(19) United States
(12) Patent Application Publication
(10) Pub. No.: US 2025/0393045 A1
(43) Pub. Date: Dec. 25, 2025

(54) COEXISTENCE OF WIRELESS SYSTEMS IN SHARED SPECTRUM

(71) Applicant: Samsung Electronics Co., Ltd., Suwon-si (KR)

(72) Inventors: Ebrahim MolavianJazi, San Jose, CA (US); Marian Rudolf, Longueuil (CA); Aristides Papasakellariou, Houston, TX (US); Hongbo Si, Allen, TX (US)

(21) Appl. No.: 19/218,168

(22) Filed: May 23, 2025

Related U.S. Application Data
(60) Provisional application No. 63/662,234, filed on Jun. 20, 2024.
(60) Provisional application No. 63/739,046, filed on Dec. 26, 2024.

(51) Int. Cl. H04W 72/1273; H04L 5/00; H04W 72/232

(52) U.S. Cl. CPC H04W 72/1273; H04L 5/0048; H04W 72/232

(57) ABSTRACT

Apparatuses and methods related to coexistence of wireless systems in shared spectrum in a wireless communication system. A method for a user equipment (UE) includes receiving a master information block (MIB) that indicates a control resource set (CORESET) for receptions of physical downlink control channels (PDCCHs), receiving a first PDCCH in the CORESET, and receiving a second PDCCH in the CORESET. The first and second PDCCHs provide a first and second downlink control information (DCI) formats, respectively, that schedule reception of first and second physical downlink shared channel (PDSCHs), respectively. The method further includes determining to receive the first PDSCH when the UE operates according to a first radio access technology (RAT) or to receive the second PDSCH when the UE operates according to a second RAT and receiving the first PDSCH or the second PDSCH.

### CROSS-REFERENCE TO RELATED APPLICATIONS AND CLAIM OF PRIORITY

The present application claims priority to:
U.S. Provisional Patent Application No. 63/662,234, filed on Jun. 20, 2024; and
U.S. Provisional Patent Application No. 63/739,046, filed on Dec. 26, 2024.
   The contents of the above-identified patent documents are incorporated herein by reference.

### TECHNICAL FIELD

The present disclosure relates generally to wireless communication systems and, more specifically, the present disclosure relates to coexistence of wireless systems in shared spectrum in a wireless communication system.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to coexistence of wireless systems in shared spectrum in a wireless communication system.

In one embodiment, a method for a user equipment (UE) is provided. The method includes receiving a master information block (MIB) that indicates a control resource set (CORESET) for receptions of physical downlink control channels (PDCCHs), receiving a first PDCCH in the CORESET, and receiving a second PDCCH in the CORESET. The first PDCCH provides a first downlink control information (DCI) format. The first DCI format schedules reception of a first physical downlink shared channel (PDSCH) that provides a first system information block (SIB). The second PDCCH provides a second DCI format. The second DCI format schedules reception of a second PDSCH that provides a second SIB. The method further includes determining to receive the first PDSCH when the UE operates according to a first radio access technology (RAT) or to receive the second PDSCH when the UE operates according to a second RAT and receiving the first PDSCH when the UE operates according to the first RAT or the second PDSCH when the UE operates according to the second RAT.

In another embodiment, a UE is provided. The UE includes a transceiver configured to receive a MIB that indicates a CORESET for receptions of PDCCHs, receive a first PDCCH in the CORESET, and receive a second PDCCH in the CORESET. The first DCI format schedules reception of a first PDSCH that provides a first SIB. The second PDCCH provides a second DCI format. The second DCI format schedules reception of a second PDSCH that provides a second SIB. The UE further includes a processor operably coupled with the transceiver. The processor is configured to determine to receive the first PDSCH when the UE operates according to a first RAT or to receive the second PDSCH when the UE operates according to a second RAT. The transceiver is further configured to receive the first PDSCH when the UE operates according to the first RAT or the second PDSCH when the UE operates according to the second RAT.

In yet another embodiment, a base station (BS) is provided. The BS includes a transceiver configured to transmit a MIB that indicates a CORESET for transmissions of PDCCHs, transmit a first PDCCH in the CORESET, and transmit a second PDCCH in the CORESET. The first PDCCH provides a first DCI format. The first DCI format schedules transmission of a first PDSCH that provides a first SIB. The second PDCCH provides a second DCI format. The second DCI format schedules transmission of a second PDSCH that provides a second SIB. The BS further includes a processor operably coupled with the transceiver. The processor is configured to determine to transmit the first PDSCH when the UE operates according to a first RAT or to transmit the second PDSCH when the UE operates according to a second RAT. The transceiver is further configured to transmit the first PDSCH when the UE operates according to the first RAT or the second PDSCH when the UE operates according to the second RAT.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to embodiments of the present disclosure;

FIG. 2 illustrates an example of gNB according to embodiments of the present disclosure;

FIG. 3 illustrates an example of UE according to embodiments of the present disclosure;

FIGS. 4 and 5 illustrate examples of wireless transmit and receive paths according to this disclosure;

FIG. 6 illustrates a flowchart of UE method for synchronization and cell search or initial access for a 6G UE using a 5G NR synchronization signal block (SSB) that provides a 6G PBCH/MIB in addition to the 5G NR PBCH/MIB according to embodiments of the present disclosure;

FIG. 7 illustrates a flowchart of UE method for providing a second PBCH/MIB as a configurable time-frequency extension of 5G NR SSB according to embodiments of the present disclosure;

FIG. 8 illustrates a flowchart of UE method in a non-multi-RAT spectrum sharing (MRSS) band using a 5G NR SSB structure with time/frequency extension for providing a 6G PBCH/MIB according to embodiments of the present disclosure;

FIG. 9 illustrates a flowchart of UE method in a non-MRSS band using a 5G NR SSB structure that is extended for providing a 6G PBCH/MIB according to embodiments of the present disclosure;

FIG. 10 illustrates a flowchart of UE method in a non-MRSS band using a 5G NR SSB structure that is extended for providing a 6G PBCH/MIB according to embodiments of the present disclosure;

FIG. 11 illustrates a flowchart of UE method with different assumptions on SSB structure for MRSS-bands and non-MRSS band according to embodiments of the present disclosure;

FIG. 12 illustrates a flowchart of UE method with time-frequency extension of 5G NR SSB for providing a 6G PBCH/MIB that depends on the SSB-CORESET #0 multiplexing pattern according to embodiments of the present disclosure;

FIG. 13 illustrates a flowchart of UE method for rate-matching around the time-frequency resources appended to the 5G NR SSB for providing a 6G PBCH/MIB according to embodiments of the present disclosure;

FIG. 14 illustrates a flowchart of UE method for sharing PBCH/MIB between 5G NR and 6G according to embodiments of the present disclosure;

FIG. 15 illustrates a flowchart of UE method for sharing SIB1 PDSCH between 5G NR and 6G according to embodiments of the present disclosure;

FIG. 16 illustrates a flowchart of UE method for using a different system information (SI)-radio network temporary identifier (RNTI) value or different downlink control information (DCI) size for a DCI format scheduling system information block one (SIB1) to distinguish a second SIB1 for 6G from a first SIB1 for 5G NR according to embodiments of the present disclosure;

FIG. 17 illustrates a flowchart of UE method for randomization of control channel elements (CCEs)/physical downlink control channel (PDCCH) candidates in the search space formula for common search space (CSS) sets according to embodiments of the present disclosure;

FIG. 18 illustrates a flowchart of a method for partitioning UE IDs or UE group IDs to distinguish a second paging (or paging early indication (PEI) or low-power wake-up signal (LP-WUS)) for 6G from a first paging (or PEI or LP-WUS) for 5G NR according to embodiments of the present disclosure; and

FIG. 19 illustrates a flowchart of UE method for using different paging-RNTI (P-RNTI) value or different DCI size for a DCI format scheduling paging to distinguish a second paging for 6G from a first paging for 5G NR according to embodiments of the present disclosure.

### DETAILED DESCRIPTION

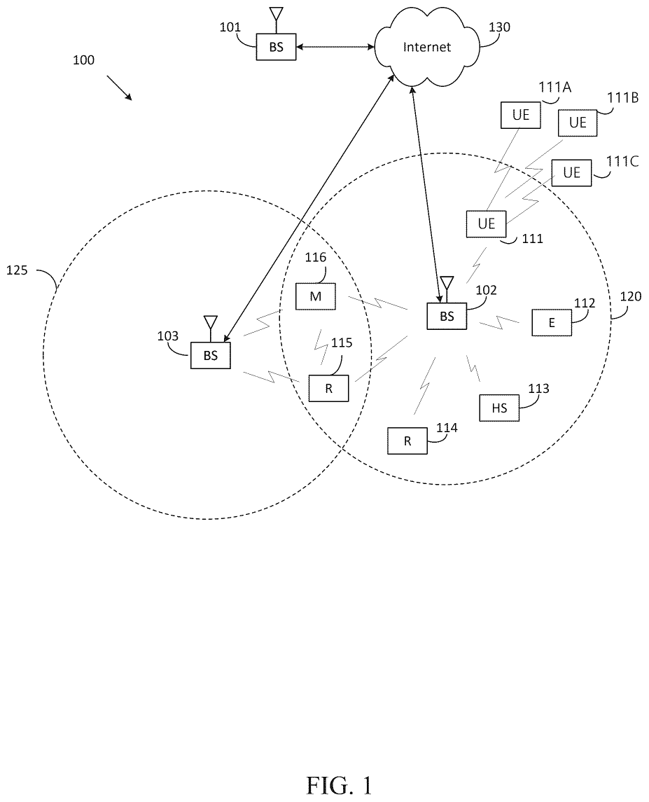

FIGS. 1-19, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

The following documents are hereby incorporated by reference into the present disclosure as if fully set forth herein: 3GPP TS 38.211 v18.2.0, “NR; Physical channels and modulation”; 3GPP TS 38.212 v18.2.0, “NR; Multiplexing and channel coding”; 3GPP TS 38.213 v18.2.0, “NR; Physical layer procedures for control”; 3GPP TS 38.214 v18.2.0, “NR; Physical layer procedures for data”; 3GPP TS 38.215 Rel-18 v18.2.0, “NR; Physical layer measurements”; 3GPP TS 38.321 Rel-18 v18.1.0, “NR; Medium Access Control (MAC) protocol specification”; 3GPP TS 38.300 Rel-18 v18.1.0, “NR; NR and NG-RAN Overall Description; Stage 2”; and 3GPP TS 38.331 v18.1.0, “NR; Radio Resource Control (RRC) protocol specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example of wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for the first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

In another example, the UE 116 may be within network coverage and the other UE may be outside network coverage (e.g., UEs 111A-111C). In yet another example, both UE are outside network coverage. In some embodiments, one or more of the gNBs 101-103 may communicate with each other and with the UEs 111-116 using 5G/NR, LTE, LTE-A, WiMAX, WiFi, or other wireless communication techniques. In some embodiments, the UEs 111-116 may use a device to device (D2D) interface called PC5 (e.g., also known as sidelink at the physical layer) for communication.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered as a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for coexistence of wireless systems in shared spectrum in a wireless communication system. In embodiments, and one or more of the gNBs 101-103 includes circuitry, programing, or a combination thereof, for supporting coexistence of wireless systems in shared spectrum in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

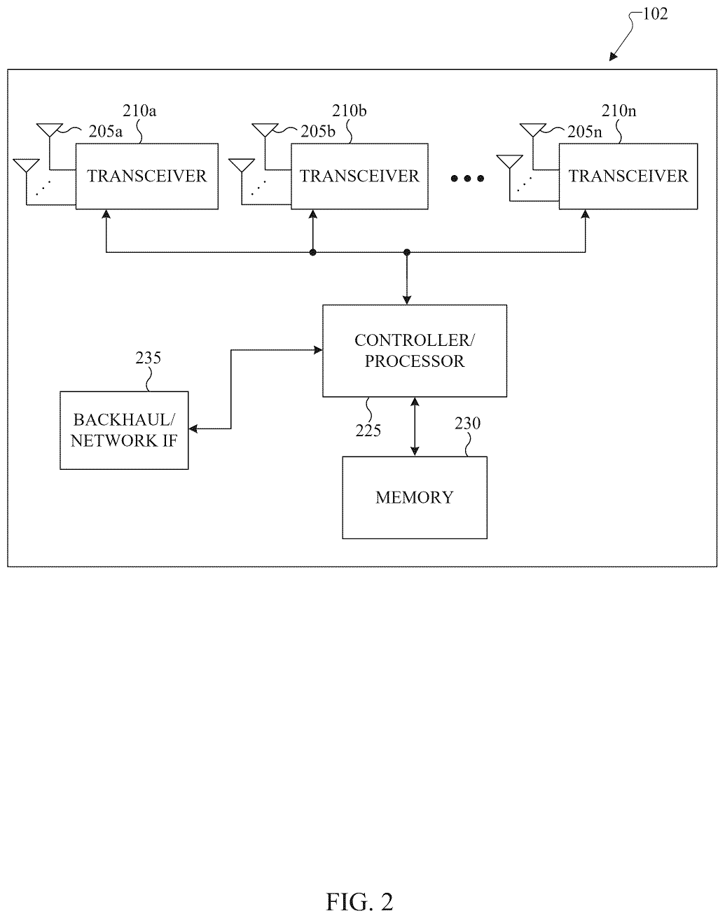

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as processes for supporting coexistence of wireless systems in shared spectrum in a wireless communication system. The controller/processor 225 can move data into or out of the memory 230 as performed by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

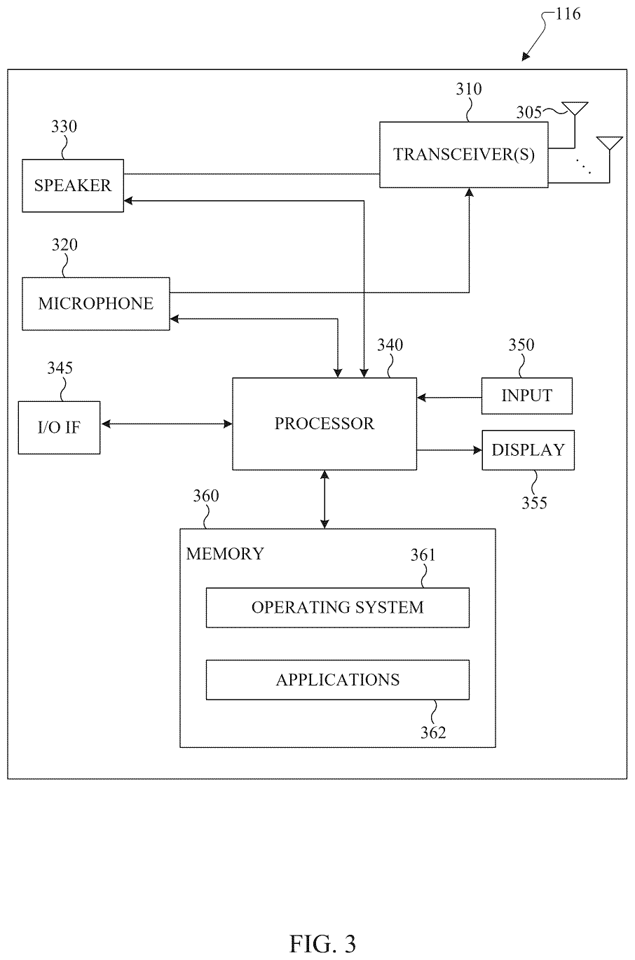

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100 or by other UEs (e.g., one or more of UEs 111-116) on a SL channel. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL and/or SL channels and/or signals and the transmission of UL and/or SL channels and/or signals by the transceiver(s) 310 in accordance with well-known principles. In some embodiments, the processor 340 includes at least one microprocessor or microcontroller.

The processor 340 is also capable of executing other processes and programs resident in the memory 360, such as processes for coexistence of wireless systems in shared spectrum in a wireless communication system.

The processor 340 can move data into or out of the memory 360 as performed by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350 and the display 355 which includes for example, a touchscreen, keypad, etc., The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

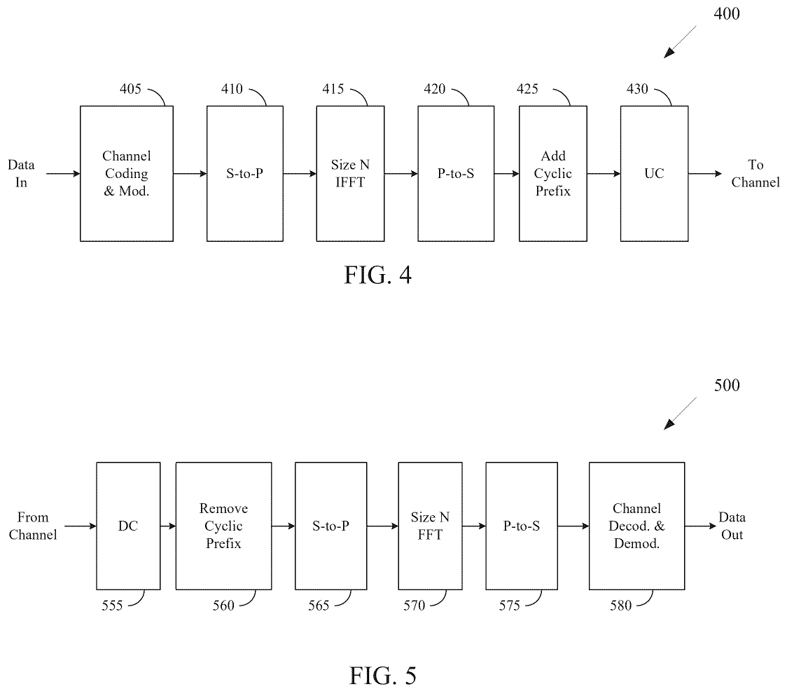

FIG. 4 and FIG. 5 illustrate example wireless transmit and receive paths according to this disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE. It may also be understood that the receive path 500 can be implemented in the first UE and that the transmit path 400 can be implemented in a second UE to support SL communications. In various embodiments, the receive path 500 can be implemented in the first UE and the transmit path 400 can be implemented in a second UE. In some embodiments, the transmit path 400 is configured for coexistence of wireless systems in shared spectrum in a wireless communication system.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. A transmitted RF signal from a first UE arrives at a second UE after passing through the wireless channel, and reverse operations to those at the first UE are performed at the second UE.

As illustrated in FIG. 5, the down converter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and/or transmitting in the sideling to another UE and may implement the receive path 500 for receiving in the downlink from the gNBs 101-103 and/or receiving in the sidelink from another UE.

Each of the components in FIG. 4 and FIG. 5 can be implemented using only hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 415 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

Due to limited spectrum availability, particularly in frequency bands below 6 GHz, also known as frequency range 1 (FR1), cellular operators may not possess sufficient spectrum to operate 6G in dedicated 6G frequency bands. Therefore, 5G NR (or even 4G LTE) spectrum may be re-used and/or co-exist with 6G spectrum for 6G operation, while 5G/4G base stations and UEs remain present and operate in those frequency bands.

In addition, even for higher frequency bands, such as mmWave bands that are also known as FR2, where spectrum availability is not scarce, operators may have 5G NR deployments with high capital expenditures (CAPEX), or high operation cost (OPEX), or that are relatively underutilized. Therefore, the operators may not prefer to deploy separate, dedicated frequency bands for their 6G network. Instead, such operators may opt to operate 6G in the same frequency bands as 5G NR deployments.

In such cases of MRSS, coexistence mechanisms may apply to ensure compatible and efficient usage of the shared spectrum between 6G and 5G or 4G.

To reduce implementation costs, accelerate 6G deployments, and increase spectrum efficiency, a 6G cell can operate in a spectrum that is shared with a 5G NR cell, or possibly with other cellular releases, such as 4G LTE. In such cases, corresponding 6G BS/UEs may be identified to coexist with 5G BS/UEs (or 4G BS/UEs) that operate in a same spectrum such as, for example, a same frequency band.

There may be mechanisms to facilitate the 6G/5G (or 6G/5G/4G) coexistence are provided as MRSS, while reducing or eliminating inter-RAT interference or any other performance degradation.

There may be another method to ensure robust MRSS mechanisms to facilitate simple implementation of 6G (and later releases of 5G/4G) base stations and UEs, including semi-static MRSS, as well as adaptive MRSS mechanisms to facilitate efficient usage of the spectrum, including dynamic MRSS with low latency, when possible.

The present disclosure provides methods and apparatus for MRSS operation based on cooperation or reuse/sharing, wherein 6G BS/UEs transmit or receive in resources, such as time/frequency/spatial (T/F/S) resources, that are shared with resources used by 5G BS/UEs (or 4G BS/UEs), to increase the spectrum usage and efficiency, or operate with same signals or channels or messages that can be partially or fully reused between 5G and 6G, or based on procedures or signaling that can be partially or fully shared between 5G and 6G with same or different interpretation or follow-up operations.

Embodiments as disclosed in the present disclosure may apply to any deployments, verticals, or scenarios including in FR1, FR2, FR3, FR4, with eMBB, URLLC and IIOT, mMTC and IoT including LTE BS-IoT or NR IoT or Ambient IoT (A-IoT), with AI/ML operation, with sidelink/V2X communications, in unlicensed/shared spectrum (NR-U), for non-terrestrial networks (NTN), for aerial systems such as unmanned aerial vehicles (UAVs) such as drones, for private or non-public networks (NPN), for operation with reduced capability (RedCap) UEs, multicast broadcast services (MBS), with integrated sensing and communication (ISAC) operation, and so on.

Combinations of the embodiments are also applicable but are not described in detail for brevity.

In one embodiment, methods for MRSS are provided. The MRSS objectives can be achieved using avoidance methods that preclude interference between the 6G RAT and the 5G/4G RAT, or using cooperation/reusing/sharing methods that rely on coordination, assistance, or cooperation between the 6G RAT and the 5G/4G RAT. In the present disclosure, avoidance refers to UE-BS/inter-BS signaling, configurations, procedures, methods, and so on, that preclude a 6G UE/cell from transmitting, receiving, or otherwise using for a 6G procedure/operation any T/F/S resource in which a 5G/4G UE/cell may transmit, receive, or otherwise use for a 5G/4G operation.

In the present disclosure, cooperation or reuse/sharing refers to UE-BS/inter-BS signaling, configurations, procedures, methods, and so on, that support for a 6G UE/cell to transmit, receive or otherwise use for a 6G procedure/operation some or all T/F/S resources in which a 5G/4G UE/cell may transmit, receive, or otherwise use for a 5G/4G operation, or some or all signals or channels or messages that a 5G/4G UE/cell may transmit or receive, or otherwise use for 5G/4G operation. Such method allows for spectrum sharing among 6G and 5G/4G, with limited or without avoidance-based methods. Examples of such signals or channels or messages or T/F/S resources include: NR SSB, MIB, SIB1 message, SIB1 PDCCH/PDSCH, SIBx>1 PDCCH/PDSCH/message, paging PDCCH/PDSCH, LP-SS, LP-WUS, CORESETs including CORESET #0, and so on, as subsequently described.

In one embodiment, acquisition of RAT-specific master information block (MIB) is provided when sharing RAT-common synchronization signal (e.g., sharing SSB).

In one embodiment, a UE corresponding to a first RAT, such as a 6G UE can receive a same signal, that is referred to as DL anchor signal, for initial synchronization or cell search, such as a same SS/PBCH block (also referred to as SSB) or a same low-power synchronization signal (LP-SS), as a second UE corresponding to a second RAT, such as a 5G NR UE. For example, the 6G UE performs synchronization or cell search or RRM measurement or mobility based on the NR PSS/SSS or LP-SS sequences, same as for a 5G NR UE. For example, the 6G UE determines a 6G-specific minimum system information, or a part thereof, referred to as a 6G MIB, that is separate/different from the 5G NR MIB.

For example, the 6G UE determines the 6G MIB from the DL anchor signal/SSB/LP-SS that is shared with 5G NR, via separate RAT-specific transmission/channel, or via different RAT-specific interpretation. For example, the following methods can be used.

In one example, one SSB is provided with two separate PBCHs for NR and 6G-using additional OFDM symbols or REs/RBs, such as in TDM or FDM manner with the 5G SSB, which band-specific or band-common.

In such example, the number of additional symbols or REs/RBs can be predetermined in the specifications (possibly based on a time/frequency location of the 5G SSB, a time-domain pattern of the 5G SSB, or a minimum channel bandwidth of the 5G SSB), or the additional symbols or REs/RBs can take one of multiple candidates for such T/F extension; in the latter case, an indication method such as the 96 unused REs (or a subset thereof) in PSS symbol of NR SSB or the spare bit of the 5G NR MIB or certain values of PBCH content or corresponding transmission parameters are used in 6G to provide a field with a number of bits or otherwise an explicit or implicit indication provided by PSS/SSS/PBCH/MIB of the NR SSB to indicate parameters for T/F-extension, if any, of the NR SSB for 6G; In yet another example, the 6G UE may perform blind decoding among multiple different candidates for such T/F extension to determine an actual T/F extension.

In one example, the 6G UEs receive SSBs using same or different assumptions on the SSB structures for MRSS-designated bands vs. non-MRSS bands, including a presence or structure of an extension of SSB in time/frequency domain; if SSB extension is applied in a non-MRSS band, the 6G UE may discard the resources for NR PBCH, or may use them for providing some of the 6G SIB1 IEs, or for receive a 6G DL signal or channel such as TRS or PDCCH.

In one example, the 5G UE can avoid such T/F-extension for 6G PBCH, e.g., by rate-matching indication for 5G UEs, or by predetermined or dedicated higher layer information or by 6G PBCH interference cancellation for MRSS-aware 5G UEs.

In one example, one SSB with one PBCH/MIB for both NR and 6G—interpreted differently for each RAT; alternatively, a spare bit of NR MIB can be used to indicate whether the MIB is for both NR and 6G or for NR only (in the latter case, the MIB for 6G can be provided by an SSB or LP-SS that is in different half-frame or frames or subframes or sync raster and so on).

In one example, a single identical SSB that applies to both RATs, such as both 5G NR and 6Gm is provided. For example, the 6G UE receives identical PSS/SSS/PBCH as for a 5G NR UE, and any differentiation among 5G NR UEs and 6G UEs is provided by SIB1 message or SIBx>1 message, as subsequently described in embodiment as disclosed in the present disclosure, or is indicated during or after the initial/random access procedure. For example, the 6G UE can be provided 6G-specific SIB1 message or a 5G NR SIB1 message that is modified to provide 6G-specific information, or the 6G UE can be provided identical SIB1 message as a 5G NR UE and receive 6G-specific system information using a SIBx>1 or using UE-common (cell-specific) or dedicated (UE-specific) higher layer signaling, such as common or dedicated RRC signaling.

In one realization, a gNB can enable or allocate different SSB types based on a UE capability. For example, when a UE reports a 5G RAT capability, the gNB enables or transmits 5G SSB. For example, when a UE reports a 6G RAT capability, the gNB enables or transmits a 6G SSB or a hybrid SSB that includes both 5G SSB and 6G SSB or variants thereof.

In one example, a gNB can enable or disable an SSB type or a corresponding UE procedure based on the UE capability or irrespective of the UE capability.

For example, a gNB may disable MRSS operation or disable hybrid SSB (for example, due to coverage reasons, traffic patterns, and so on), despite a reported capability for both 5G RAT and 6G RAT (such as a dual-stack-protocol UE). Above realizations and examples can apply after RRC connection or before RRC connection.

In one embodiment, acquisition of RAT-specific remaining minimum information block (RMSI/SIB1) or other SIBx is provided when sharing RAT-common signal or channel for initial cell search (e.g., sharing SSB).

In one embodiment, a UE associated with a first RAT, such as a 6G UE, can determine a first RMSI or SIB1 corresponding to the first RAT based on a DL anchor signal for initial synchronization or cell search, such as an SSB or an LP-SS, that is shared with a second RAT, such as 5G NR. The first RMSI/SIB1 can be different from a second RMSI/SIB1 that is associated with the second RAT, such as NR. The scheduling information, such as PDCCH configuration, for the first SIB1 and the second SIB1 can be provided by the DL anchor signal (e.g., NR SSB or NR LP-SS), such as by corresponding MIB messages that are associated with the DL anchor signal.

In one example, both the MIB message and the SIB1 PDSCH for 6G are shared with 5G NR. The shared SIB1 PDSCH provides a SIB1 message that includes IEs for 5G NR operation, that may also be used by 6G, and additional 6G-specific IEs for 6G operation. Alternatively, the 6G UE can interpret the shared SIB1 PDSCH payload differently than 5G NR.

In one example, both the MIB message and the PDCCH providing a DCI format scheduling the SIB1 message for 6G are shared with 5G NR. The DCI format, such as a DCI format 1_0, with SI-RNTI for 6G can have same size and same SI-RNTI as for 5G NR. The fields of the DCI format can have same or different interpretation for 6G than 5G NR, such as different TDRA or FDRA for the 6G SIB1 PDSCH reception compared to the 5G SIB1 PDSCH reception. Alternatively, the 6G UE applies different parameters for reception of the PDCCH providing the DCI format scheduling SIB1, such as a different DCI size or a different RNTI (i.e., different SI-RNTI for 5G NR and for 6G), to determine the DCI format with SI-RNTI for 6G that is different from that for 5G NR.

In one example, the MIB message for 6G is shared with 5G NR, and the 6G UE interprets parameters for PDCCH receptions associated with SIB1 scheduling, such as CORESET #0 or search space set #0 configuration, that are provided by the shared MIB message, or applies additional randomization in the 6G PDCCH search space formula, to receive a PDCCH for scheduling SIB1 for 6G, such that the PDCCH reception is in different T/F/S resources than a PDCCH reception for scheduling SIB1 for 5G NR.

In one example, the DL anchor signal such as NR SSB or NR LP-SS provides a first PBCH/MIB for 6G and a second PBCH/MIB the 5G NR that is separate from the first PBCH/MIB (while some information may be shared between 5G and 6G), as described in an embodiment of the present disclosure. The 6G UE acquires the first/6G SIB1 based on the first/6G MIB, that is separate from the second/5G SIB1 which is based on the first/5G MIB.

In one example, a single identical SIB1 message that applies to both RATs is provided, such as both 5G NR and 6G. For example, the 6G UE receives system information same as for a 5G NR UE, and any differentiation among 5G NR UEs and 6G UEs is indicated during or after the initial/random access procedure. For example, the 6G UE is provided with information of 6G-specific system information using UE-common (cell-specific) or dedicated (UE-specific) higher layer signaling, such as common or dedicated RRC signaling, for example, upon or after RRC connection. For example, the system information indicates a set of PRACH preambles or PRACH occasions to be used by 6G UEs that is separate and does not have common elements than a set of PRACH preambles or PRACH occasions to be used by 5G NR UEs.

In one example, acquisition of first SIBx (x>1) associated with 6G that are different from second SIBx associated with 5G NR is provided, when scheduling information for the first and second SIBx are identified based on a SIB1 that is shared between 5G and 6G, or based on first SIB1 and second SIB1, associated with 6G and 5G, respectively, that are different.

In one embodiment, a reception of RAT-specific paging/RAR/group-common PDCCH/LP-WUS in resources shared across RATs is provided.

In one embodiment, a first UE associated with a first RAT, such as a 6G UE, can receive a first PDCCH that schedules first paging information or a first random access response (RAR) or a first group-common PDCCH (such as DCI format 2_x in a CSS set) in time/frequency/spatial (T/F/S) resources, such as resources in a same CORESET #0 or resources in a same CORESET with non-zero index, that are also used (shared) for reception of a second PDCCH that schedules second paging information or a second RAR or a second group-common PDCCH by a second UE associated with a second RAT, such as 5G NR. The first paging/RAR/control information for the first UE can be included in a first paging message/RAR message (or RAR MAC)/group-common DCI format 2_x that includes paging/RAR/control information for a number of UEs, such as only 6G UEs, or a combination of 6G UEs and 5G NR UEs. A similar example can be provided for LP-WUS as well.

For the case of paging, the following examples/embodiments can be provided.

In one example, a paging PDSCH/message for 6G is shared with 5G NR and includes paging information for both 5G NR UEs and 6G UEs. If UE IDs are different among 5G UEs and 6G UEs, different UEs, including NR UE and 6G UEs can distinguish corresponding paging information.

In one example, a CORESET and a search space set for paging PDCCH for 6G is shared with 5G NR, and the 6G UE applies different parameters for paging PDCCH reception (such as different DCI size or different RNTI) to determine a DCI format 1_0 with P-RNTI for 6G that is different from that for 5G NR.

In one example, a CORESET for reception of paging PDCCH for 6G is shared with 5G NR, while a search space set for paging PDCCH (such as a Type-2 CSS set) for 6G is different from a Type-2 CSS set for paging PDCCH for 5G NR, such as by the 6G UE applying an additional randomization in the 6G PDCCH search space formula, as described in embodiments of the present disclosure, or based on indication, such as by SIB1 or RRC configuration, of paging occasions for 6G that are different from paging occasions for 5G NR. Therefore, the 6G UE receives a paging PDCCH that is in different T/F/S resources of the CORESET than the paging PDCCH for 5G NR.

In one example, a reception of first RAR/group-common PDCCH in a CSS set (e.g., DCI 2_x) associated with 6G that is different/separate from second RAR/group-common PDCCH associated with 5G NR is provided, for example, when corresponding CORESET or Type-1 CSS set or Type-3 CSS set is shared among NR and 6G.

In one example, a reception of first PEI or first LP-WUS associated with 6G that are different/separate from second PEI or LP-WUS associated with 5G NR is provided, for example, when CORESET or Type-2A CSS set for PEI PDCCH reception is shared among NR and 6G, or when T/F/S resources for LP-WUS reception are shared between NR and 6G.

The present disclosure relates to a pre-5G or 5G or beyond 5G communication system to be provided for supporting one or more of: higher data rates, lower latency, higher reliability, improved coverage, and massive connectivity, and so on. Various embodiments apply to UEs operating with other RATs and/or standards, such as different releases/generations of 3GPP standards (including beyond 5G, 5G Advanced, 6G, and so on), IEEE standards (such as 802.16 WiMAX and 802.11 Wi-Fi and so on), and so forth.

In the present disclosure, unless otherwise noted, a parameter referenced in italics is provided by higher layers such as by RRC.

A communication system can include a downlink (DL) that refers to transmissions from a base station (e.g., 101-103 as illustrated in FIG. 1) or one or more transmission points to UEs (e.g., 111-116 as illustrated in FIG. 1) and an uplink (UL) that refers to transmissions from UEs (e.g., 111-116 as illustrated in FIG. 1) to a base station (101-103 as illustrated in FIG. 1) or to one or more reception points.

A time unit for DL signaling or for UL signaling on a cell is referred to as a slot and can include one or more symbols. A symbol can also serve as an additional time unit. A frequency (or bandwidth (BW)) unit is referred to as a resource block (RB). One RB includes a number of sub-carriers (SCs). For example, a slot can have duration of 1 millisecond or 0.5 millisecond, include 14 symbols and an RB can include 12 SCs with inter-SC spacing of 15 kHz or 30 kHz, and so on.

DL signals include data signals conveying information content, control signals conveying DL control information (DCI), and reference signals (RS) that are also known as pilot signals. A BS transmits data information or DCI through respective physical DL shared channels (PDSCHs) or physical DL control channels (PDCCHs). A PDSCH or a PDCCH can be transmitted over a variable number of slot symbols including one slot symbol. For brevity, a DCI format scheduling a PDSCH reception by a UE is referred to as a DL DCI format and a DCI format scheduling a physical uplink shared channel (PUSCH) transmission from a UE is referred to as an UL DCI format.

A BS transmits one or more of multiple types of RS including channel state information RS (CSI-RS) and demodulation RS (DM-RS). A CSI-RS is primarily intended for UEs to perform measurements and provide channel state information (CSI) to a BS. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process comprises NZP CSI-RS and CSI-IM resources.

A UE can determine CSI-RS transmission parameters through DL control signaling or higher layer signaling, such as radio resource control (RRC) signaling, from a BS. Transmission instances of a CSI-RS can be indicated by DL control signaling or be configured by higher layer signaling. A DM-RS is transmitted only in the BW of a respective PDCCH or PDSCH and a UE can use the DM-RS to demodulate data or control information.

In one embodiment, UL signals also include data signals conveying information content, control signals conveying UL control information (UCI), DM-RS associated with data or UCI demodulation, sounding RS (SRS) enabling a BS to perform UL channel measurement, and a RA preamble enabling a UE to perform RA (see also NR specification). A UE transmits data information or UCI through a respective PUSCH or a physical UL control channel (PUCCH). A PUSCH or a PUCCH can be transmitted over a variable number of slot symbols including one slot symbol. The BS can configure the UE to transmit signals on a cell within an active UL bandwidth part (BWP) of the cell UL BW.

UCI includes HARQ acknowledgement (ACK) information, indicating correct or incorrect detection of data transport blocks (TBs) in a PDSCH, scheduling request (SR) indicating whether a UE has data in a buffer, and CSI reports enabling a BS to select appropriate parameters for PDSCH or PDCCH transmissions to a UE. HARQ-ACK information can be configured to be with a smaller granularity than per TB and can be per data code block (CB) or per group of data CBs where a data TB includes a number of data CBs.

A CSI report from a UE can include a channel quality indicator (CQI) informing a BS of a largest modulation and coding scheme (MCS) for the UE to detect a data TB with a predetermined block error rate (BLER), such as a 10% BLER (see NR specification), of a precoding matrix indicator (PMI) informing a BS how to combine signals from multiple transmitter antennas in accordance with a MIMO transmission principle, and of a rank indicator (RI) indicating a transmission rank for a PDSCH.

UL RS includes DM-RS and SRS. DM-RS is transmitted only in a BW of a respective PUSCH or PUCCH transmission. A BS can use a DM-RS to demodulate information in a respective PUSCH or PUCCH. SRS is transmitted by a UE to provide a BS with an UL CSI and, for a TDD system, an SRS transmission can also provide a PMI for DL transmission. Additionally, in order to establish synchronization or an initial higher layer connection with a BS, a UE can transmit a physical random-access channel (PRACH as shown in NR specifications).

An antenna port is defined such that the channel over which a symbol on the antenna port is conveyed can be inferred from the channel over which another symbol on the same antenna port is conveyed.

For DM-RS associated with a PDSCH, the channel over which a PDSCH symbol on one antenna port is conveyed can be inferred from the channel over which a DM-RS symbol on the same antenna port is conveyed only if the two symbols are within the same resource as the scheduled PDSCH, in the same slot, and in the same precoding resource block group (PRG).

For DM-RS associated with a PDCCH, the channel over which a PDCCH symbol on one antenna port is conveyed can be inferred from the channel over which a DM-RS symbol on the same antenna port is conveyed only if the two symbols are within resources for which the UE may assume the same precoding being used.

For DM-RS associated with a physical broadcast channel (PBCH), the channel over which a PBCH symbol on one antenna port is conveyed can be inferred from the channel over which a DM-RS symbol on the same antenna port is conveyed only if the two symbols are within a SS/PBCH block transmitted within the same slot, and with the same block index.

Two antenna ports are said to be quasi co-located if the large-scale properties of the channel over which a symbol on one antenna port is conveyed can be inferred from the channel over which a symbol on the other antenna port is conveyed. The large-scale properties include at least one of delay spread, Doppler spread, Doppler shift, average gain, average delay, and spatial Rx parameters.

A UE may assume that synchronization signal (SS)/PBCH block (also denoted as SSBs) transmitted with the same block index on the same center frequency location are quasi co-located with respect to Doppler spread, Doppler shift, average gain, average delay, delay spread, and, when applicable, spatial Rx parameters. The UE may not assume quasi co-location for any other synchronization signal SS/PBCH block transmissions.

In absence of CSI-RS configuration, and unless otherwise configured, the UE may assume PDSCH DM-RS and SSB to be quasi co-located with respect to Doppler shift, Doppler spread, average delay, delay spread, and, when applicable, spatial Rx parameters. The UE may assume that the PDSCH DM-RS within the same code division multiplexing (CDM) group is quasi co-located with respect to Doppler shift, Doppler spread, average delay, delay spread, and spatial Rx. The UE may also assume that DM-RS ports associated with a PDSCH are QCL with QCL type A, type D (when applicable) and average gain. The UE may further assume that no DM-RS collides with the SS/PBCH block.

The UE can be configured with a list of up to M transmission configuration indication (TCI) State configurations within the higher layer parameter PDSCH-Config to decode PDSCH according to a detected PDCCH with DCI intended for the UE and the given serving cell, where M depends on the UE capability maxNumberConfiguredTCIstatesPerCC. Each TCI-State contains parameters for configuring a quasi-colocation (QCL) relationship between one or two downlink reference signals and the DM-RS ports of the PDSCH, the DM-RS port of PDCCH or the CSI-RS port(s) of a CSI-RS resource.

The quasi co-location relationship is configured by the higher layer parameter qcl-Type1 for the first DL RS, and qcl-Type2 for the second DL RS (if configured). For the case of two DL RSs, the QCL types may not be the same, regardless of whether the references are to the same DL RS or different DL RSs. The quasi co-location types corresponding to each DL RS are given by the higher layer parameter qcl-Type in QCL-Info and may take one of the following values: QCL-TypeA: {Doppler shift, Doppler spread, average delay, delay spread}; QCL-TypeB: {Doppler shift, Doppler spread; QCL-TypeC: {Doppler shift, average delay}; and QCL-TypeD: {Spatial Rx parameter}.

The UE receives a MAC-CE activation command to map up to [N] (e.g., N=8) TCI states to the codepoints of the DCI field “transmission configuration indication.” When the HARQ-ACK corresponding to the PDSCH carrying the activation command is transmitted in slot n, the indicated mapping between TCI states and codepoints of the DCI field “transmission configuration indication” may be applied after a MAC-CE application time, e.g., starting from the first slot that is after slot

$$( n + 3 {N}_{slot}^{subframe , μ} ) .$$

In one example, the term “beam” is used to refer to a spatial filter for transmission or reception of a signal or a channel. For example, a beam (of an antenna) can be a main lobe of the radiation pattern of an antenna array, or a sub-array or an antenna panel, or of multiple antenna arrays, sub-arrays or panels combined, that are used for such transmission or reception. In various examples, a beam such as a Tx beam or an Rx beam is referred to as a spatial filter, such as a spatial transmission filter or a spatial reception filter.

In the present disclosure, various embodiments of the disclosure may be also implemented in any type of UE including, for example, UEs with the same, similar, or more capabilities compared to 5G NR UEs. Although various embodiments of the disclosure discuss 3GPP 5G NR communication systems, the embodiments may apply in general to UEs operating with other RATs and/or standards, such as next releases/generations of 3GPP, IEEE WiFi, and so on.

In the present disclosure, unless otherwise explicitly noted, providing a parameter value by higher layers includes providing the parameter value by MIB or a system information block (SIB), such as a SIB1, or by a common RRC signaling, or by UE-specific RRC signaling.

In the present disclosure, for brevity of description, the higher layer provided TDD UL-DL frame configuration refers to tdd-UL-DL-ConfigurationCommon as example for RRC common configuration and/or tdd-UL-DL-ConfigurationDedicated as example for UE-specific configuration. The UE determines a common TDD UL-DL frame configuration of a serving cell by receiving a SIB such as a SIB1 when accessing the cell from an RRC_IDLE state or by RRC signaling when the UE is configured with SCells or additional SCGs by an IE ServingCellConfigCommon in an RRC_CONNECTED state. The UE determines a dedicated TDD UL-DL frame configuration using the IE ServingCellConfig when the UE is configured with a serving cell, e.g., add or modify, where the serving cell may be the SpCell or an SCell of an MCG or SCG. A TDD UL-DL frame configuration designates a slot or symbol as one of types “D,” “U” or “F” using at least one time-domain pattern with configurable periodicity.

In the present disclosure, for brevity of description, SFI refers to a slot format indicator as example that is indicated using higher layer provided IEs such as slotFormatCombination or slotFormatCombinationsPerCell and which is indicated to the UE by group common DCI format such as DCI F2_0 where slotFormats are defined in 3GPP TS 38.213.

The synchronization signal and PBCH block (SSB) comprises primary and secondary synchronization signals (PSS, SSS), each occupying 1 symbol and 127 subcarriers, and PBCH spanning across 3 OFDM symbols and 240 subcarriers, but on one symbol leaving an unused part in the middle for SSS. The possible time locations of SSBs within a half-frame are determined by sub-carrier spacing and the periodicity of the half-frames where SSBs are transmitted is configured by the network. During a half-frame, different SSBs may be transmitted in different spatial directions (i.e., using different beams, spanning the coverage area of a cell).

Within the frequency span of a carrier, multiple SSBs can be transmitted. The PCIs of SSBs transmitted in different frequency locations may not be unique, i.e., different SSBs in the frequency domain can have different PCIs. However, when an SSB is associated with an RMSI, the SSB is referred to as a cell-defining SSB (CD-SSB). A PCell is always associated with a CD-SSB located on the synchronization raster.

Polar coding is used for PBCH. The UE may assume a band-specific sub-carrier spacing for the SSB unless a network has configured the UE to assume a different sub-carrier spacing. PBCH symbols carry its own frequency-multiplexed DMRS. QPSK modulation is used for PBCH.

Measurement time resource(s) for SSB-based RSRP measurements may be confined within a SSB measurement time configuration (SMTC). The SMTC configuration provides a measurement window periodicity/duration/offset information for UE RRM measurement per carrier frequency. For intra-frequency connected mode measurement, up to two measurement window periodicities can be configured. For an RRC_IDLE state, a single SMTC is configured per carrier frequency for measurements. For inter-frequency mode measurements in an RRC_CONNECTED state, a single SMTC is configured per carrier frequency. Note that if RSRP is used for L1-RSRP reporting in a CSI report, the measurement time resource(s) restriction provided by the SMTC window size is not applicable. Similarly, measurement time resource(s) for RSSI are confined within SMTC window duration. If no measurement gap is used, RSSI is measured over OFDM symbols within the SMTC window duration. If a measurement gap is used, RSSI is measured over OFDM symbols corresponding to overlapped time span between SMTC window duration and minimum measurement time within the measurement gap.

Link adaptation (e.g., adaptive modulation and coding (AMC)) with various modulation schemes and channel coding rates is applied to the PDSCH. The same coding and modulation are applied to all groups of resource blocks belonging to the same L2 PDU scheduled to one user within one transmission duration and within a MIMO codeword.

For channel state estimation purposes, the UE may be configured to measure CSI-RS and estimate the downlink channel state based on the CSI-RS measurements. The UE feeds the estimated channel state back to the BS to be used in link adaptation.

Measurement reports are necessary to enable the scheduler to operate in both uplink and downlink. These include transport volume and measurements of a UEs radio environment.

Cell search is the procedure by which a UE acquires time and frequency synchronization with a cell and detects the Cell ID of that cell. NR cell search is based on the primary and secondary synchronization signals, and PBCH DMRS, located on the synchronization raster.

The MIB on PBCH provides the UE with parameters (e.g., CORESET #0 configuration) for monitoring of PDCCH for scheduling PDSCH that carries the system information block 1 (SIB1). PBCH may also indicate that there is no associated SIB1, in which case the UE may be pointed to another frequency from where to search for an SSB that is associated with a SIB1 as well as a frequency range where the UE may assume no SSB associated with SIB1 is present. The indicated frequency range is confined within a contiguous spectrum allocation of the same operator in which SSB is detected.

System information (SI) comprises a MIB and a number of SIBs, which are divided into minimum SI and other SI (OSI).

In one example, minimum SI comprises basic information for initial access and information for acquiring any other SI. Minimum SI comprises: (1) MIB contains cell barred status information and essential physical layer information of the cell to receive further system information, e.g., CORESET #0 configuration. MIB is periodically broadcast on BCH; and (2) SIB1 defines the scheduling of other system information blocks and contains information for initial access. SIB1 is also referred to as remaining minimum SI (RMSI) and is periodically broadcast on DL-SCH or sent in a dedicated manner on DL-SCH to UEs in an RRC_CONNECTED state.

In one example, other SI (OSI) encompasses all SIBs not broadcast in the Minimum SI. Those SIBs can either be periodically broadcast on DL-SCH, broadcast on-demand on DL-SCH (i.e., upon request from UEs in an RRC_IDLE state, an RRC_INACTIVE state, or an RRC_CONNECTED state), or sent in a dedicated manner on DL-SCH to UEs in an RRC_CONNECTED state (i.e., upon request, if configured by the network, from UEs in an RRC_CONNECTED state or when the UE has an active BWP with no common search space configured or when the UE configured with inter cell beam management is receiving DL-SCH from a TRP with PCI different from serving cell's PCI).

Other SI comprises: (1) SIB2 contains cell re-selection information, mainly related to the serving cell; (2) SIB3 contains information about the serving frequency and intra-frequency neighbouring cells relevant for cell re-selection (including cell re-selection parameters common for a frequency as well as cell specific re-selection parameters); (3) SIB4 contains information about other NR frequencies and inter-frequency neighbouring cells relevant for cell re-selection (including cell re-selection parameters common for a frequency as well as cell specific re-selection parameters), which can also be used for NR idle/inactive measurements; (4) SIB5 contains information about E-UTRA frequencies and E-UTRA neighbouring cells relevant for cell re-selection (including cell re-selection parameters common for a frequency as well as cell specific re-selection parameters); (5) SIB6 contains an ETWS primary notification; (6) SIB7 contains an ETWS secondary notification; (7) SIB8 contains a CMAS warning notification; (8) SIB9 contains information related to GPS time and Coordinated Universal Time (UTC); (9) SIB10 contains the human-readable network names (HRNN) of the NPNs listed in SIB1; (10) SIB11 contains information related to idle/inactive measurements; (11) SIB15 contains information related to disaster roaming; (12) SIB16 contains slice-based cell reselection information; (13) SIB17 contains information related to TRS configuration for UEs in an RRC_IDLE/RRC_INACTIVE state; (14) SIBpos contains positioning assistance data as defined in TS 37.355 and TS 38.331; (15) SIB18 contains information related to the Group IDs for Network selection (GINs) associated with SNPNs listed in SIB1; and (16) SIB19 in TN contains NTN-specific parameters for NTN neighbour cells as defined in TS 38.331.

For sidelink, other SI also includes: (1) SIB12 contains information related to NR sidelink communication; (2) SIB13 contains information related to SystemInformationBlockType21 for V2X sidelink communication as specified in TS 38.331; (3) SIB14 contains information related to SystemInformationBlockType26 for V2X sidelink communication as specified in TS 36.331; and (4) SIB23 contains information related to ranging and sidelink positioning.

For non-terrestrial network, Other SI also includes: (1) SIB19 contains NTN-specific parameters for serving cell and optionally NTN-specific parameters for neighbour cells as defined in TS 38.331; and (2) SIB25 contains TN coverage are information as defined in TS 38.331.

For MBS broadcast, Other SI also includes: (1) SIB20 contains MCCH configuration; and (2) SIB21 contains information related to service continuity for MBS broadcast reception.

For MBS multicast reception in an RRC_INACTIVE state, Other SI also includes SIB24 contains the information may acquire the multicast MCCH/MTCH configuration as defined in TS 38.331.

For ATG network, Other SI also includes SIB22 contains ATG-specific parameters for serving cell and optionally ATG-specific parameters for neighbour cells as defined in TS 38.331.

For a cell/frequency that is considered for camping by the UE, the UE may not acquire the contents of the minimum SI of that cell/frequency from another cell/frequency layer. This does not preclude the case that the UE applies stored SI from previously visited cell(s).

If the UE cannot determine the full contents of the minimum SI of a cell by receiving from that cell, the UE may consider that cell as barred.

In case of BA, the UE only acquires SI on the active BWP.

If the UE is configured with inter cell beam management, the UE may not acquire the SI from the serving cell while the UE is receiving DL-SCH from a TRP with PCI different from serving cell's PCI.

Cell search is the procedure for a UE to acquire time and frequency synchronization with a cell and to detect the physical layer cell ID of the cell.

A UE receives the synchronization signals (SS) in order to perform cell search: the primary synchronization signal (PSS) and secondary synchronization signal (SSS) as defined in TS 38.211.

A UE assumes that reception occasions of a physical broadcast channel (PBCH), PSS, and SSS are in consecutive symbols, as defined in TS 38.211, and form a SS/PBCH block. The UE assumes that SSS, PBCH DM-RS, and PBCH data have same EPRE. The UE may assume that the ratio of PSS EPRE to SSS EPRE in a SS/PBCH block is either 0 dB or 3 dB. If the UE has not been provided dedicated higher layer parameters, the UE may assume that the ratio of PDCCH DMRS EPRE to SSS EPRE is within-8 dB and 8 dB when the UE monitors PDCCHs for a DCI format 1_0 with CRC scrambled by SI-RNTI, P-RNTI, or RA-RNTI, or for a DCI format 2_7, or for a DCI format 4_0.

For a half frame with SS/PBCH blocks, the first symbol indexes for candidate SS/PBCH blocks are determined according to the SCS of SS/PBCH blocks as follows, where index 0 corresponds to the first symbol of the first slot in a half-frame.

In one example of Case A-15 kHz SCS: the first symbols of the candidate SS/PBCH blocks have indexes of {2,8}+14·n. (1) For operation without shared spectrum channel access: (i) for carrier frequencies smaller than or equal to 3 GHZ, n=0,1, and (ii) for carrier frequencies within FR1 larger than 3 GHZ, n=0, 1, 2, 3; and (2) for operation with shared spectrum channel access, as described in TS 37.213, n=0, 1, 2, 3, 4.

In one example, of Case B-30 kHz SCS: the first symbols of the candidate SS/PBCH blocks have indexes {4, 8, 16, 20}+28·n. For carrier frequencies smaller than or equal to 3 GHZ, n=0. For carrier frequencies within FR1 larger than 3 GHz, n=0, 1.

In one example of Case C-30 kHz SCS: the first symbols of the candidate SS/PBCH blocks have indexes {2,8}+14·n.

For operation without shared spectrum channel access: (1) for paired spectrum operation, for carrier frequencies smaller than or equal to 3 GHZ, n=0,1. For carrier frequencies within FR1 larger than 3 GHZ, n=0, 1, 2, 3; (2) for unpaired spectrum operation, for carrier frequencies smaller than 1.88 GHZ, n=0,1. For carrier frequencies within FR1 equal to or larger than 1.88 GHz, n=0, 1, 2, 3; and (3) for operation with shared spectrum channel access, n=0, 1, 2, 3, 4, 5, 6, 7, 8, 9.

In one example of Case D-120 kHz SCS: the first symbols of the candidate SS/PBCH blocks have indexes {4, 8, 16, 20}+28·n. For carrier frequencies within FR2, n=0, 1, 2, 3, 5, 6, 7, 8, 10, 11, 12, 13, 15, 16, 17, 18.

In one example of Case E-240 kHz SCS: the first symbols of the candidate SS/PBCH blocks have indexes {8, 12, 16, 20, 32, 36, 40, 44}+56·n. For carrier frequencies within FR2-1, n=0, 1, 2, 3, 5, 6, 7, 8.

In one example of Case F-480 kHz SCS: the first symbols of the candidate SS/PBCH blocks have indexes {2, 9}+14·n. For carrier frequencies within FR2-2, n=0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31.

In one example of Case G-960 kHz SCS: the first symbols of the candidate SS/PBCH blocks have indexes {2, 9}+14·n. For carrier frequencies within FR2-2, n=0, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31

From the above cases, if the SCS of SS/PBCH blocks is not provided by ssbSubcarrierSpacing, the applicable cases for a cell depend on a respective frequency band, as provided in TS 38.101-1 and TS 38.101-2. A same case applies for all SS/PBCH blocks on the cell. If a 30 kHz SS/PBCH block SCS is indicated by ssbSubcarrierSpacing, Case B applies for frequency bands with only 15 kHz SS/PBCH block SCS as specified in TS 38.101-1, and the case specified for 30 kHz SS/PBCH block SCS in TS 38.101-1 applies for frequency bands with 30 kHz SS/PBCH block SCS or both 15 kHz and 30 kHz SS/PBCH block SCS as specified in TS 38.101-1.

For a UE configured to operate with carrier aggregation over a set of cells in a frequency band of FR2 or with frequency-contiguous carrier aggregation over a set of cells in a frequency band of FR1, if the UE is provided SCS values by ssbSubcarrierSpacing for receptions of SS/PBCH blocks on any cells from the set of cells, the UE expects the SCS values to be same.

The candidate SS/PBCH blocks in a half frame are indexed in an ascending order in time from 0 to L̅ₘₐₓ−1, where L̅ₘₐₓ is determined according to SS/PBCH block patterns for Cases A through G. Lₘₐₓ is a maximum number of SS/PBCH block indexes in a cell, and the maximum number of transmitted SS/PBCH blocks within a half frame is Lₘₐₓ.

For operation without shared spectrum channel access in FR1 and FR2, and for operation with shared spectrum channel access in FR2-2, Lₘₐₓ=L̅ₘₐₓ.

For operation with shared spectrum channel access in FR1, Lₘₐₓ=8 for L̅ₘₐₓ=10 and 15 kHz SCS of SS/PBCH blocks and for L̅ₘₐₓ=20 and 30 kHz SCS of SS/PBCH blocks.

For L̅ₘₐₓ=4, a UE determines the 2 LSB bits of a candidate SS/PBCH block index per half frame from a one-to-one mapping with an index of the DM-RS sequence transmitted in the PBCH as described in TS 38.211.

For L̅ₘₐₓ>4, a UE determines the 3 LSB bits of a candidate SS/PBCH block index per half frame from a one-to-one mapping with an index of the DM-RS sequence transmitted in the PBCH as described in TS 38.211.

For L̅ₘₐₓ=10, the UE determines the 1 MSB bit of the candidate SS/PBCH block index from PBCH payload bit ā_{Ā+7} as described in TS 38.212.

For L̅ₘₐₓ=20, the UE determines the 2 MSB bits of the candidate SS/PBCH block index from PBCH payload bits ā_{Ā+6}, ā_{Ā+7} as described in TS 38.212.

For L̅ₘₐₓ=64, the UE determines the 3 MSB bits of the candidate SS/PBCH block index from PBCH payload bits ā_{Ā+5}, ā_{Ā+6}, ā_{Ā+7} as described in TS 38.212.

A UE can be provided per serving cell by ssb-periodicityServingCell a periodicity of the half frames for reception of the SS/PBCH blocks for the serving cell. If the UE is not configured a periodicity of the half frames for receptions of the SS/PBCH blocks, the UE assumes a periodicity of a half frame. A UE assumes that the periodicity is same for all SS/PBCH blocks in the serving cell.

For an initial cell selection, a UE may assume that half frames with SS/PBCH blocks occur with a periodicity of 2 frames.

For an operation without shared spectrum channel access, an SS/PBCH block index is same as a candidate SS/PBCH block index.

For an operation without shared spectrum channel access in FR2-2, a UE expects a MIB in a SS/PBCH block to provide subCarrierSpacingCommon=“scs30or120.

Upon a detection of a SS/PBCH block, the UE determines from MIB that a CORESET for Type0-PDCCH CSS set, as described in 3GPP specification, is present if k_{SSB}<24 (e.g., TS 38.211) for FR1 or if k_{SSB}<12 for FR2. The UE determines from MIB that a CORESET for Type0-PDCCH CSS set is not present if k_{SSB}>23 for FR1 or if k_{SSB}>11 for FR2; the CORESET for Type0-PDCCH CSS set may be provided by PDCCH-ConfigCommon.

For a serving cell without transmission of SS/PBCH blocks, a UE acquires time and frequency synchronization with the serving cell based on receptions of SS/PBCH blocks on the PCell, or on the PSCell, or on an SCell if applicable as described in TS 38.133, of the cell group for the serving cell.

If during a cell search a UE determines from MIB that a CORESET for Type0-PDCCH CSS set is present, the UE determines a number of consecutive resource blocks and a number of consecutive symbols for the CORESET of the Type0-PDCCH CSS set from controlResourceSetZero in pdcch-ConfigSIB1, as described in Tables 13-0 through 13-10 as shown in TS 38.213, for operation without shared spectrum channel access in FR1 and FR2-1, or as described in Tables 13-1A and 13-4A as shown in TS 38.213 for operation with shared spectrum channel access in FR1, or as described in Table 13-10A as shown in TS 38.213 for FR2-2, and determines PDCCH monitoring occasions from searchSpaceZero in pdcch-ConfigSIB1, included in MIB, as described in Tables 13-11 through 13-15A as shown in TS 38.213.

SFN_{c} and n_{c} are the SFN and slot index within a frame of the CORESET based on SCS of the CORESET and SFN_{SSB,i} and n_{SSB,i} are the SFN and slot index based on SCS of the CORESET, respectively, where the SS/PBCH block with index i overlaps in time with system frame SFN_{SSB,i} and slot n_{SSB,i}. The symbols of the CORESET associated with pdcch-ConfigSIB1 in MIB or with searchSpaceSIB1 in PDCCH-ConfigCommon have normal cyclic prefix. In Table 13-0 of TS 38.213, configurations with index 0 to 9 are applicable when an associated SS/PBCH block is located according to Table 5.4.3.3-2 in TS 38.101-1, configurations with index 10 to 11 are applicable when an associated SS/PBCH block is located according to NOTE 12 of Table 5.4.3.3-1 in TS 38.101-1, and non-interleaved CCE-to-REG mapping applies for configurations with index 6 to 9. In Table 13-1 of TS 38.213, the associated SS/PBCH block is not located according to NOTE 12 of Table 5.4.3.3-1 in TS 38.101-1.

For an operation with shared spectrum channel access in FR2-2 and for operation without shared spectrum channel access, a UE assumes that the offset in Tables 13-0 through 13-10A of TS 38.213 is defined with respect to the SCS of the CORESET for Type0-PDCCH CSS set from the smallest RB index of the CORESET for Type0-PDCCH CSS set to the smallest RB index of the common RB overlapping with the first RB of the corresponding SS/PBCH block, after puncturing as shown in TS 38.211. The SCS of the CORESET for Type0-PDCCH CSS set is provided by subCarrierSpacingCommon for FR1 and FR2-1 and same as the SCS of the corresponding SS/PBCH block for FR2-2. In Tables 13-7, 13-8, and 13-10 of TS 38.213, k_{SSB} is defined in TS 38.211.

For an operation with shared spectrum channel access in FR1, a UE determines an offset from a smallest RB index of the CORESET for Type0-PDCCH CSS set to a smallest RB index of the common RB overlapping with a first RB of the corresponding SS/PBCH block.

According to the offset in Table 13-1A or Table 13-4A of TS 38.213, if the frequency position of the SS/PBCH block corresponds to the GSCN of a synchronization raster entry as defined in TS 38.101-1.

According to a sum of a first offset and a second offset if the frequency position of the SS/PBCH block is provided by ssbFrequency in a measurement configuration associated with a reporting configuration providing reportCGI and does not correspond to the GSCN of a synchronization raster entry as defined in TS 38.101-1, where: (1) the first offset is provided in Table 13-1A or Table 13-4A of TS 38.213 and (2) the second offset is determined as the offset from a smallest RB index of the common RB overlapping with the first RB of the SS/PBCH block indicated in the measurement configuration to a smallest RB index of the common RB overlapping with the first RB of a SS/PBCH block hypothetically located at the GSCN of a synchronization raster entry, where the single synchronization raster entry is located in the same channel as the SS/PBCH block used for the shared spectrum channel access procedure, as described in TS 37.213. Where the offsets are defined with respect to the SCS of the CORESET for Type0-PDCCH CSS set that is same as the SCS of the corresponding SS/PBCH block.

For an operation without shared spectrum channel access and for the SS/PBCH block and CORESET multiplexing pattern 1, a UE monitors PDCCH in the Type0-PDCCH CSS set over two slots. For SS/PBCH block with index i, the UE determines an index of slot n₀ as

$${n}_{0} = ( O \cdot {2}^{μ} + ⌊ i \cdot M ⌋ ) mod {N}_{slot}^{frame , μ}$$

that is in a frame with system frame number (SFN) SFN_{C} satisfying

$${SFN}_{c} mod 2 = 0 if ⌊ O \cdot {2}^{μ} + ⌊ i \cdot M ⌋ ) / {N}_{slot}^{frame , μ} ⌋ mod 2 = 0 ,$$

or in a frame with SFN satisfying

$${SFN}_{c} mod 2 = 1 if ⌊ O \cdot {2}^{μ} + ⌊ i \cdot M ⌋ ) / {N}_{slot}^{frame , μ} ⌋ mod 2 = 1$$

where μ∈{0, 1, 2, 3, 5, 6} based on the SCS for PDCCH receptions in the CORESET (e.g., TS 38.211).

For μ∈{0, 1, 2, 3} and for a SS/PBCH block index i, the two slots including the associated Type0-PDCCH monitoring occasions are slots n₀ and n₀+1. M, O, and the index of the first symbol of the CORESET in slots n₀ and n₀+1 are provided by Table 13-11 and Table 13-12 of TS 38.213.

For μ=5 and for a SS/PBCH block index i, the two slots including the associated Type0-PDCCH monitoring occasions are slots n₀ and n₀+4. M, O, and the index of the first symbol of the CORESET in slots n₀ and n₀+4 are provided by Table 13-12A of TS 38.213, where X=1.25.

For μ=6 and for a SS/PBCH block index i, the two slots including the associated Type0-PDCCH monitoring occasions are slots n₀ and n₀+8. M, O, and the index of the first symbol of the CORESET in slots n₀ and n₀+8 are provided by Table 13-12A of TS 38.213, where X=0.625.

For an operation with shared spectrum channel access and for the SS/PBCH block and CORESET multiplexing pattern 1, a UE monitors PDCCH in the Type0-PDCCH CSS set over slots that include Type0-PDCCH monitoring occasions associated with SS/PBCH blocks that are quasi co-located with the SS/PBCH block that provides a CORESET for Type0-PDCCH CSS set with respect to average gain, quasi co-location “typeA” and “typeD” properties, when applicable (e.g., TS 38.214).

For a candidate SS/PBCH block index ī, where 0≤ī≤L̅ₘₐₓ−1, two slots include the associated Type0-PDCCH monitoring occasions. The UE determines an index of slot n₀ as

$${n}_{0} = ( O \cdot {2}^{μ} + ⌊ \overline{ι} \cdot M ⌋ ) mod {N}_{slot}^{frame , μ}$$

that is in a frame with system frame number (SFN) SFN_{C} satisfying

$${SFN}_{c} mod 2 = 0 if ⌊ O \cdot {2}^{μ} + ⌊ \overline{ι} \cdot M ⌋ ) / {N}_{slot}^{frame , μ} ⌋ mod 2 = 0 ,$$

or in a frame with SFN satisfying

$${SFN}_{c} mod 2 = 1 if ⌊ ( O \cdot {2}^{μ} + ⌊ \overline{ι} \cdot M ⌋ ) / {N}_{slot}^{frame , μ} ⌋ mod 2 = 1 ,$$

where μ∈{0, 1, 3, 5, 6} based on the SCS for PDCCH receptions in the CORESET (e.g., TS 38.211).

For μ∈{0, 1} and for a candidate SS/PBCH block index ī, the two slots including the associated Type0-PDCCH monitoring occasions are slots n₀ and n₀+1. M, O, and the index of the first symbol of the CORESET in slots n₀ and n₀+1 are provided by Table 13-11 of TS 38.213. The UE does not expect to be configured with M=1/2, or with M=2, when

$${N}_{S S B}^{QCL} = 1.$$

For μ=3 and for a candidate SS/PBCH block index ī, the two slots including the associated Type0-PDCCH monitoring occasions are slots n₀ and n₀+1. M, O, and the index of the first symbol of the CORESET in slots n₀ and n₀+1 are provided by Table 13-12 of TS 38.213.

For μ=5 and for a candidate SS/PBCH block index ī, the two slots including the associated Type0-PDCCH monitoring occasions are slots n₀ and n₀+4. M, O, and the index of the first symbol of the CORESET in slots n₀ and n₀+4 are provided by Table 13-12A of TS 38.213, where X=1.25.

For μ=6 and for a candidate SS/PBCH block index ī, the two slots including the associated Type0-PDCCH monitoring occasions are slots n₀ and n₀+8. M, O, and the index of the first symbol of the CORESET in slots n₀ and n₀+8 are provided by Table 13-12A of TS 38.213, where X=0.625.

For an operation without shared spectrum channel access and for the SS/PBCH block and CORESET multiplexing patterns 2 and 3, a UE monitors PDCCH in the Type0-PDCCH CSS set over one slot with Type0-PDCCH CSS set periodicity equal to the periodicity of SS/PBCH block. For a SS/PBCH block with index ī, the UE determines the slot index n_{c} and SFN_{c} based on parameters provided by Tables 13-13 through 13-15A of TS 38.213.

For an operation with shared spectrum channel access and for SS/PBCH block and CORESET multiplexing pattern 3, a UE monitors PDCCH in the Type0-PDCCH CSS set over slots that include Type0-PDCCH monitoring occasions associated with SS/PBCH blocks that are quasi co-located with the SS/PBCH block that provides a CORESET for Type0-PDCCH CSS set with respect to average gain, quasi co-location “typeA” and “typeD” properties, when applicable. For a candidate SS/PBCH block index ī, where 0≤ī≤L̅ₘₐₓ−1, the periodicity of the slot including the associated Type0-PDCCH monitoring occasion is same as the periodicity of the candidate SS/PBCH block, and the UE determines the slot index n_{c} and SFN_{c} based on parameters provided by Tables 13-15 and 13-15A of TS 38.213, where i is replaced by ī for operation with shared spectrum channel access in FR2-2.

For the SS/PBCH block and CORESET multiplexing patterns 2 and 3, if the active DL BWP is the initial DL BWP, the UE is expected to be able to perform radio link monitoring, and measurements for radio resource management (e.g., TS 38.133) using a SS/PBCH block that provides a CORESET for Type0-PDCCH CSS set.

If a UE detects a first SS/PBCH block and determines that a CORESET for Type0-PDCCH CSS set is not present, and for 24≤k_{SSB}≤29 for FR1 or for 12≤k_{SSB}≤13 for FR2, the UE may determine the nearest (in the corresponding frequency direction) global synchronization channel number (GSCN) of a second SS/PBCH block having a CORESET for an associated Type0-PDCCH CSS set as

$${N}_{GSCN}^{Reference} + {N}_{GSCN}^{Size} \cdot {N}_{GSCN}^{Offset} \cdot {N}_{GSCN}^{Reference}$$

is the GSCN of the first SS/PBCH block,

$${N}_{GSCN}^{Size} = 1 in Fr 1 and FR 2 - 1 , {N}_{GSCN}^{Size} = 3 in FR 2 - 2 , and {N}_{GSCN}^{Offset}$$

is a GSCN offset provided by Table 13-16 of TS 38.213 for FR1 and Table 13-17 of TS 38.213 for FR2. If the UE detects the second SS/PBCH block and the second SS/PBCH block does not provide a CORESET for Type0-PDCCH CSS set, the UE may ignore the information related to GSCN of SS/PBCH block locations for performing cell search.

If a UE detects a SS/PBCH block and determines that a CORESET for Type0-PDCCH CSS set is not present, and for k_{SSB}=31 for FR1 or for k_{SSB}=15 for FR2, the UE determines that there is no SS/PBCH block having an associated Type0-PDCCH CSS set within a GSCN range

$$[ {N}_{GSCN}^{Reference} - {N}_{GSCN}^{Start} , {N}_{GSCN}^{Reference} + {N}_{GSCN}^{End} ] .$$

$${N}_{GSCN}^{Start} and {N}_{GSCN}^{End}$$

are respectively determined by controlResourceSetZero and searchSpaceZero in pdcch-ConfigSIB1. If the GSCN range is

$$[ {N}_{GSCN}^{Reference} , {N}_{GSCN}^{Reference} ] ,$$

the UE determines that there is no information for a second SS/PBCH block with a CORESET for an associated Type0-PDCCH CSS set on the detected SS/PBCH block.

If a UE does not detect any SS/PBCH block providing a CORESET for Type0-PDCCH CSS set, within a time period determined by the UE, the UE may ignore the information related to GSCN of SS/PBCH locations in performing cell search.

Paging allows the network to reach UEs in an RRC_IDLE state and in an RRC_INACTIVE state through Paging messages, and to notify UEs in an RRC_IDLE state, an RRC_INACTIVE state and an RRC_CONNECTED state of system information change and ETWS/CMAS indications through Short Messages. Both Paging messages and Short Messages are addressed with P-RNTI on PDCCH, but while the former is sent on PCCH, the latter is sent over PDCCH directly (e.g., TS 38.331).

While in an RRC_IDLE state the UE monitors the paging channels for CN-initiated paging. While in an RRC_INACTIVE state with no ongoing SDT procedure, the UE monitors paging channels for RAN-initiated paging and CN-initiated paging. A UE may not monitor paging channels continuously though; paging DRX is defined where the UE in an RRC_IDLE state or an RRC_INACTIVE state is only necessary to monitor paging channels during one paging occasion (PO) per DRX cycle (e.g., TS 38.304).

The paging DRX cycles are configured by the network: (1) for CN-initiated paging, a default cycle is broadcast in system information; (2) for CN-initiated paging, a UE specific cycle can be configured via NAS signalling; and (3) for RAN-initiated paging, a UE-specific cycle is configured via RRC signalling, where the UE uses the shortest of the DRX cycles applicable i.e., a UE in an RRC_IDLE state uses the shortest of the first two cycles above, while a UE in an RRC_INACTIVE state uses the shortest of the three.

The POs of a UE for CN-initiated and RAN-initiated paging are based on the same UE ID, resulting in overlapping POs for both. The number of different POs in a DRX cycle is configurable via system information and a network may distribute UEs to those POs based on their IDs.

While in an RRC_CONNECTED state and while in an RRC_INACTIVE state with ongoing SDT procedure, the UE monitors the paging channels in any PO signalled in system information for SI change indication and PWS notification. In case of BA, a UE in an RRC_CONNECTED state only monitors paging channels on the active BWP with common search space configured.

For operation with shared spectrum channel access, a UE can be configured for an additional number of PDCCH monitoring occasions in its PO to monitor for paging. However, when the UE detects a PDCCH transmission within the UE's PO addressed with P-RNTI, the UE may not monitor the subsequent PDCCH monitoring occasions within this PO.

If a paging cause is included in the paging message, a UE in an RRC_IDLE state or an RRC_INACTIVE state may use the paging cause as per TS 23.501.

In one example of paging optimization for UEs in CM_IDLE, at UE context release, the NG-RAN node may provide the AMF with a list of recommended cells and NG-RAN nodes as assistance info for subsequent paging. The AMF may also provide paging attempt information comprising a paging attempt count and the intended number of paging attempts and may include the next paging area scope. If paging attempt information is included in the paging message, each paged NG-RAN node receives the same information during a paging attempt.

The paging attempt count may be increased by one at each new paging attempt. The next paging area scope, when present, indicates whether the AMF plans to modify the paging area currently selected at next paging attempt. If the UE has changed its state to CM CONNECTED, the paging attempt count is reset.

In one example of paging optimization for UEs in an RRC_INACTIVE state, at RAN paging, the serving NG-RAN node provides RAN paging area information. The serving NG-RAN node may also provide RAN paging attempt information. Each paged NG-RAN node receives the same RAN paging attempt information during a paging attempt with the following content: paging attempt count, the intended number of paging attempts and the next paging area scope. The paging attempt count may be increased by one at each new paging attempt. The next paging area scope, when present, indicates whether the serving NG_RAN node plans to modify the RAN paging area currently selected at next paging attempt. If the UE leaves from an RRC_INACTIVE state, the paging attempt count is reset.

In one example of UE power saving for paging monitoring, in order to reduce UE power consumption due to false paging alarms, the group of UEs monitoring the same PO can be further divided into multiple subgroups. With subgrouping, a UE may monitor PDCCH in its PO for paging if the subgroup to which the UE belongs is paged as indicated via associated PEI. If a UE cannot find its subgroup ID with the PEI configurations in a cell or if the UE is unable to monitor the associated PEI occasion corresponding to its PO, the UE may monitor the paging in its PO.

These subgroups have the following characteristics: (1) they are formed based on either CN controlled subgrouping or UE ID based subgrouping; (2) if CN controlled subgroup ID is not provided from AMF, UE ID based subgrouping is used if supported by the UE and network; (3) the RRC state (an RRC_IDLE state or an RRC_INACTIVE state) does not impact which subgroup the UE belongs to; (4) subgrouping support for a cell is broadcast in the system information as one of the following: Only CN controlled subgrouping supported, only UE ID based subgrouping supported, or both CN controlled subgrouping and UE ID based subgrouping supported; (5) a total number of subgroups allowed in a cell is up to 8 and represents the sum of CN controlled and UE ID based subgrouping configured by the network; and (6) a UE configured with CN controlled subgroup ID applies CN controlled subgroup ID if the cell supports CN controlled subgrouping; otherwise, it derives UE ID based subgroup ID if the cell supports only UE ID based subgrouping.

PEI associated with subgroups has the following characteristics, if the PEI is supported by the UE, it may at least support UE ID based subgrouping method: (i) PEI monitoring can be limited via system information to the last used cell (i.e., the cell in which the UE most recently received RRCRelease without indicating that the last used cell for PEI may not be updated); (ii) a PEI-capable UE may store its last used cell information; (iii) gNBs supporting the PEI monitoring to the last used cell function provide the UE's last used cell information to the AMF in the NG-AP UE Context Release Complete message for PEI capable UEs, as described in TS 38.413; and (iv) a UE that expects MBS group notification may ignore the PEI and may monitor paging in its PO.

In one example of CN controlled subgrouping, for CN controlled subgrouping, AMF is responsible for assigning subgroup ID to the UE. The total number of subgroups for CN controlled subgrouping which can be configured, e.g., by OAM is up to 8. It is assumed that CN controlled subgrouping support is homogeneous within an RNA: (1) the UE indicates its support of CN controlled subgrouping via NAS signalling; (2) if the UE supports CN controlled subgrouping, the AMF determines the subgroup ID assignment for the UE; (3) the AMF sends subgroup ID to the UE via NAS signalling; (4) the AMF informs the gNB about the CN assigned subgroup ID for paging the UE in an RRC_IDLE/RRC_INACTIVE state; (5) when the paging message for the UE is received from the CN or is generated by the gNB, the gNB determines the PO and the associated PEI occasion for the UE; and (6) before the UE is paged in the PO, the gNB transmits the associated PEI and indicates the corresponding CN controlled subgroup of the UE that is to be paged in the PEI.

In one example of UE ID based subgrouping, for UE ID based subgrouping, the gNB and UE can determine the subgroup ID based on the UE ID and the total number of subgroups for UE ID based subgrouping in the cell. The total number of subgroups for UE ID based subgrouping is decided by the gNB for each cell and can be different in different cells: (1) the gNB determines the total number of subgroups for UE ID based subgrouping in a cell; (2) the gNB broadcasts the total number of subgroups for UE ID based subgrouping in a cell; (3) a UE determines its subgroup in a cell; (4) when paging message for the PEI capable UE is received from the CN at the gNB or is generated by the gNB, the gNB determines the PO and the associated PEI occasion for the UE; and (5) before the UE is paged in the PO, the gNB transmits the associated PEI and indicates the corresponding subgroup derived based on UE ID of the UE that is paged in the PEI.

The random access procedure is triggered by a number of events such as: (1) an initial access from an RRC_IDLE state; (2) an RRC connection re-establishment procedure; (3) DL or UL data arrival, during an RRC_CONNECTED state or during an RRC_INACTIVE state while SDT procedure (see 3GPP Specification) is ongoing, when UL synchronisation status is “non-synchronised”; (4) UL data arrival, during an RRC_CONNECTED state or during an RRC_INACTIVE state while SDT procedure is ongoing, when there are no PUCCH resources for SR available; (5) a handover; (6) SR failure; (7) an explicit request by RRC upon synchronous reconfiguration; (8) an RRC connection resume procedure from an RRC_INACTIVE state; (9) to establish time alignment for a primary or a secondary TAG; (10) a request for Other SI (see 3GPP specification); (11) a beam failure recovery; (12) consistent UL LBT failure on SpCell; (13) SDT in an RRC_INACTIVE state (see 3GPP specification); (14) positioning purpose during an RRC_CONNECTED state requiring random access procedure, e.g., when timing advance is necessary for UE positioning; (15) early UL synchronization with an LTM candidate cell; and (16) RACH-based LTM cell switch.

Two types of random access procedure are supported: 4-step RA type with MSG1 and 2-step RA type with MSGA. Both types of RA procedure support contention-based random access (CBRA) and contention-free random access (CFRA).

The MSG1 of the 4-step RA type comprises a preamble on PRACH. After MSG1 transmission, the UE monitors for a response from the network within a configured window. For CFRA, dedicated preamble for MSG1 transmission is assigned by the network and upon receiving random access response from the network, the UE ends the random access procedure. For CBRA, upon reception of the random access response, the UE sends MSG3 using the UL grant scheduled in the response and monitors contention resolution. If contention resolution is not successful after MSG3 (re)transmission(s), the UE goes back to MSG1 transmission.

The MSGA of the 2-step RA type includes a preamble on PRACH and a payload on PUSCH. After MSGA transmission, the UE monitors for a response from the network within a configured window. For CFRA, dedicated preamble and PUSCH resource are configured for MSGA transmission and upon receiving the network response, the UE ends the random access procedure. For CBRA, if contention resolution is successful upon receiving the network response, the UE ends the random access procedure as shown in 3GPP specification; while if fallback indication is received in MSGB, the UE performs MSG3 transmission using the UL grant scheduled in the fallback indication and monitors contention resolution. If contention resolution is not successful after MSG3 (re)transmission(s), the UE goes back to MSGA transmission.

If the random access procedure with 2-step RA type is not completed after a number of MSGA transmissions, the UE can be configured to switch to CBRA with 4-step RA type.

For the random access procedure towards an LTM candidate cell for early UL TA acquisition, CFRA triggered by a PDCCH order is used. The UE sends MSG1 towards the cell without monitoring for a response from it. To support UE power ramping, the UE may perform MSG1 retransmission as indicated by the network.

For a random access in a cell configured with SUL, the network can explicitly signal which carrier to use (UL or SUL). Otherwise, the UE selects the SUL carrier if and only if the measured quality of the DL is lower than a broadcast threshold. UE performs carrier selection before selecting between 2-step and 4-step RA type. The RSRP threshold for selecting between 2-step and 4-step RA type can be configured separately for UL and SUL. Once started, all uplink transmissions of the random access procedure remain on the selected carrier.

The network can associate a set of RACH resources with feature(s) applicable to a random access procedure: network slicing (see 3GPP specification), (e)RedCap, SDT, and NR coverage enhancement. A set of RACH resources associated with a feature is only valid for random access procedures applicable to at least that feature; and a set of RACH resources associated with several features is only valid for random access procedures having at least all of these features. The UE selects the set(s) of applicable RACH resources, after uplink carrier (i.e., NUL or SUL) and BWP selection and before selecting the RA type.

When CA is configured, random access procedure with 2-step RA type is only performed on PCell while contention resolution can be cross-scheduled by the PCell.

When CA is configured, for random access procedure with 4-step RA type, the first three steps of CBRA always occur on the PCell while contention resolution (step 4) can be cross-scheduled by the PCell. The three steps of a CFRA started on the PCell remain on the PCell. CFRA on SCell can only be initiated by the BS to establish timing advance for a secondary TAG: the procedure is initiated by the BS with a PDCCH order (step 0) that is sent on an activated SCell of the secondary TAG, preamble transmission (step 1) takes place on the SCell, and random access response (step 2) takes place on PCell.

When two TAG IDs are configured for the serving cell, the TAG for which the TA command is applied is indicated in a random access response message or in MSGB.

An NG-RAN node is either: (1) a BS, providing NR user plane and control plane protocol terminations towards the UE; or (2) an ng-BS, providing E-UTRA user plane and control plane protocol terminations towards the UE.

The BSs and ng-BSs are interconnected with each other by means of the Xn interface. The BSs and ng-BSs are also connected by means of the NG interfaces to the 5GC, more specifically to the access and mobility management function (AMF) by means of the NG-C interface and to the user plane function (UPF) by means of the NG-U interface (see TS 23.501).

The BS and ng-BS host the following functions: (1) functions for radio resource management: radio bearer control, radio admission control, connection mobility control, dynamic allocation of resources to UEs in uplink, downlink and sidelink (scheduling); (2) IP and Ethernet header compression, uplink data decompression, encryption and integrity protection of data; (3) selection of an AMF at UE attachment when no routing to an AMF can be determined from the information provided by the UE; (4) routing of User Plane data towards UPF(s); (5) routing of control plane information towards AMF; (6) connection setup and release; (7) scheduling and transmission of paging messages; (8) scheduling and transmission of system broadcast information (originated from the AMF or OAM); (9) measurement and measurement reporting configuration for mobility and scheduling; (10) transport level packet marking in the uplink; (11) session management; (12) support of network slicing; (13) QoS Flow management and mapping to data radio bearers; (14) support of UEs in an RRC_INACTIVE state; (15) distribution function for NAS messages; (16) radio access network sharing; (17) dual Connectivity; (18) tight interworking between NR and E-UTRA; (19) maintain security and radio configuration for user plane CIoT 5GS Optimisation, as defined in TS 23.501 (ng-BS only). BL UE or UE in enhanced coverage is only supported by ng-BS (see TS 36.300) and NB-IoT UE is only supported by ng-BS (see TS 36.300).

The Xn user plane (Xn-U) interface is defined between two NG-RAN nodes. The transport network layer is built on IP transport and GTP-U is used on top of UDP/IP to carry the user plane PDUs.

Xn-U provides non-guaranteed delivery of user plane PDUs and supports the following functions: (1) data forwarding and (2) flow control.

The Xn control plane interface (Xn-C) is defined between two NG-RAN nodes. The transport network layer is built on SCTP on top of IP. The application layer signalling protocol is referred to as Xn application protocol (XnAP). The SCTP layer provides the guaranteed delivery of application layer messages. In the transport IP layer point-to-point transmission is used to deliver the signalling PDUs.

The Xn-C interface supports the following functions: (1) Xn interface management; (2) UE mobility management, including context transfer and RAN paging; (3) dual connectivity.

NG-RAN supports radio access network sharing as defined in TS 23.501.

If NR access is shared, system information broadcast in a shared cell indicates a TAC and a cell identity for each subset of PLMNs, PNI-NPNs and SNPNs. NR access provides only one TAC and one cell identity per cell per PLMN, SNPN or PNI-NPN. In this version of the specification, a cell identity can only belong to one network type among PLMN, PNI-NPN or SNPN as defined in TS 23.501.

Each cell identity associated with a subset of PLMNs, SNPNs or PNI-NPNs identifies its serving NG-RAN node.

The PDCCH can be used to schedule DL transmissions on PDSCH and UL transmissions on PUSCH, where the DCI on PDCCH includes: (1) downlink assignments containing at least modulation and coding format, resource allocation, and hybrid-ARQ information related to DL-SCH; and (2) uplink scheduling grants containing at least modulation and coding format, resource allocation, and hybrid-ARQ information related to UL-SCH.

In addition to scheduling, PDCCH can be used to for: (1) activation and deactivation of configured PUSCH transmission with configured grant; (2) activation and deactivation of PDSCH semi-persistent transmission; (3) notifying one or more UEs of the slot format; (4) notifying one or more UEs of the PRB(s) and OFDM symbol(s) where the UE may assume no transmission is intended for the UE; (5) transmission of TPC commands for PUCCH and PUSCH; (6) transmission of one or more TPC commands for SRS transmissions by one or more UEs; (7) switching a UE's active bandwidth part; (8) initiating a random access procedure; (9) indicating the UE(s) to monitor the PDCCH during the next occurrence of the DRX on-duration; (10) in IAB context, indicating the availability for soft symbols of an IAB-DU; (11) triggering one shot HARQ-ACK codebook feedback; and (12) for operation with shared spectrum channel access: (i) triggering search space set group switching; (ii) indicating one or more UEs about the available RB sets and channel occupancy time duration; and (iii) indicating downlink feedback information for configured grant PUSCH (CG-DFI).

A UE monitors a set of PDCCH candidates in the configured monitoring occasions in one or more configured CORESETs according to the corresponding search space configurations.

A CORESET comprises a set of PRBs with a time duration of 1 to 3 OFDM symbols. The resource units resource element groups (REGs) and control channel elements (CCEs) are defined within a CORESET with each CCE comprises a set of REGs. Control channels are formed by aggregation of CCE. Different code rates for the control channels are realized by aggregating different number of CCE. Interleaved and non-interleaved CCE-to-REG mapping are supported in a CORESET. The PDCCH repetition is operated by using two search spaces which are explicitly linked by configuration provided by the RRC layer and are associated with corresponding CORESETs.

For PDCCH repetition, two linked search spaces are configured with the same number of candidates, and two PDCCH candidates in two search spaces are linked with the same candidate index. When PDCCH repetition is scheduled to a UE, an intra-slot repetition is allowed and each repetition has the same number of CCEs and coded bits and corresponds to the same DCI payload.

Polar coding is used for PDCCH.

Each resource element group carrying PDCCH carries its own DMRS.

QPSK modulation is used for PDCCH.

For scheduling at cell level, the following identities are used: (1) C-RNTI: unique UE identification used as an identifier of the RRC Connection and for scheduling; (2) CG-SDT-CS-RNTI: unique UE identification used for Configured Grant-based SDT in the uplink; (3) CI-RNTI: identification of cancellation in the uplink; (4) CS-RNTI: unique UE identification used for Semi-Persistent Scheduling in the downlink or configured grant in the uplink; (5) INT-RNTI: identification of pre-emption in the downlink; (6) MCS-C-RNTI: unique UE identification used for indicating an alternative MCS table for PDSCH and PUSCH; (7) P-RNTI: identification of Paging and System Information change notification in the downlink; (8) SI-RNTI: identification of Broadcast and System Information in the downlink; (9) SP-CSI-RNTI: unique UE identification used for semi-persistent CSI reporting on PUSCH.

For power and slot format control, the following identities are used: (1) SFI-RNTI: identification of slot format; (2) TPC-PUCCH-RNTI: unique UE identification to control the power of PUCCH; (3) TPC-PUSCH-RNTI: unique UE identification to control the power of PUSCH; and (4) TPC-SRS-RNTI: unique UE identification to control the power of SRS.

During the random access procedure, the following identities are also used: (1) RA-RNTI: identification of the random access response in the downlink; (2) MSGB-RNTI: identification of the random access response for 2-step RA type in the downlink; (3) temporary C-RNTI: UE identification temporarily used for scheduling during the random access procedure; and (4) random value for contention resolution: UE identification temporarily used for contention resolution purposes during the random access procedure.

For NR connected to 5GC, the following UE identity is used at NG-RAN level: I-RNTI: used to identify the UE context in an RRC_INACTIVE state.

For UE power saving purpose, the following identities are used: (1) PS-RNTI: used to determine if the UE may monitor PDCCH on the next occurrence of the connected mode DRX on-duration; and (2) PEI-RNTI: used to determine if the UE may monitor the associated PO.

For IAB the following identity is used: AI-RNTI: identification of the DCI carrying availability indication for soft symbols of an IAB-DU.

For network-controlled repeater, the following identity is used: NCR-RNTI: identification of the DCI carrying side control information.

For MBS, the following identities are used: (1) G-RNTI: Identifies dynamically scheduled PTM transmissions of MTCH(s); (2) G-CS-RNTI: Identifies configured scheduled PTM transmissions of MTCH(s) scheduled with configured grant; (3) MCCH-RNTI: Identifies transmissions of MCCH and MCCH change notification for broadcast reception; and (4) multicast MCCH-RNTI: Identifies transmissions of MCCH and MCCH change notification for multicast reception in an RRC_INACTIVE state.

For sidelink, the following identities are used: (1) SL-RNTI: unique UE identification used for NR sidelink communication scheduling; (2) SL-CS-RNTI: unique UE identification used for configured sidelink grant for NR sidelink communication; (3) SL semi-persistent Scheduling V-RNTI: unique UE identification used for semi-persistent scheduling for V2X sidelink communication; (4) SL-PRS-RNTI: unique UE identification used for SL-PRS transmission scheduling on dedicated SL-PRS resource pool; and (5) SL-PRS-CS-RNTI: unique UE identification used for configured sidelink grant for SL-PRS transmission on dedicated SL-PRS resource pool.

Cross-carrier scheduling with the carrier indicator field (CIF) allows the PDCCH of a serving cell to schedule resources on another serving cell but with the following restrictions: (1) when cross-carrier scheduling from an SCell to PCell is not configured, PCell can only be scheduled via its PDCCH; (2) when cross-carrier scheduling from an SCell to PCell is configured: (i) PDCCH on that SCell can schedule PCell's PDSCH and PUSCH, (ii) PDCCH on the PCell can schedule PCell's PDSCH and PUSCH but cannot schedule PDSCH and PUSCH on any other cell, and (iii) only one SCell can be configured to be used for cross-carrier scheduling to PCell; (3) when an SCell is configured with a PDCCH, that cell's PDSCH and PUSCH are always scheduled by the PDCCH on this SCell; (4) when an SCell is not configured with a PDCCH, that SCell's PDSCH and PUSCH are always scheduled by a PDCCH on another serving cell; and (5) the scheduling PDCCH and the scheduled PDSCH/PUSCH can use the same or different numerologies.

The PDCCH monitoring activity of the UE in RRC connected mode is governed by DRX, BA, DCP and cell DTX.

When DRX is configured, the UE does may not continuously monitor PDCCH. DRX is characterized by the following: (1) on-duration: duration that the UE waits for, after waking up, to receive PDCCHs. If the UE successfully decodes a PDCCH, the UE stays awake and starts the inactivity timer; (2) inactivity-timer: duration that the UE waits to successfully decode a PDCCH, from the last successful decoding of a PDCCH, failing which the UE can go back to sleep. The UE may restart the inactivity timer following a single successful decoding of a PDCCH for a first transmission only (i.e., not for retransmissions); (3) retransmission-timer: duration until a retransmission can be expected; (4) cycle: specifies the periodic repetition of the on-duration followed by a possible period of inactivity; and (5) active-time: total duration that the UE monitors PDCCH. This includes the “on-duration” of the DRX cycle, the time UE is performing continuous reception while the inactivity timer has not expired, and the time when the UE is performing continuous reception while waiting for a retransmission opportunity.

A SL UE can be configured with DRX, in which case, PDCCH providing SL grants can be send to the UE only during its active time.

When BA is configured, the UE only may monitor PDCCH on the one active BWP i.e., the UE may not monitor PDCCH on the entire DL frequency of the cell. A BWP inactivity timer (independent from the DRX inactivity-timer described above) is used to switch the active BWP to the default one: the timer is restarted upon successful PDCCH decoding and the switch to the default BWP takes place when the timer expires.

In addition, the UE may be indicated, when configured accordingly, whether the UE is necessary to monitor or not the PDCCH during the next occurrence of the on-duration by a DCP monitored on the active BWP. If the UE does not detect a DCP on the active BWP, the UE does not monitor the PDCCH during the next occurrence of the on-duration, unless the UE is explicitly configured to do so in that case.

A UE can only be configured to monitor DCP when connected mode DRX is configured, and at occasion(s) at a configured offset before the on-duration. More than one monitoring occasion can be configured before the on-duration. The UE does not monitor DCP on occasions occurring during active-time, measurement gaps, BWP switching, or when the UE monitors response for a CFRA preamble transmission for beam failure recovery, in which case the UE monitors the PDCCH during the next on-duration. If no DCP is configured in the active BWP, the UE follows normal DRX operation.

When CA is configured, DCP is only configured on the PCell.

One DCP can be configured to control PDCCH monitoring during on-duration for one or more UEs independently.

Power saving in an RRC_IDLE state and an RRC_INACTIVE state can also be achieved by a UE relaxing neighbour cells RRM measurements when the UE meets the criteria determining the UE is in low mobility and/or not at cell edge.

UE power saving may be enabled by adapting the DL maximum number of MIMO layers by BWP switching.

Power saving is also enabled during active-time via cross-slot scheduling, which facilitates a UE to achieve power saving with the assumption that the UE may not be scheduled to receive PDSCH, triggered to receive A-CSI or transmit a PUSCH scheduled by the PDCCH until the minimum scheduling offsets K0 and K2. Dynamic adaptation of the minimum scheduling offsets K0 and K2 is controlled by PDCCH.

Serving cells of a MAC entity may be configured by RRC in two DRX groups with separate DRX parameters. When RRC does not configure a secondary DRX group, there is only one DRX group and all serving cells belong to that one DRX group. When two DRX groups are configured, each serving cell is uniquely assigned to either of the two groups. The DRX parameters that are separately configured for each DRX group are on-duration and inactivity-timer.

UE power saving in an RRC_IDLE/RRC_INACTIVE state may be achieved by providing the configuration for TRS with CSI-RS for tracking in TRS occasions. The TRS in TRS occasions may allow UEs in an RRC_IDLE/RRC_INACTIVE state to sleep longer before waking up for its paging occasion. The TRS occasions configuration is provided in SIB17. The availability of TRS in the TRS occasions is indicated by L1 availability indication. These TRSs may also be used by the UEs configured with eDRX.

UE power saving may be achieved by UE relaxing measurements for RLM/BFD. When configured, UE determines whether the UE is in low mobility state and/or whether its serving cell radio link quality is better than a threshold. The configuration for low mobility and good serving cell quality criterion is provided through dedicated RRC signalling.

RLM and BFD relaxation may be enabled/disabled separately through RRC configuration. Additionally, RLM relaxation may be enabled/disabled on per cell group basis while BFD relaxation may be enabled/disabled on per serving cell basis.

The UE is only allowed to perform RLM and/or BFD relaxation when relaxed measurement criterion for low mobility and/or for good serving cell quality is met. If configured to do so, the UE may trigger reporting of its RLM and/or BFD relaxation status through UE assistance information if the UE changes its respective RLM and/or BFD relaxation status while meeting the UE minimum requirements specified in TS 38.133.

UE power saving may also be achieved through PDCCH monitoring adaptation mechanisms when configured by the network, including skipping of PDCCH monitoring and Search space set group (SSSG) switching. In this case UE does not monitor PDCCH during the PDCCH skipping duration except for the cases as specified in TS 38.213, or monitors PDCCH according to the search space sets applied in SSSG.

The function allows, for example in a deployment where capacity boosters can be distinguished from cells providing basic coverage, to optimize energy consumption enabling the possibility for an E-UTRA or NR cell providing additional capacity via single or dual connectivity, to be switched off when its capacity is no longer requested and to be re-activated on a need basis, or to support various adaptation techniques in time, frequency, spatial and power domains.

The solution for intra-system energy saving builds upon the possibility for the NG-RAN node owning a capacity booster cell to autonomously decide to switch-off such cell to lower energy consumption (inactive state). The decision is typically based on cell load information, consistently with configured information. The switch-off decision may also be taken by O&M.

The NG-RAN node may initiate handover actions in order to off-load the cell being switched off and may indicate the reason for handover with an appropriate cause value to support the target node in taking subsequent actions, e.g., when selecting the target cell for subsequent handovers. All neighbour NG-RAN nodes are informed by the NG-RAN node owning the concerned cell about the switch-off actions over the Xn interface, by means of the NG-RAN node configuration update procedure.

All informed nodes maintain the cell configuration data, e.g., neighbour relationship configuration, also when a certain cell is inactive. If basic coverage is ensured by NG-RAN node cells, NG-RAN node owning non-capacity boosting cells may request a re-activation over the Xn interface if capacity is necessary in such cells demand to do so. This is achieved via the Cell Activation procedure. During switch off time period of the boost cell, the NG-RAN node may prevent idle mode UEs from camping on this cell and may prevent incoming handovers to the same cell.

The NG-RAN node receiving a request may act accordingly. The switch-on decision may also be taken by O&M. All peer NG-RAN nodes are informed by the NG-RAN node owning the concerned cell about the re-activation by an indication on the Xn interface.

The solution also builds upon the possibility for the NG-RAN node owning a coverage cell to request neighbouring NG-RAN node(s) owning a capacity booster cell to switch on some SSB beams within the cell which are deactivated. The receiving NG-RAN node may act accordingly.

The solution also builds upon the possibility for an NG-RAN node to page certain UEs (e.g., stationary UEs) in an RRC_INACTIVE state on a limited set of beams, instead of paging on all the beams within the cell. It is up to the gNB's implementation to select the UEs in an RRC_INACTIVE state for which paging in limited set of beams applies. If the paging over the limited set of beams fails, the gNB performs subsequent paging by implementation, e.g., by ensuring the same paging message is repeated in all the transmitted SS/PBCH beams.

The solution for inter-system energy saving builds upon the possibility for the NG-RAN node owning a capacity booster cell to autonomously decide to switch-off such cell to dormant state. The decision is typically based on cell load information, consistently with configured information. The switch-off decision may also be taken by O&M. The NG-RAN node indicates the switch-off action to the eNB over NG interface and S1 interface. The NG-RAN node could also indicate the switch-on action to the eNB over NG interface and S1 interface.

The eNB providing basic coverage may request a NG-RAN node's cell re-activation based on its own cell load information or neighbour cell load information, the switch-on decision may also be taken by O&M. The eNB requests a NG-RAN node's cell re-activation and receives the NG-RAN node's cell re-activation reply from the NG-RAN node over the S1 interface and NG interface. Upon reception of the re-activation request, the NG-RAN node's cell may remain switched on at least until expiration of the minimum activation time. The minimum activation time may be configured by O&M or be left to the NG-RAN node's implementation.

The following methods describe cell DTX/DRX. To facilitate reducing gNB downlink transmission/uplink reception active time, UE can be configured with a periodic cell DTX/DRX pattern (i.e., active and non-active periods). The pattern configuration for cell DTX/DRX is common for the UEs configured with this feature in the cell. The cell DTX and cell DRX patterns can be configured and activated separately. A maximum of two cell DTX/DRX patterns can be configured per MAC entity for different serving cells. When cell DTX is configured and activated for the concerned cell, the UE may not monitor PDCCH in selected cases or does not monitor SPS occasions during cell DTX non-active duration. When cell DRX is configured and activated for the concerned cell, the UE does not transmit on CG resources or does not transmit a SR during cell DRX non-active duration. This feature is only applicable to UEs in an RRC_CONNECTED state and it does not impact random access procedure, SSB transmission, paging, and system information broadcasting. Cell DTX/DRX operation is only supported for single TRP scenario. Cell DTX/DRX can be activated/deactivated by RRC signalling or L1 group common signalling.

Cell DTX/DRX is characterized by the following: (1) active duration: duration that the UE waits for to receive PDCCHs or SPS occasions and transmit SR or CG. In this duration, the gNB transmission/reception of PDCCH, SPS, SR, CG, periodic and semi-persistent CSI report are not impacted for the purpose of network energy saving; and (2) cycle: specifies the periodic repetition of the active-duration followed by a period of non-active duration.

Active duration and cycle parameters are common between cell DTX and cell DRX, when both are configured.

Once the gNB recognizes there is an emergency call or public safety related service (e.g., MPS or MCS), the network may ensure that there is no impact to that service (e.g., it may release or deactivate cell DTX/DRX configuration). The network may also ensure that there is at least partial overlapping between UE's connected mode DRX on-duration and cell DTX/DRX active duration, i.e., the UE's connected mode DRX periodicity is a multiple of cell DTX/DRX periodicity or vice versa.

A same principle as for conditional handover of “normal” cells applies to conditional handover in case the source cell is using a network energy saving solution (e.g., the cell is activating cell DTX/DRX or turning off), unless hereunder specified. In this case, the following additional triggering conditions are supported, upon which UE may use NES-specific CHO event for executing CHO to a candidate cell, as defined in TS 38.331: the UE may be notified via DCI to enable CHO conditions(s) configured with NES event indication.

The following methods describe camping restrictions. If a cell is activating or going to activate NES cell DTX/DRX, the cell can allow the access of UEs capable of NES cell DTX/DRX via a single bit in SIB1 but prevent the access of UEs not capable of cell DTX/DRX using barring mechanisms.

The following methods describe SSB-less SCell. For an intra-band or inter-band CA SCell, a UE may obtain timing reference and AGC source from another serving cell in case the UE is not provided with SSB nor SMTC configuration for this SCell, as described in TS 38.331.

The following methods describe spatial and power domain adaptation. To assist the gNB on muting transceivers and/or adapting transmission power, the UE can be configured to report multiple CSI entries in a CSI report based on two or more sub-configurations, as specified in TS 38.214. Each sub-configuration corresponds to a spatial domain adaptation pattern (subsets of available spatial elements) and/or a power offset between PDSCH and CSI-RS.

If the UE is configured with a SCG, the UE may apply the procedures described in 3GPP specification for both MCG and SCG except for PDCCH monitoring in Type0/0A/0B/2/2A-PDCCH CSS sets where the UE may not apply the procedures for the SCG.

When the procedures are applied for MCG, the terms “secondary cell,” “secondary cells,” “serving cell,” and “serving cells” refer to secondary cell, secondary cells, serving cell, serving cells belonging to the MCG respectively.

When the procedures are applied for SCG, the terms “secondary cell,” “secondary cells,” “serving cell,” “serving cells” refer to secondary cell, secondary cells (not including PSCell), serving cell, serving cells belonging to the SCG respectively. The term “primary cell” refers to the PSCell of the SCG.

A UE monitors a set of PDCCH candidates in one or more CORESETs on the active DL BWP on each activated serving cell configured with PDCCH monitoring according to corresponding search space sets where monitoring implies receiving each PDCCH candidate and decoding according to the monitored DCI formats.

A set of PDCCH candidates for a UE to monitor is defined in terms of PDCCH search space sets. A search space set can be a CSS set or a USS set. A UE monitors PDCCH candidates in one or more of the following search spaces sets: (1) a Type0-PDCCH CSS set on the primary cell of the MCG configured by: (i) pdcch-ConfigSIB1 in MIB or by searchSpaceSIB1 in PDCCH-ConfigCommon or by searchSpaceZero in PDCCH-ConfigCommon for a DCI format 1_0 with CRC scrambled by a SI-RNTI, (ii) searchSpaceZero by providing searchSpaceID=0 for searchSpaceMCCH or searchSpaceMTCH for a DCI format 4_0 with CRC scrambled by a MCCH-RNTI or a G-RNTI for broadcast, or (iii) searchSpaceZero by providing searchSpaceID=0 for searchspaceMulticastMCCH for a DCI format 4_0 with CRC scrambled by a multicast-MCCH-RNTI, or by searchSpaceMulticastMTCH for a DCI format 4_1 with CRC scrambled by a G-RNTI for multicast in an RRC_INACTIVE state; (2) a Type0A-PDCCH CSS set configured by searchSpaceOtherSystemInformation in PDCCH-ConfigCommon for a DCI format 1_0 with CRC scrambled by a SI-RNTI on the primary cell of the MCG; (3) a Type0B-PDCCH CSS set configured by: (i) searchSpaceMCCH and searchSpaceMTCH for a DCI format 4_0 with CRC scrambled by a MCCH-RNTI or a G-RNTI for broadcast, on the primary cell of the MCG; and (ii) searchspaceMulticastMCCH for a DCI format 4_0 with CRC scrambled by a multicast-MCCH-RNTI, or by searchSpaceMulticastMTCH for a DCI format 4_1 with CRC scrambled by a G-RNTI for PDCCH receptions in an RRC_INACTIVE state; (4) a Type1-PDCCH CSS set configured by ra-SearchSpace in PDCCH-ConfigCommon for a DCI format with CRC scrambled by a RA-RNTI, a MsgB-RNTI, or a TC-RNTI on the primary cell; (5) a Type1A-PDCCH CSS set configured by sdt-SearchSpace in PDCCH-ConfigCommon for a DCI format with CRC scrambled by a C-RNTI or a CS-RNTI on the primary cell as described in 3GPP specification; (6) a Type2-PDCCH CSS set configured by pagingSearchSpace in PDCCH-ConfigCommon for a DCI format 1_0 with CRC scrambled by a P-RNTI on the primary cell of the MCG; (7) a Type2A-PDCCH CSS set configured by pei-SearchSpace in pei-ConfigBWP for a DCI format 2_7 with CRC scrambled by a PEI-RNTI on the primary cell of the MCG; (8) a Type3-PDCCH CSS set configured by: (i) SearchSpace in PDCCH-Config with searchSpaceType=common for DCI formats with CRC scrambled by INT-RNTI, SFI-RNTI, TPC-PUSCH-RNTI, TPC-PUCCH-RNTI, TPC-SRS-RNTI, CI-RNTI, or cellDTRX-RNTI and, only for the primary cell, C-RNTI, MCS-C-RNTI, CS-RNTI(s), or PS-RNTI, (ii) SearchSpace in pdcch-ConfigMulticast for DCI formats with CRC scrambled by G-RNTI, or G-CS-RNTI, or (iii) searchSpaceMCCH and searchSpaceMTCH on a secondary cell for a DCI format 4_0 with CRC scrambled by a MCCH-RNTI or a G-RNTI for broadcast; and (9) a USS set configured by: SearchSpace in PDCCH-Config with searchSpaceType=ue-Specific for DCI formats with CRC scrambled by C-RNTI, MCS-C-RNTI, SP-CSI-RNTI, CS-RNTI(s), SL-RNTI, SL-CS-RNTI, SL semi-persistent scheduling V-RNTI, or NCR-RNTI.

In the following, DCI formats with CRC scrambled by C-RNTI or CS-RNTI or MCS-C-RNTI are also referred to as unicast DCI formats, DCI formats with CRC scrambled by G-RNTI for multicast or G-CS-RNTI are also referred to as multicast DCI formats, and DCI formats with CRC scrambled by MCCH-RNTI or G-RNTI for broadcast scheduling PDSCH receptions are also referred to as broadcast DCI formats, and DCI formats with CRC scrambled by multicast-MCCH-RNTI or G-RNTI for multicast scheduling PDSCH receptions in an RRC_INACTIVE state are also referred as multicast DCI formats for an RRC_INACTIVE state.

For a DL BWP, if a UE is not provided searchSpaceSIB1 for Type0-PDCCH CSS set by PDCCH-ConfigCommon, the UE does not monitor PDCCH candidates for a Type0-PDCCH CSS set on the DL BWP. The Type0-PDCCH CSS set is defined by the CCE aggregation levels and the number of PDCCH candidates per CCE aggregation level given in 3GPP specification.

For a DL BWP, if a UE is not provided with searchSpaceOtherSystemInformation for Type0A-PDCCH CSS set, the UE does not monitor PDCCH for Type0A-PDCCH CSS set on the DL BWP. The CCE aggregation levels and the number of PDCCH candidates per CCE aggregation level for Type0A-PDCCH CSS set are given in Table 10.1-1 of TS 38.213.

For a DL BWP, if a UE is not provided ra-SearchSpace for Type1-PDCCH CSS set, the UE does not monitor PDCCH for Type1-PDCCH CSS set on the DL BWP. If the UE has not been provided with a Type3-PDCCH CSS set, or a Type1A-PDCCH CSS set, or an USS set and the UE has received a C-RNTI and has been provided with a Type1-PDCCH CSS set, the UE monitors PDCCH candidates for DCI format 0_0 and DCI format 1_0 with CRC scrambled by the C-RNTI in the Type1-PDCCH CSS set.

If a UE is not provided with pagingSearchSpace for Type2-PDCCH CSS set, the UE does not monitor PDCCH for Type2-PDCCH CSS set on the DL BWP. The CCE aggregation levels and the number of PDCCH candidates per CCE aggregation level for Type2-PDCCH CSS set are given in Table 10.1-1 of 3GPP specification.

If a UE is not provided with pei-SearchSpace for Type2A-PDCCH CSS set, the UE does not monitor PDCCH for Type2A-PDCCH CSS set on the DL BWP. The CCE aggregation levels and the maximum number of PDCCH candidates per CCE aggregation level for Type2A-PDCCH CSS set are given in Table 10.1-1 of TS38.213. If the UE is provided pei-SearchSpace with zero value for the Type2A-PDCCH CSS set index, and for the SS/PBCH block and CORESET multiplexing patterns 2 and 3, the UE determines PDCCH monitoring occasions as described in 3GPP specification and the CCE aggregation levels and the number of PDCCH candidates per CCE aggregation level for Type2A-PDCCH CSS set are given in TS38.213.

If a UE is provided a zero value for searchSpaceID in PDCCH-ConfigCommon for a Type0/0A/1A/2-PDCCH CSS set, the UE determines monitoring occasions for PDCCH candidates of the Type0/0A/1A/2-PDCCH CSS set as described in 3GPP specification, and the UE is provided a C-RNTI, the UE monitors PDCCH candidates only at monitoring occasions associated with a SS/PBCH block, where the SS/PBCH block is determined by the most recent of: (1) a MAC CE activation command indicating a TCI state of the active BWP that includes a CORESET with index 0, as described in TS 38.214, where the TCI-state includes a CSI-RS which is quasi-co-located with the SS/PBCH block; (2) a random access procedure that is not initiated by a PDCCH order that triggers a contention-free random access procedure, or (3) configured-grant based PUSCH transmission in an RRC_INACTIVE state as described in 3GPP specification.

If a UE monitors PDCCH candidates for DCI formats with CRC scrambled by a C-RNTI and the UE is provided a non-zero value for searchSpaceID in PDCCH-ConfigCommon for a Type0/0A/1A/2-PDCCH CSS set, or monitors PDCCH candidates for DCI formats with CRC scrambled by a MCCH-RNTI or a G-RNTI for broadcast and the UE is provided a non-zero value for searchSpaceMCCH and searchSpaceMTCH in PDCCH-ConfigCommon for a Type0B-PDCCH CSS set, or monitors PDCCH candidates for DCI formats with CRC scrambled by a multicast-MCCH-RNTI or a G-RNTI for multicast in an RRC_INACTIVE state and the UE is provided a non-zero value for searchSpaceMulticastMCCH and searchSpaceMulticastMTCH in PDCCH-ConfigCommon for a Type0B-PDCCH CSS set, the UE determines monitoring occasions for PDCCH candidates of the Type0/0A/1A/2-PDCCH CSS set, or of the Type0B-PDCCH CSS set, respectively, based on the search space set associated with the value of searchSpaceID.

The UE may assume that the DM-RS antenna port associated with PDCCH receptions in the CORESET configured by pdcch-ConfigSIB1 in MIB, the DM-RS antenna port associated with corresponding PDSCH receptions, and the corresponding SS/PBCH block are quasi co-located with respect to average gain, quasi co-location “typeA” and “typeD” properties, when applicable (e.g., as illustrated in TS 38.214), if the UE is not provided a TCI state indicating quasi co-location information of the DM-RS antenna port for PDCCH reception in the CORESET. The value for the DM-RS scrambling sequence initialization is the cell ID. For operation without shared spectrum channel access in FR1 and FR2-1, a SCS is provided by subCarrierSpacingCommon in MIB. For operation with shared spectrum channel access in FR1 and for operation in FR2-2, a SCS is same as the SCS of a corresponding SS/PBCH block.

For a single cell operation or for an operation with carrier aggregation in a same frequency band, a UE does not expect to monitor a PDCCH in a Type0/0A/0B/2/3-PDCCH CSS set or in a USS set if a DM-RS for monitoring a PDCCH in a Type1-PDCCH CSS set is not configured with same qcl-Type set to “typeD” properties (e.g., TS 38.214) with a DM-RS for monitoring the PDCCH in the Type0/0A/0B/2/3-PDCCH CSS set or in the USS set, and if the PDCCH or an associated PDSCH overlaps in at least one symbol with a PDCCH the UE monitors in a Type1-PDCCH CSS set or with an associated PDSCH.

If a UE is provided with: (1) one or more search space sets by corresponding one or more of searchSpaceZero, searchSpaceSIB1, searchSpaceOtherSystemInformation, pagingSearchSpace, ra-SearchSpace, and (2) a C-RNTI, an MCS-C-RNTI, or a CS-RNTI, the UE monitors PDCCH candidates for DCI format 0_0 and DCI format 1_0 with CRC scrambled by the C-RNTI, the MCS-C-RNTI, or the CS-RNTI in the one or more search space sets in a slot where the UE monitors PDCCH candidates for at least a DCI format 0_0 or a DCI format 1_0 with CRC scrambled by SI-RNTI, RA-RNTI, MsgB-RNTI, or P-RNTI.

If a UE is provided with (1) one or more search space sets by corresponding one or more of searchSpaceZero, searchSpaceSIB1, searchSpaceOtherSystemInformation, pagingSearchSpace, pei-SearchSpace, ra-SearchSpace, or a CSS set by PDCCH-Config, and (2) a SI-RNTI, a P-RNTI, a PEI-RNTI, a RA-RNTI, a MsgB-RNTI, a SFI-RNTI, an INT-RNTI, a TPC-PUSCH-RNTI, a TPC-PUCCH-RNTI, or a TPC-SRS-RNTI, then, for a RNTI from any of these RNTIs, the UE does not expect to process information from more than one DCI format with CRC scrambled with the RNTI per slot.

Table 10.1-1 of TS 38.213. CCE aggregation levels and
maximum number of PDCCH candidates per CCE aggregation
level for CSS sets configured by searchSpaceSIB1.

| CCE Aggregation Level | Number of Candidates |
|---|---|
| 4 | 4 |
| 8 | 2 |
| 16 | 1 |

For each DL BWP configured to a UE in a serving cell, the UE can be provided by higher layer signalling with: (1) P≤3 CORESETs if coresetPoolIndex is not provided, or if a value of coresetPoolIndex is same for all CORESETs if coresetPoolIndex is provided; and (2) P≤5 CORESETs if coresetPoolIndex is not provided for a first CORESET, or is provided and has a value 0 for a first CORESET, and is provided and has a value 1 for a second CORESET.

For each CORESET, the UE is provided with the following by ControlResourceSet: (1) a CORESET index p, by controlResourceSetId or by controlResourceSetId-v1610, where: (i) 0<p<12 if coresetPoolIndex is not provided, or if a value of coresetPoolIndex is same for all CORESETs if coresetPoolIndex is provided, and (ii) 0<p<16 if coresetPoolIndex is not provided for a first CORESET, or is provided and has a value 0 for a first CORESET, and is provided and has a value 1 for a second CORESET; (2) a DM-RS scrambling sequence initialization value by pdcch-DMRS-ScramblingID; (3) a precoder granularity for a number of REGs in the frequency domain where the UE can assume use of a same DM-RS precoder by precoderGranularity; (4) a number of consecutive symbols provided by duration; (5) a set of resource blocks provided by frequencyDomainResources; (6) CCE-to-REG mapping parameters provided by cce-REG-MappingType; (7) an antenna port quasi co-location, from a set of antenna port quasi co-locations provided by TCI-State, indicating quasi co-location information of the DM-RS antenna port for PDCCH reception; and (8) an indication for a presence or absence of a transmission configuration indication (TCI) field for a DCI format, other than DCI format 1_0, that schedules PDSCH receptions or has associated HARQ-ACK information without scheduling PDSCH and is provided by a PDCCH in CORESET p, by tci-PresentInDCI or tci-PresentDCI-1-2.

When precoderGranularity=allContiguousRBs, a UE does not expect: (1) to be configured a set of resource blocks of a CORESET that includes more than four sub-sets of resource blocks that are not contiguous in frequency and (2) any RE of a CORESET to overlap with any RE determined from: (i) Ite-CRS-ToMatchAround or LTE-CRS-PatternList, if the UE is not provided pdcchCandidateReception-WithCRSOverlap, or (ii) a SS/PBCH block.

If a UE is provided with two TCI states indicating quasi co-location information of the DM-RS antenna port for PDCCH reception in a CORESET associated with a Type3-PDCCH CSS set, the UE may assume the quasi co-location information indicated in both of the two TCI states for the PDCCH reception in the CORESET.

For each DL BWP configured to a UE in a serving cell, the UE is provided, by higher layers, with S≤10 search space sets where, for each search space set from the S search space sets, the UE is provided with the following by SearchSpace: (1) a search space set index s, 0<s<40, by searchSpaceId; (2) an association between the search space set s and a CORESET p by controlResourceSetId or by controlResourceSetId-v1610; (3) a PDCCH monitoring periodicity of kₛ slots and a PDCCH monitoring offset of oₛ slots, by monitoringSlotPeriodicityAndOffset or by monitoringSlotPeriodicityAndOffset-r17; (4) a PDCCH monitoring pattern within a slot, indicating first symbol(s) of the CORESET for PDCCH monitoring within each slot where the UE monitors PDCCH, by monitoringSymbolsWithinSlot; (5) a duration of Tₛ<kₛ indicating a number of slots that the search space set s exists by duration, or a number of slots in consecutive groups of slots where the search space set s can exist by duration-r17; (6) a bitmap, by monitoringSlots WithinSlotGroup, that applies per group of slots and provides a PDCCH monitoring pattern indicating slots in a group of slots for PDCCH monitoring: (i) a size of the group of slots is same as a size of monitoringSlots WithinSlotGroup; and (ii) for a Type1-PDCCH CSS set provided by ra-SearchSpace in dedicated RRC signaling, or for a Type3-PDCCH CSS set, or for a USS set, the PDCCH monitoring pattern indicates only consecutive slots in the group of slots for PDCCH monitoring and, at least for one combination (Xₛ, Yₛ) indicated by the UE as a capability, a number of the consecutive slots is not larger than Yₛ; (iii) for a Type1-PDCCH CSS set provided by ra-SearchSpace in SIB1, the PDCCH monitoring pattern indicates only up to 1 slot in the group of slots for PDCCH monitoring; and (iv) for a Type0-PDCCH CSS set or for a Type0A-PDCCH CSS set, or for a Type2-PDCCH CSS set, the PDCCH monitoring pattern indicates slots in the group of slots for PDCCH monitoring, and the slots are not restricted to be consecutive, and the number of those slots is not larger than the size of monitoringSlots WithinSlotGroup; (7) a number of PDCCH candidates Mₛ^{(L)} per CCE aggregation level L by aggregationLevel1, aggregationLevel2, aggregationLevel4, aggregationLevel8, and aggregationLevel16, for CCE aggregation level 1, CCE aggregation level 2, CCE aggregation level 4, CCE aggregation level 8, and CCE aggregation level 16, respectively; (8) an indication that search space set s is either a CSS set or a USS set by searchSpaceType; (9) if search space set s is a CSS set: (i) an indication by dci-Format0-0-AndFormat1-0 to monitor PDCCH candidates for DCI format 0_0 and DCI format 1_0; (ii) an indication by dci-Format2-0 to monitor one or two PDCCH candidates, or to monitor one PDCCH candidate per RB set if the UE is provided freqMonitorLocations for the search space set, for DCI format 2_0 and a corresponding CCE aggregation level; (iii) an indication by dci-Format2-1 to monitor PDCCH candidates for DCI format 2_1; (iv) an indication by dci-Format2-2 to monitor PDCCH candidates for DCI format 2_2; (v) an indication by dci-Format2-3 to monitor PDCCH candidates for DCI format 2_3; (vi) an indication by dci-Format2-4 to monitor PDCCH candidates for DCI format 2_4; (vii) an indication by dci-Format2-6 to monitor PDCCH candidates for DCI format 2_6; (viii) an indication by dci-Format2-9 to monitor PDCCH candidates for DCI format 2_9; (ix) an indication by dci-Format4-0 to monitor PDCCH candidates for DCI format 4_0; and (x) an indication by dci-Format4-1, or dci-Format4-2, or dci-Format4-1-AndFormat4-2 to monitor PDCCH candidates for DCI format 4_1, or DCI format 4_2, or for both DCI format 4_1 and DCI format 4_2, respectively; (10) an indication by searchSpaceLinkingId that search space set s is linked to another search space set for which is provided a same value for searchSpaceLinkingId; (11) if search space set s is a USS set: (i) an indication by dci-Formats to monitor PDCCH candidates either for DCI format 0_0 and DCI format 1_0, or for DCI format 0_1 and DCI format 1_1, (ii) an indication by dci-FormatsExt to monitor PDCCH candidates for DCI format 0_2 and DCI format 1_2, or for DCI format 0_1, DCI format 1_1, DCI format 0_2, and DCI format 1_2, (iii) an indication by dci-FormatsMC to monitor PDCCH candidates for one or both of DCI format 0_3 and DCI format 1_3, or (iv) an indication by dci-FormatsSL to monitor PDCCH candidates for DCI format 0_0 and DCI format 1_0, or for DCI format 0_1 and DCI format 1_1, or for DCI format 3_0, or for DCI format 3_1, or for DCI format 3_0 and DCI format 3_1, on an indication by dci-Format-NCR to monitor PDCCH candidates for DCI format 2_8; and (12) a bitmap by freqMonitorLocations, if provided, to indicate an index of one or more RB sets for the search space set s, where the MSB k in the bitmap corresponds to RB set k−1 in the DL BWP. For RB set k indicated in the bitmap, the first PRB of the frequency domain monitoring location confined within the RB set is given by

$${RB}_{s 0 + k , DL}^{start , μ} + {N}_{RB}^{offset} , where {RB}_{s 0 + k , DL}^{start , μ}$$

is the index of first common RB of the RB set k (e.g., 6 as illustrated in TS 38.214), and

$${N}_{RB}^{offset}$$

is provided by rb-Offset or

$${N}_{R B}^{offset} = 0$$

if rb-Offset is not provided. For each RB set with a corresponding value of 1 in the bitmap, the frequency domain resource allocation pattern for the monitoring location is determined based on the first

$${N}_{RBG , s e t 0}^{size} bits$$

in frequencyDomainResources provided by the associated CORESET configuration.

If the monitoringSymbolsWithinSlot indicates to a UE to monitor PDCCH in a subset of up to three consecutive symbols that are same in every slot where the UE monitors PDCCH for all search space sets, the UE does not expect to be configured with a PDCCH SCS other than 15 kHz if the subset includes at least one symbol after the third symbol.

A UE does not expect to be provided with a first symbol and a number of consecutive symbols for a CORESET that results in a PDCCH candidate mapping to symbols of different slots.

A UE does not expect any two PDCCH monitoring occasions on an active DL BWP, for a same search space set or for different search space sets, in the same CORESET to be separated by a non-zero number of symbols that is smaller than the CORESET duration.

A UE determines a PDCCH monitoring occasion on an active DL BWP from the PDCCH monitoring periodicity, the PDCCH monitoring offset, and the PDCCH monitoring pattern within a slot. If monitoringSlotsWithinSlotGroup is not provided, the UE determines that PDCCH monitoring occasions exist in a slot with number

$${n}_{s , f}^{μ}$$

(e.g. TS 38.211) in a frame with number n_{f} if

$$( {n}_{f} {N}_{slot}^{frame , μ} + {n}_{s , f}^{μ} - {o}_{s} ) mod {k}_{s} = 0 .$$

The UE monitors PDCCH candidates for search space set s for Tₛ consecutive slots, starting from slot

$${n}_{s , f}^{μ} ,$$

and does not monitor PDCCH candidates for search space set s for the next kₛ-Tₛ consecutive slots. If monitoring Slots WithinSlotGroup is provided, for search space set s, the UE determines that the slot with number

$${n}_{s , f}^{μ}$$

(e.g., TS 30.411) Ili a name with number n_{f} satisfying

$$( {n}_{f} {N}_{slot}^{frame , μ} + {n}_{s , f}^{μ} - {o}_{s} ) mod {k}_{s} = 0$$

is the first slot in a first group of Lₛ slots and that PDCCH monitoring occasions exist in Tₛ/Lₛ consecutive groups of slots starting from the first group, where Lₛ is the size of monitoringSlotsWithinSlotGroup. The UE monitors PDCCH candidates for search space set s within each of the Tₛ/Lₛ consecutive groups of slots according to monitoringSlots WithinSlotGroup, starting from slot

$${n}_{s , f}^{μ} ,$$

and does not monitor PDCCH candidates for search space set s for the next kₛ-Tₛ consecutive slots.

A USS at CCE aggregation level L E {1, 2, 4, 8, 16} is defined by a set of PDCCH candidates for CCE aggregation level L.

If a UE is configured with CrossCarrierSchedulingConfig for a serving cell, the carrier indicator field value corresponds to the value indicated by cif-InSchedulingCell in CrossCarrierSchedulingConfig. If a UE is configured with MC-DCI-SetofCells for a set of serving cells, the UE is provided nCI-Value for the set of serving cells.

For an active DL BWP of a serving cell on which a UE monitors PDCCH candidates in an USS, if the UE is not configured with a carrier indicator field, the UE monitors the PDCCH candidates without carrier indicator field. For an active DL BWP of a serving cell on which a UE monitors PDCCH candidates in an USS, if a UE is configured with a carrier indicator field, the UE monitors the PDCCH candidates with carrier indicator field.

A UE does not expect to monitor PDCCH candidates on an active DL BWP of a secondary cell if the UE is configured to monitor PDCCH candidates for detection of DCI formats scheduling on that secondary cell in another serving cell. For a serving cell included in MC-DCI-SetofCells, if provided, the UE does not expect to monitor PDCCH candidates on more than one scheduling cell for detection of DCI formats scheduling on the serving cell. For the active DL BWP of a serving cell on which the UE monitors PDCCH candidates, the UE monitors PDCCH candidates at least for the same serving cell.

For a search space set s associated with CORESET p, the CCE indexes for aggregation level L corresponding to PDCCH candidate

$${m}_{s , {n}_{CI}}^{( L )}$$

of the search space set in slot

$${n}_{s , f}^{μ}$$

for an active DL BWP of a serving cell corresponding to carrier indicator field value n_{CI}, or corresponding to value n_{CI} of nCI-Value associated with a set of serving cells MC-DCI-SetofCells, are given by

$$L \cdot \{ ( {Y}_{p , {n}_{s , f}^{μ}} + ⌊ \frac{{m}_{s , {n}_{CI}}^{( L )} \cdot {N}_{CCE , p}}{L \cdot {M}_{s , max}^{( L )}} ⌋ + {n}_{CI} ) mod ⌊ {N}_{CCE , p} / L ⌋ \} + i$$

where: for any CSS,

$${Y}_{p , {n}_{s , f}^{μ}} = 0 ;$$

### for a USS,

$${Y}_{p , {n}_{s , f}^{μ}} = ( {A}_{p} \cdot {Y}_{p , {n}_{s , f}^{μ} - 1} ) modD ,$$

Y_{p,-1}=n_{RNTI}≠0, Aₚ=39827 for pmod3=0, Aₚ=39829 for pmod3=1, Aₚ=39839 for pmod3=2, and D=65537; i=0, . . . , L−1; N_{CCE,p} is the number of CCEs, numbered from 0 to N_{CCE,p}−1, in CORESET p and, if any, per RB set, for CORESET 0, the CCEs are obtained prior to puncturing, if any, of corresponding RBs (e.g., TS 38.211); n_{CI} is: (i) the carrier indicator field value, if provided by cif-InSchedulingCell in CrossCarrierSchedulingConfig for the serving cell on which PDCCH is monitored, except for scheduling of the serving cell from the same serving cell in which case n_{CI}=0; (ii) the nCI-Value provided for the set of serving cells MC-DCI-SetofCells, if MC-DCI-SetofCells is provided; and (iii) otherwise, including for any CSS, n_{CI}=0;

$${m}_{s , {n}_{CI}}^{( L )} = 0 , … , {M}_{s , {n}_{CI}}^{( L )} - 1 , where$$

is the number of PDCCH candidates the UE is configured to monitor for aggregation level L of a search space set s for a serving cell corresponding to n_{CI}; for any CSS,

$${M}_{s , max}^{( L )} = {M}_{s , 0}^{( L )} ;$$

### for a USS,

$${M}_{s , max}^{( L )}$$

is the maximum of

$${M}_{s , {n}_{CI}}^{( L )}$$

over all configured n_{CI} values for a CCE aggregation level L of search space set s; and the RNTI value used for n_{RNTI} is the C-RNTI.

If a UE: (1) is configured to monitor a first PDCCH candidate for a DCI format 0_0 and a DCI format 1_0 from a CSS set and a second PDCCH candidate for a DCI format 0_0 and a DCI format 1_0 from a USS set, where the CSS set and the USS set do not include searchSpaceLinkingId, in a CORESET with index zero on an active DL BWP, and the DCI formats 0_0/1_0 associated with the first PDCCH candidate and the DCI formats 0_0/1_0 associated with the second PDCCH candidate have same size, and (iii) the UE receives the first PDCCH candidate and the second PDCCH candidate over a same set of CCEs, and (iv) the first PDCCH candidate and the second PDCCH candidate have identical scrambling, and (v) the DCI formats 0_0/1_0 for the first PDCCH candidate and the DCI formats 0_0/1_0 for the second PDCCH candidate have CRC scrambled by either C-RNTI, or MCS-C-RNTI, or CS-RNTI.

The UE decodes only the DCI formats 0_0/1_0 associated with the first PDCCH candidate. If a UE detects a DCI format with inconsistent information, the UE discards all the information in the DCI format.

A UE configured with a bandwidth part indicator in a DCI format determines, in case of an active DL BWP or of an active UL BWP change, that the information in the DCI format is applicable to the new active DL BWP or UL BWP, respectively.

In various embodiments of the present disclosure, a 6G base station (6G BS) or a 5G/4G BS can be replaced with other corresponding network nodes, such as 6G IAB or 6G NCR or 6G reconfigurable intelligent surface (RIS), or such as 5G NCR or IAB node, or a 4G relay or repeater node. In various embodiments, a 6G UE or a 5G/4G UE can operate in relation with multiple network nodes corresponding to a certain RAT (same RAT as that for the UE, or different RAT than that for the UE), such as both a 6G BS and a 6G IAB/NCR/RIS, or both a 5G BS and a 5G IAB/NCR, or both a 4G BS and 4G relay/repeater node.

In various embodiments of the present disclosure, a 6G/5G BS or a 4G BS can refer to a central unit (CU) or a distributed unit (DU) or a remote unit (RU) or a transmission-reception point (TRP) or other architectural units or functional/logical entities for a corresponding base station, or a variation or collection or combination thereof.

In various embodiments of the present disclosure, at least the following scenarios are provided for coexistence of 6G RAT with one or both 4G LTE RAT and 5G NR RAT.

A 6G RAT/BS operates a 6G cell in a spectrum that is shared with a cell operated by one or both of 5G RAT/BS or 4G RAT/BS. For example, a 6G UE operates in a cell that is also operated by one or both of 5G RAT/BS or 4G RAT/BS.

For example, a 6G UE and a 5G/4G UE operate in overlapping time durations in the same cell, or in different cells of the same band, and the operation may also overlap in the frequency domain or the spatial domain.

For example, 6G UEs operate in a cell that is also operated by 5G/4G RAT/BS for 5G/4G UEs.

For example, 6G UEs operate in a 6G cell where transmissions or receptions overlap in frequency with transmissions or receptions associated on a 5G/4G cell operated by 5G/4G RAT/BS for 5G/4G UEs. In such examples, the cell(s) are at least serving cell(s), or possibly non-serving cell(s), e.g., for the purpose of inter-cell beam management, mobility, and so on.

At least the following examples can be provided.

In one example, a 6G UE operates on only one 6G cell that is shared with 5G/4G RAT.

In one example, a 6G UE operates on a set of more than one 6G cells, and only a subset of the set of the 6G cells is shared with 5G/4G RATs, while remaining from the set of cells are not shared with 5G/4G RATs.

In one example, a 6G UE operates on a set of more than one 6G cells, and all cells in the set of the 6G cells are shared with 5G/4G RATs.

Such examples can also include cases with DL cells only, or UL cells only, or both DL cells and UL cells (or cells that are both DL and UL).

Such example can also include cases that the “more than one 6G cells” are in a same frequency band (intra-band CA) or in different frequency bands (inter-band CA), or a combination thereof.

Such example are provided as a “single-carrier MRSS” or “MRSS without CA,” while Scenarios #1b and #1c are provided as “multi-carrier MRSS” or “MRSS with CA” or “CA-based MRSS.”

Various network deployment assumptions are provided for examples disclosed in the present disclosure.

For example, a same BS or network entity operates both the 6G RAT and the 5G/4G RAT.

For example, separate BSs or network entities operate the 6G RAT and the 5G/4G RATs, and the 6G RAT and the 5G/4G RATs share corresponding spectrum/frequency resources.

For example, the BSs cooperate/coexist or otherwise have signaling exchange with practically negligible signaling latency.

The following core network (CN) assumptions are provided for examples as disclosed in the present disclosure.

The 6G RAT that operates the 6G cell/UEs is associated with a 6G core network (6G-CN) and the 5G/4G RAT that operates the 5G/4G cell/UEs is associated with a 5G/4G core network (5G/4G-CN).

The mentioned examples are to enable a BS/network entity (or cooperating BSs/network entities) to allocate shared/overlapping T/F/S resources for operation of the 6G cell and/or the corresponding 6G UEs such that there is no interference or otherwise performance degradation to the operation of the 5G/4G cell and/or the corresponding 5G/4G UEs.

The mentioned examples can be used to ensure compatible design for the 6G with 5G/4G RATs, to reduce implementation efforts, or facilitate reuse of implementations for 5G/4G RATs for 6G RATs, when operating in shared or re-farmed spectrum.

A 6G UE operates in a first 6G cell and in a second 5G/4G cell that coordinate/cooperate or otherwise jointly operate scheduling of UEs.

In one embodiment, a “multi-RAT” carrier aggregation (CA) operation is provided, where different cells are associated with different RATs, such as NR-6G CA (N6-CA) or EUTRA-6G CA (E6-CA), unlike the conventional “single-RAT” carrier aggregation that operates with a number of cells associated with a same RAT, such as 4G LTE CA, or 5G NR CA, or 6G CA.

At least the following examples are provided for embodiments as disclosed in the present disclosure:

In one example, a first 6G cell is in a same/shared spectrum with a second 5G/4G cell (shared multi-RAT “MR” cells).

In one example, a first 6G cell is in a same frequency band as a second 5G/4G cell (intra-band MRSA).

In one example, a first 6G cell is in a different frequency band than a second 5G/4G cell (inter-band MRSA).

Various network deployment assumptions are provided for examples and embodiments as disclosed in the present disclosure.

For example, a 5G/4G RAT operates both a 5G/4G cell and a 6G cell.

For example, a 6G RAT operates both a 6G cell and a 5G/4G cell.

For example, a 6G RAT operates a 6G cell and a 5G/4G RAT operates a 5G/4G cell, wherein the 6G RAT and 5G/4G RAT coordinate/cooperate their corresponding operations, such as scheduling, resource allocation, or configuration among the RATs. In such example, different RATs share certain signaling, or transmissions/receptions, or procedures, and so on. In such example, a first RAT (e.g., 6G RAT) offloads certain signaling, or transmissions/receptions, or procedures, and so on, to the other RAT (e.g., 5G RAT).

Various CN assumptions are provided for examples and embodiments as disclosed in the present disclosures.

For example, the 5G/4G RAT is associated with a 5G core network (5G-CN) that can support both 5G/4G and 6G operations.

For example, the 6G RAT is associated with an extended 6G core network (ext-6G-CN) that can support both 6G and 5G/4G operations.

For example, both the 6G RAT and the 5G/4G RAT are associated with a 5G core network (5G-CN) or an extended 5G core network (ext-5G-CN) that can support both 6G and 5G/4G operations. For example, the 6G RAT is a certain extended 6G RAT (ext-6G RAT) that can operate in association with a 5G-CN or ext-5G-CN.

For example, both the 6G RAT and the 5G/4G RAT are associated with an extended 6G core network (ext-6G-CN) that can support both 6G and 5G/4G operations. For example, the 5G/4G RAT is a certain extended 5G/4G RAT (ext-5G/4G RAT) that can operate in association with a 6G-CN or ext-6G-CN.

For example, the 6G RAT is associated with a 6G-CN and the 5G RAT is associated with a 5G-CN that coordinate/cooperate their corresponding operations, e.g., based on signaling exchange with negligible latency between the two core networks.

The disclosed examples and embodiments are to enable the BS/network entity (or the cooperating BSs/network entities) to operate 6G cells and 5G/4G cells jointly and provide coordinated/cooperative support for a 6G UE with MRSA capability. In such examples and embodiments, the coordination/cooperation can be in the physical layer (L1) and/or in higher layers such as MAC/RLC (L2/L3). This scenario offers increased throughput and possibly reduced latency or signaling overhead, that is achieved by e.g., reusing the network infrastructure for 5G.

A 6G UE operates in the first 6G cell and in a second 5G/4G cell, wherein the first 6G cell and the second 5G/4G cell operate independently.

The disclosed examples and embodiments are provided as 5G-6G dual connectivity (N6-DC) or 4G-6G dual connectivity (E6-DC), or 4G-5G-6G tri-connectivity (EN6-TC).

At least the following examples are provided for the disclosed embodiments and examples of the present disclosure.

In one example, the first 6G cell is in a same/shared spectrum with the second 5G/4G cell (shared multi-RAT “MR” cells).

In one example, the first 6G cell is in the same frequency band as the second 5G/4G cell (intra-band MRC).

In one example, the first 6G cell is in a different frequency band than the second 5G/4G cell (inter-band MRC).

Various network deployments (RAN) are provided for the examples and embodiments disclosed in the present disclosure.

For example, a 6G RAT operates the first 6G cell and a 5G/4G RAT operates the second 5G/4G cell.

For example, the 6G RAT and 5G/4G RAT do coordinate/cooperate for their corresponding operations, e.g., for scheduling, resource allocation, or configurations among the RATs.

For example, different RATs have separate schedulers.

For example, configurations, transmissions/receptions, and procedures, are independent among the RATs.

Various CN assumptions are provided for the examples and embodiments disclosed in the present disclosure.

For example, the 6G RAT is associated with a 6G core network (6G-CN) and the 5G/4G RAT is associated with a 5G/4G core network (5G/4G-CN).

For example, both the 6G RAT and the 5G/4G RAT are associated with a 5G/4G-CN.

For example, both the 6G RAT and the 5G/4G RAT are associated with a 6G-CN or an extended 6G core network (ext-6G-CN) that can handle both 6G and 5G/4G.

The embodiments and examples disclosed in the present disclosure are to enable the 6G UE to establish a 5G/4G connection in addition to the 6G connection which can facilitate increased throughput for the 6G UE.

The objectives of MRSS can be achieved using avoidance methods that preclude interference between the 6G RAT and the 5G/4G RAT, or using cooperation/reusing/sharing methods that rely on coordination, assistance, or cooperation between the 6G RAT and the 5G/4G RAT. Herein, avoidance refers to UE-BS/inter-BS signaling, configurations, procedures, methods, and so on, that preclude a 6G UE/cell from transmitting, receiving, or otherwise using for a 6G procedure/operation any T/F/S resource in which a 5G/4G UE/cell may transmit, receive, or otherwise use for a 5G/4G operation.

Herein, cooperation or reuse/sharing refers to UE-BS/inter-BS signaling, configurations, procedures, methods, and so on, that supports for a 6G UE/cell to transmit, receive or otherwise using for a 6G procedure/operation some or all T/F/S resources in which a 5G/4G UE/cell may transmit, receive, or otherwise use for a 5G/4G operation, or some or all signals or channels or messages or signaling or procedures that a 5G/4G UE/cell may transmit or receive, or otherwise use for 5G/4G operation. Such method allows for considerable or full spectrum sharing among 6G and 5G/4G, with limited or without avoidance-based methods. Examples of such signals or channels or messages or T/F/S resources include: NR SSB, MIB, SIB1 message, SIB1 PDCCH/PDSCH, SIBx>1, paging PDCCH/PDSCH, LP-SS, LP-WUS, CORESETs including CORESET #0, and so on, as subsequently described.

When cooperation or sharing methods are used for MRSS, various embodiments/examples are provided for distinguishing UEs corresponding to different RATs, for example, distinction of 6G UEs from 5G/4G UEs that operate in the same frequency band and apply the shared signals or channels or messages or resources or signaling or procedures. In one example, new handling such as new physical layer parameters can be introduced for 6G UEs, for example, when sharing NR signals/channels/resources, as subsequently described. In another example, new interpretation or new UE procedures can be introduced for 6G UEs, such as different association of message fields to 6G UEs compared to NR UEs, for example, when sharing NR messages.

Various embodiments, methods, or examples throughout the present disclosure may consider collocated RATs (such as collocated 5G and 6G BSs); otherwise synchronous operation of different RATs, such as synchronous 5G and 6G BSs. For example, a maximum reception time difference among 5G and 6G BSs can be smaller than a certain threshold, such as smaller than a CP.

Such consideration can facilitate sharing 5G signals or channels for 6G BSs/UEs or 6G procedures. For example, when different RATs such as 5G and 6G BSs are not collocated or otherwise not synchronous, in one example, sharing/reuse mechanism may not apply. In another example, a time offset, such as a predetermined number of symbols (or slots) can be applied to 5G signals or channels when using them by a 6G procedure by a 6G BS or a 6G UE. In another example, a predetermined number of guard symbols may be applied by a 6G BS/UE for corresponding 6G procedures.

Various embodiments, method, or examples throughout the present disclosure may apply to any SSB such as an always-on SSB, or aperiodic/on-demand SSB, or cell-defining SSB (CD-SSB) or non-cell-defining SSB (NCD-SSB). Some examples may apply only to certain SSBs such as only CD-SSB or such as only always-on CD-SSB, and so on. For example, when certain methods are applied to on-demand SSB or mutable SSB, and a corresponding SSB is deactivated or muted for NR, in one example, a corresponding SSB is also deactivated or muted also for 6G, while in another example, a 6G SSB can be separately provided.

In one embodiment, acquisition of RAT-specific MIB is provided when sharing RAT-common signal or channel for initial synchronization or cell search (e.g., sharing SSB).

In one embodiment, a UE corresponding to a first RAT, such as a 6G UE can receive a same DL anchor signal for initial synchronization or cell search, such as a same SS/PBCH block (also referred to as SSB, for brevity), or a same low-power synchronization signal (LP-SS), as a second UE corresponding to a second RAT, such as a 5G NR UE. For example, the 6G UE performs synchronization or cell search or RRM measurement or mobility measurements based on the NR PSS/SSS, CSI-RS, or LP-SS sequences, same as for a 5G NR UE. For example, the 6G UE determines a 6G-specific minimum system information, or a part thereof, referred to as a 6G master information block (MIB), that is separate/different from the 5G NR MIB. For example, the 6G UE determines the 6G MIB from the DL anchor signal/SSB/LP-SS that is shared with 5G NR, via separate RAT-specific transmission/channel, or via different RAT-specific interpretation.

For example, the following methods can be used.

In one example, one SSB with two separate PBCHs for NR and 6G-using additional OFDM symbols or REs/RBs, such as in TDM or FDM manner with the 5G SSB, that are band-specific or band-common is provided.

In such example, ae number of additional symbols or REs/RBs can be predetermined in the specifications (possibly based on a time/frequency location of the 5G SSB, a time-domain pattern of the 5G SSB, or a minimum channel bandwidth of the 5G SSB), or the additional symbols or

REs/RBs can take one of multiple candidates for such T/F extension; in the latter case, an indication method such as the 96 unused REs (or a subset thereof) in PSS symbol of NR SSB or the spare bit of the 5G NR MIB or certain values of PBCH content or corresponding transmission parameters are used in 6G to provide a field with a number of bits or otherwise an explicit or implicit indication provided by PSS/SSS/PBCH/MIB of the NR SSB to indicate parameters for T/F-extension, if any, of the NR SSB for 6G; In yet another example; the 6G UE may perform blind decoding among multiple different candidates for such T/F extension to determine an actual T/F extension.

In such example, the 6G UEs receive SSBs using same or different assumptions on the SSB structures for MRSS-designated bands vs. non-MRSS bands, including a presence or structure of an extension of SSB in time/frequency domain; if SSB extension is applied in a non-MRSS band, the 6G UE may discard the resources for NR PBCH, or may use them for providing some of the 6G SIB1 IEs, or for receive a 6G DL signal or channel such as TRS or PDCCH.

In such example, the 5G UE can avoid such T/F-extension for 6G PBCH, e.g., by rate-matching indication for 5G UEs, or by predetermined or dedicated higher layer information or by 6G PBCH interference cancellation for MRSS-aware 5G UEs.

In one example, one SSB with one PBCH/MIB for both NR and 6G-interpreted differently for each RAT is provided; alternatively, spare bit of NR MIB can be used to indicate whether MIB is for both NR and 6G or for NR only (in the latter case, the MIB for 6G can be provided by an SSB or LP-SS that is in different half-frame or frames or subframes or sync raster and so on).

In one example, a single identical SSB that applies to both RATs, such as both 5G NR and 6G, is provided. For example, the 6G UE receives identical PSS/SSS/PBCH as for a 5G NR UE, and any differentiation among 5G NR UEs and 6G UEs is provided by SIB1 message or SIBx>1 message, as described in embodiment of the present disclosure, or is indicated during or after the initial/random access procedure. For example, the 6G UE can be provided 6G-specific SIB1 message or a 5G NR SIB1 message that is modified to provide 6G-specific information, or the 6G UE can be provided identical SIB1 message as a 5G NR UE and receive 6G-specific system information using a SIBx>1 or using UE-common (cell-specific) or dedicated (UE-specific) higher layer signaling, such as common or dedicated RRC signaling.

In one example, the DL anchor signal/SSB/LP-SS includes first information for the first RAT and second information for the second RAT, such as a first MIB for 5G NR and a second MIB for the 6G. For example, the SSB that is shared between NR and 6G includes a first PBCH that provides the 5G NR MIB, and a second PBCH that provides the 6G MIB. The second MIB can be separately channel coded or can use a different coding method than the first MIB, for example when the second MIB provides only few additional bits and at least some information from the first MIB is also used by 6G UEs.

In another example, the first and second MIB/PBCH are jointly coded with a same channel coding method, and an applicable number of bits for the first PBCH/MIB and the second PBCH/MIB is determined by or predetermined for the 5G UE and a 6G UE.

For example, the 6G UE performs synchronization and cell search based on the NR PSS/SSS sequences, and determines the 6G MIB based on the second PBCH. In one example, the 6G UE discards the first PBCH that provides the 5G NR MIB, except possibly for T/F resources corresponding to first PBCH DM-RS, that can be used as assistance for improved channel estimation, demodulation and decoding of the second PBCH, or when the first PBCH DM-RS provides certain timing information such as for SSB index or half-frame bit. In another example, the 6G UE decodes the first PBCH/MIB for 5G to determine at least certain fields or parameters that are shared with 6G operation.

For example, the 6G UE can determine certain time/frequency synchronization parameters, such as one or more of system frame number (SFN), half-radio frame bit, parameter k_SSB for RE-level offset of the SSB from the common resource block (CRB), based on the parameters (such as scrambling) or payload of the first/NR PBCH payload or the NR MIB. For example, such fields can be excluded from the 6G MIB or 6G PBCH payload or parameter selection. For example, the parameters or payload of the second/6G PBCH or the 6G MIB can be used for indication of only 6G-specific parameters, such as 6G SIB1 PDCCH/PDSCH configuration parameters or 6G cell barring information, or for indication of separate 6G-specific values for parameters/IEs that are shared between NR and 6G, and the 6G-specific values override the NR values provided by the first PBCH/MIB. For example, the second/6G PBCH or 6G MIB can also include network-energy-saving related information for cell operation or for initial access, such as information related to on-demand SSB or on-demand SIB1 or on-demand LP-SS (or aperiodic variations of such DL signals or channels) or UL WUS configuration associated with activation or triggering of SSB or SIB1 or LP-SS and so on.

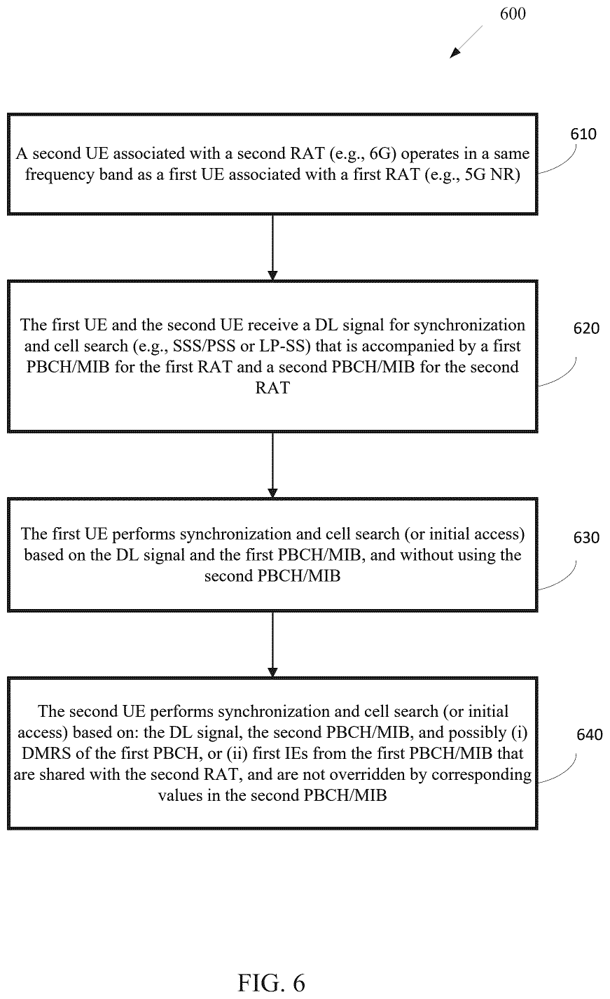

FIG. 6 illustrates a flowchart of UE method 600 for synchronization and cell search or initial access for a 6G UE using a 5G NR SSB that provides a 6G PBCH/MIB in addition to the 5G NR PBCH/MIB according to embodiments of the present disclosure. The UE method 600 may be performed by a UE (e.g., 111-116 as illustrated in FIG. 1). The first UE or the second UE may be one of UEs (e.g., 111-116 as illustrated in FIG. 1). An embodiment of the UE method 600 shown in FIG. 6 is for illustration only. One or more of the components illustrated in FIG. 6 can be implemented in specialized circuitry configured to perform the noted functions or one or more of the components can be implemented by one or more processors executing instructions to perform the noted functions.

FIG. 6 shows an example procedure for synchronization and cell search or initial access for a 6G UE using a 5G NR SSB that provides a 6G PBCH/MIB in addition to the 5G NR PBCH/MIB.

A second UE associated with a second RAT (e.g., 6G) operates in the same frequency band/carrier frequency as a first UE associated with a first RAT (e.g., 5G NR), 610. The first UE and the second UE receive a DL signal for synchronization and cell search (e.g., SSS/PSS or LP-SS) that is accompanied by a first PBCH/MIB for the first RAT and a second PBCH/MIB for the second RAT, 620. The first UE performs synchronization and cell search (or initial access) based on the DL signal and the first PBCH/MIB without using the second PBCH/MIB, 630. The second UE performs synchronization and cell search (or initial access) based on: the DL signal, the second PBCH/MIB, and possibly (i) DM-RS of the first PBCH, or (ii) first IEs from the first PBCH/MIB that are shared with the second RAT, and are not overridden by corresponding values in the second PBCH/MIB, 640.

For example, each SSB index can include additional time-domain resources for transmission of the second PBCH that provides the 6G MIB. For example, the second PBCH can be TDM with the NR SSB, including with the first PBCH associated with 5G NR. For example, each SSB index can include additional L OFDM symbols, such as L=2 symbols in 5^{th} and 6^{th} OFDM symbol positions with same or different number of REs in the 5^{th} and 6^{th} symbols as for the other 4 OFDM symbols. For example, the second PBCH for 6G is provided by same REs in the 5^{th} and 6^{th} symbols as for the first PBCH for NR (in the 2^{nd} and 4^{th} OFDM symbols). In another example, only one additional OFDM symbols (L=1), such as only in the 5^{th} symbol position, and corresponding REs, as previously described, are used for 6G PBCH.

In one example, each SSB index can include additional frequency-domain resources for transmission of the second PBCH that provides the 6G MIB. For example, the second PBCH can be FDM with the NR SSB, including with the first PBCH associated with 5G NR. For example, some or all of the 4 OFDM symbols of the NR SSB can be extended in frequency domain for transmission of the 6G PBCH (including 6G PBCH DMRS), beyond the existing 20 PRBs allocated for NR SSB. For example, a number M, such as M=5, of additional PRBs are appended to each side of the NR SSB structure, for some or all 4 OFDM symbols of the NR SSB, therefore including additional 2*M such as 10 PRBs in an/each OFDM symbol, compared to NR SSB. In another example, all PRBs associated with the second PBCH are appended to one side of the NR SSB, such as 2*M or in general N PRBs appended to the top of NR SSB or to the bottom of the NR SSB, for some or all 4 OFDM symbols of NR SSB. For example, such frequency-domain extension is not present in the first/PSS symbol of the NR SSB. For example, such frequency-domain extension may or may not be present in the third/SSS symbol of NR SSB. For example, such frequency-domain extension is present only in the second/fourth symbols of NR SSB that are used only for NR PBCH.

For example, additional OFDM symbols for transmission of 6G PBCH, as previously described, may or may not be used in combination with the additional REs/RBs. For example, the second PBCH can include a first part and a second part, wherein the first part is TDM with the NR SSB, and the second part is FDM with the NR SSB.

For example, the second PBCH is both TDM and FDM with the NR SSB, for example, in different symbols/slots and different PRBs, such as based on time-domain and frequency-domain offset values.

For example, a T/F resource allocation for the second/6G PBCH can be based on a time-domain pattern of the NR SSB. For example, different TDM patterns can be supported for the second/6G PBCH for different NR SSB patterns (Case A to Case G). For example, allocating additional one or two OFDM symbols to NR SSB may be applicable/supported for SSB time-domain patterns Case A or Case 3 (corresponding to an NR SSB with 15 kHz SCS or 30 kHz SCS, respectively), while such time-domain extension may not be applicable to SSB time-domain patterns Case B, D, or E (corresponding to an NR SSB with SCS of 30 or 120 or 240 kHz, respectively).

In one example, a T/F resource allocation for the second/6G PBCH can be based on frequency domain placement of the NR SSB and a corresponding channel/system bandwidth. For example, for a channel bandwidth of 5 MHZ (equivalent to 25 PRBs), and considering 20 RBs allocated to NR SSB, there exists only 5 RBs left for frequency-domain extension of NR SSB to provide the second/6G PBCH. Depending on the placement of the SSB relative to the channel bandwidth, a number N_above of zero or one or more RBs of the channel bandwidth above NR SSB or a number N_below of zero or one or more RBs of the channel bandwidth below the NR SSB may be available for frequency domain extension. For example, N_above+N_below=5 RBs. For example, N_above+N_below >5 RBs when the channel bandwidth is larger than 5 MHz (or 25 PRBs). For example, N_above+N_below <5 RBs, including 0 RBs, when the channel bandwidth is less than 5 MHz (or 25 PRBs), such as 3 to 5 MHz.

For example, a number of applicable RBs can be also based on the channel bandwidth. For example, N RBs allocated to extension of NR SSB to provide the second/6G PBCH can satisfy: N=min {N_ext, N_channel−N_SSB}. For example, N_ext is a maximum size of such extension, such as 10 RBs. For example, N_channel is the channel bandwidth in number of RBs, and N_SSB is a number of RBs allocated to NR SSB, such as 20 RBs. For example, when the channel bandwidth N_channel is less than N_ext+N_SSB, such as 30 RBs, only a number of (N_channel−N_SSB) RBs are allocated to extension of NR SSB, while for channel bandwidth N_channel greater than N_ext+N_SSB, such as 30 RBs, a full 10 RBs can be allocated to extension of NR SSB. In the former case, a placement of such extension RBs can be flexible/floating based on the placement of NR SSB in the channel, while in the latter case, a placement of such extension RBs can be fixed, such as always below or always above or always equally distributed below and above the NR SSB.

For example, a T/F allocation for extension of NR SSB to provide the second/6G SSB can be predetermined in the specifications of system operation. For example, the specifications can predetermine an applicable number and placement of additional OFDM symbols and/or additional RBs for the second PBCH for each or each group of scenarios based on the channel bandwidth, the frequency-domain placement of the SSB within the channel bandwidth, and the applicable time-domain pattern of the SSB. For such information can be per band, or per frequency range such as FR1, or FR2, or FR3.

In one example, one T/F allocation or one T/F allocation pattern is predetermined for extension of NR SSB to provide the second/6G PBCH, for example, at least for each band or for each NR SSB configuration or pattern.

In another example, for a given NR SSB configuration or pattern, multiple T/F allocations or multiple T/F allocation patterns can be supported for such NR SSB extension.

In one example, when the UE acquires an NR SSB, the UE determines per UE implementation (e.g., by blind detection) which T/F allocation from the multiple T/F allocations, or which T/F allocation pattern from the multiple T/F allocation patterns, is used as an extension for the NR SSB to provide the second/6G PBCH.

In another example, a UE can be provided an indication to determine an applicable T/F allocation from the multiple T/F allocations, or an applicable T/F allocation pattern from the multiple T/F allocation patterns. Such indication can be provided by a transmission parameter of an PSS or an SSS or a DM-RS of a first/5G PBCH in the NR SSB, or by an information field in the first/5G PBCH (such (non-MIB part of the first/5G PBCH) or in a first/5G MIB of the NR SSB. For example, the indication can be provided by RB/RE level offset of NR SSB relative to the common resource block/grid, such as by using reserved values of k_SSB, or based on sync raster value (or sync raster value modulo a predetermined value).

For example, the indication can be provided by time-domain offset of NR SSB, such as SFN value (or SFN value modulo a predetermined value). For example, an indication can be by a transmit power of the NR SSB, such as PSS or SSS or DM-RS of first PBCH for 5G, an associated relative power or power offset. For example, for a 6G UE, PSS sequence is mapped to a combination of (cell ID, extension), instead of solely the Cell ID, and SSS sequence (possibly along with 6G PBCH) provides the cell ID. For example, NR SSB sequence properties can be used for such indication. For example, the indication can be provided by scrambling of PBCH or DM-RS of PBCH. For example, the indication can be provided by a reserved bit of MIB or a reserved bit of (non-MIB part of) PBCH payload, or by empty REs of the NR SSB, such as the 96 unused REs (or a subset thereof) in the first/PSS symbol of the NR SSB, as subsequently described.

In one example, in the SSB structure for SSB, there exist 96 REs corresponding to the 1^{st} OFDM symbol of an NR SSB that are not used for PSS, and their equivalent REs are used in the 3^{rd} symbol of NR SSB for NR PBCH transmission (adjacent to SSS). For example, some or all such 96 REs (in the PSS symbol) can be used for 6G PBCH transmission. In one example, a subset of such 96 REs, such as 72 REs, are used for the 6G PBCH, and some of those 96 REs, such as 12 REs on each side of the PSS, are left as guard band to accommodate improved PSS detection. In one example, such SSB extension in the PSS symbol includes at least a field (or multiple separate fields), for example with 1 to 3 bits, to indicate whether additional extension of NR SSB in time or frequency domain is applied for providing the 6G SSB, such as for providing the second PBCH for 6G, and if so, a number of L additional OFDM symbols or M additional REs/RBs that are applied for NR SSB extension. For example, the 6G specifications of system operation can include a mapping or table for the possible values of L or M, or for possible combinations of (L, M) values.

For example, 2 or 4 or 8 possible values for L or M or (L, M) combinations can be indicated using 1 or 2 or 3 bits, respectively. Such table/mapping can be same or different for different frequency bands/ranges or duplexing modes or SSB multiplexing patterns, and so on. For example, one value in the table can correspond to no extension of the NR SSB (in which case, the 6G PBCH/MIB is provided using different methods, as subsequently described, e.g., using the example/embodiments for reinterpretation of the NR PBCH/MIB). In another example, such 72-96 REs in the PSS symbol can be also used to provide additional fields for the 6G MIB/PBCH. In yet another example, an indication of Lor M or (L, M) combination is provided using the (first/5G or second/6G) PBCH parameters, such as the PBCH scrambling, for example a PBCH scrambling before channel coding or a PBCH scrambling after channel coding, or by reserved state(s) in PBCH or by k_SSB parameter of NR SSB.

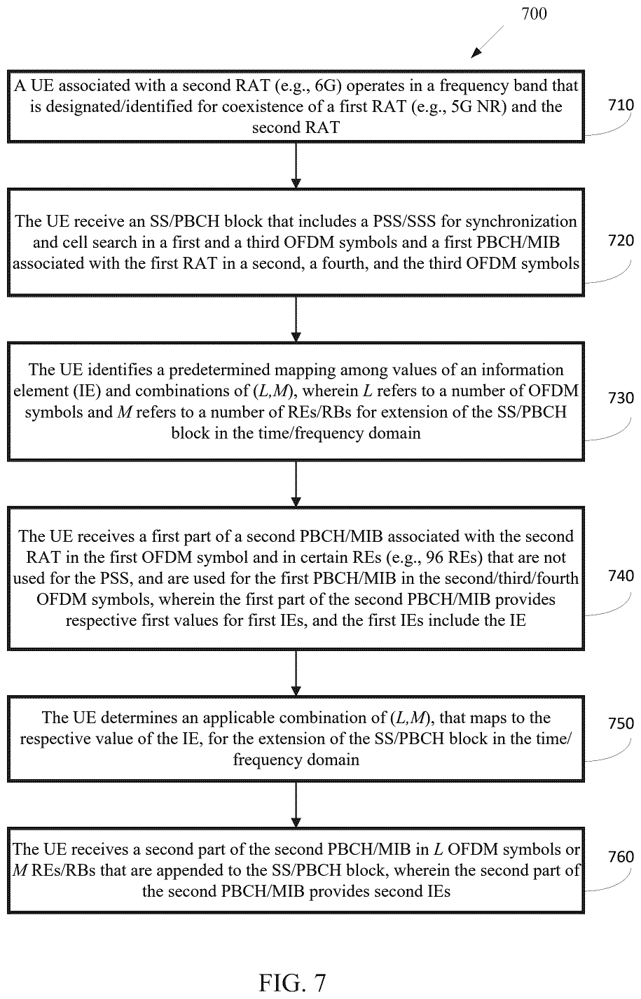

FIG. 7 illustrates a flowchart of UE method 700 for providing a second PBCH/MIB as a configurable time-frequency extension of 5G NR SSB according to embodiments of the present disclosure. The UE method 700 may be performed by a UE (e.g., 111-116 as illustrated in FIG. 1). An embodiment of the UE method 700 shown in FIG. 7 is for illustration only. One or more of the components illustrated in FIG. 7 can be implemented in specialized circuitry configured to perform the noted functions or one or more of the components can be implemented by one or more processors executing instructions to perform the noted functions.

FIG. 7 shows an example method for providing a second PBCH/MIB as a configurable time-frequency extension of 5G NR SSB.

A UE associated with a second RAT (e.g., 6G) operates in a frequency band/carrier frequency that is designated/identified for coexistence of a first RAT (e.g., 5G NR) and the second RAT, 710. The UE receive an SS/PBCH block that includes a PSS/SSS for synchronization and cell search in a first and a third OFDM symbols and a first PBCH/MIB associated with the first RAT in a second, a fourth, and the third OFDM symbols, 720. The UE identifies a predetermined mapping among values of a field and combinations of (L, M), wherein L refers to a number of OFDM symbols and M refers to a number of REs/RBs for extension of the SS/PBCH block in the time/frequency domain, 730. The UE receives a first part of a second PBCH/MIB associated with the second RAT in the first OFDM symbol and in certain REs (e.g., 96 REs) that are not used for the PSS, and are used for the first PBCH/MIB in the second/third/fourth OFDM symbols, wherein the first part of the second PBCH/MIB provides respective first values for first IEs, and the first IEs include the IE, 740. The UE determines an applicable combination of (L, M), that maps to the respective value of the IE, for the extension of the SS/PBCH block in the time/frequency domain, 750. The UE receives a second part of the second PBCH/MIB in L OFDM symbols or M REs/RBs that are appended to the SS/PBCH block, wherein the second part of the second PBCH/MIB provides second IEs, 760.

For example, it is predetermined in the specifications of the system operation whether a frequency band (or all bands in a frequency range) is designated for 5G-6G Coexistence or MRSS. For example, MRSS operation is up to the gNB, and the UE receives an indication in the PSS/SSS or the first PBCH/MIB (such as a scrambling pattern of the first PBCH or a flag, such as a spare bit, of the first MIB) whether a corresponding frequency band/cell operates with 5G-6G Coexistence or MRSS.

For example, the first part and the second part of the second PBCH/MIB are separately processed, such as separate channel coding, modulation, resource mapping, and so on. For example, the UE can receive and decode the first part of the second PBCH/MIB without any information on the presence or contents of the second part of the second PBCH/MIB.

In one example, a structure of the 6G SSB based on extension of the NR SSB in time domain or frequency domain can be independent of an operating frequency band or frequency range, or duplex mode, or NR SSB multiplexing pattern, and so on. For example, to achieve a simplified or unified 6G UE implementation, such extension of the NR SSB to include the second PBCH for 6G is applied regardless of whether or not an associated frequency band is predetermined in the specifications for 5G-6G spectrum sharing.

For example, when a certain frequency band or frequency range is not predetermined for 5G-6G coexistence or MRSS (such as a frequency band dedicated to 6G, for example, an FR3 band), the 6G UE discards the symbols/REs corresponding to the first PBCH for 5G NR, except possibly the REs for PBCH DM-RS. For example, such REs are considered as reserved, for example, with undefined or predetermined values (for example, set to 0s), or are used for other 6G DL signals or channels such as 6G TRS, or 6G CSI-RS or PDCCH or PDSCH and so on. In another example, the 6G UE discards the symbols/REs corresponding to the second PBCH for 6G (including the extension symbols/REs), except possibly the REs for second PBCH DM-RS. For example, such REs are considered as reserved, for example, with undefined or predetermined values (for example, set to 0s), or are used for other 6G DL signals or channels such as 6G CSI-RS or PDCCH or PDSCH.

In another example, the symbols/REs corresponding to the first PBCH, are also used for providing additional IEs from the 6G minimum system information, such as certain 6G IEs that are otherwise provided by the 6G SIB1. For example, the 6G UE can have different interpretation from the 6G MIB and 6G SIB1 (for example, 6G MIB with fewer IEs and 6G SIB1 with more IEs, or alternatively 6G MIB with more IEs and 6G SIB1 with fewer IEs) based on whether or not the frequency band or frequency range is among those predetermined for MRSS.

In another example, a structure of the 6G SSB can be different for different frequency bands or frequency ranges, or duplex modes, or NR SSB multiplexing patterns, and so on. For example, when an operation frequency band or frequency range is predetermined in the specifications of system operation for 5G-6G spectrum sharing or MRSS, the 6G SSB is based on NR SSB with aforementioned extension in time or frequency domain (with such extension being predetermined or being configurable based on an indication provided in the PSS symbol, as previously described). Otherwise (that is, for non-MRSS bands), a structure of 6G SSB can be same as for 5G SSB, for example, with 4 symbols and without any additional symbols or REs/RBs, and the PBCH resources provides only a 6G PBCH (and does not provide 5G PBCH).

For example, a structure of the 6G SSB can be different for different NR multiplexing patterns for NR SSB and NR CORESET #0, such as NR multiplexing patterns 1/2/3. For example, for NR SSB multiplexing pattern 1, only extension of NR SSB in frequency domain may be applied, or only 1-symbol extension of NR SSB may be applied, to avoid overlap with symbols associated with NR CORESET #0, such as NR SIB1 PDCCH or PDSCH transmission. For example, for NR SSB multiplexing pattern 2 or 3, only extension of NR SSB in time-domain may be applied, or frequency-domain extension of NR SSB with small value of M may be applied, to avoid overlap with REs/RBs associated with CORESET #0, such as SIB1 PDCCH or PDSCH transmission. For example, an extension of the NR SSB in time or frequency domain includes a certain guard time or guard band from the NR CORESET #0, or SIB1 PDCCH/PDSCH resources. For example, such multiplexing-pattern-specific extension of NR SSB can be predetermined in the 6G specifications or can be configurable based on an indication provided in the PSS symbol, as previously described. For example, combinations of (L, M) or corresponding mapping for NR SSB extension, as previously described, can be different for different SSB multiplexing patterns, such as a first mapping with first (L, M) combinations for SSB multiplexing pattern 1, and a second mapping with second (L, M) combinations for SSB multiplexing pattern 2 or 3.

In one example, same or similar methods can apply to other examples of DL anchor signal or channel for initial synchronization or cell search, such as a modified SSB or LP-SS, and so on that is shared among multiple RATs, such as between NR and 6G. For example, the 6G MIB can be provided by information carried by the LP-SS, such as information overlaid on the LP-SS sequence (for example sequence parameters), or provided by LP-SS time/frequency resource selection parameters, and so on. In another example, LP-SS can be accompanied by a PBCH-like channel that provides the remaining MIB parameters or the entire 6G MIB. The PBCH-like channel that accompanies the LP-SS can be TDMed or FDMed with the LP-SS, such as adjacent T/F resources, or can be interleaved among LP-SS resources.

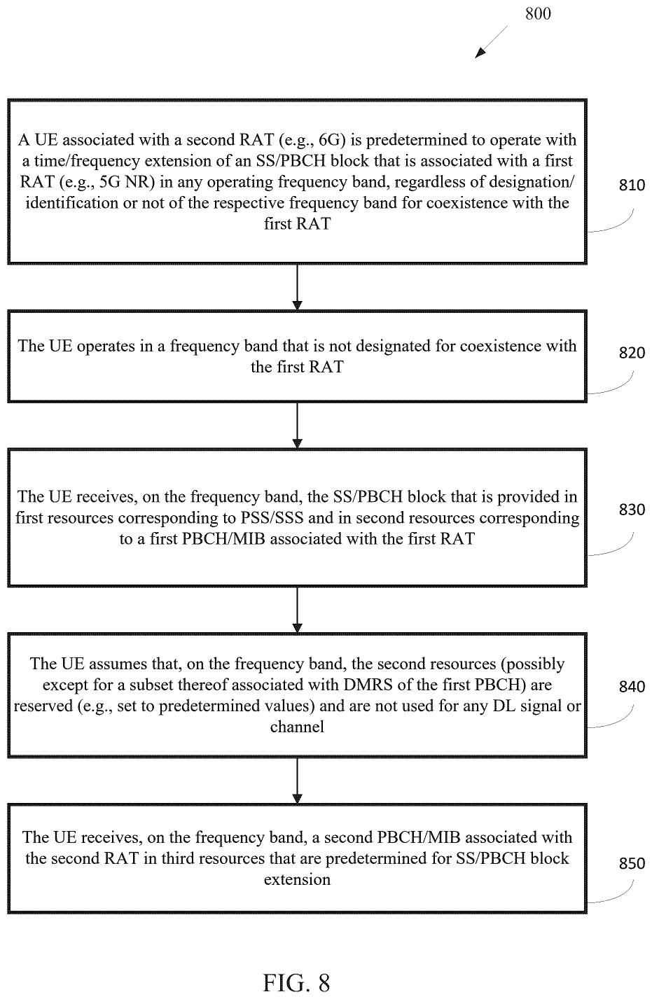

FIG. 8 illustrates a flowchart of UE method 800 in a non-MRSS band using a 5G NR SSB structure with time/frequency extension for providing a 6G PBCH/MIB according to embodiments of the present disclosure. The UE method 800 may be performed by a UE (e.g., 111-116 as illustrated in FIG. 1). An embodiment of the UE method 800 shown in FIG. 8 is for illustration only. One or more of the components illustrated in FIG. 8 can be implemented in a specialized circuitry configured to perform the noted functions or one or more of the components can be implemented by one or more processors executing instructions to perform the noted functions.

FIG. 8 shows an example of a method for operation of a 6G UE in a non-MRSS band (i.e., a dedicated 6G band) using a 5G NR SSB structure with time/frequency extension for providing a 6G PBCH/MIB: resources corresponding to NR PBCH are reserved and discarded.

A UE associated with a second RAT (e.g., 6G) is predetermined to operate with a time/frequency extension of an SS/PBCH block that is associated with a first RAT (e.g., 5G NR) in any operating frequency band/carrier frequency, regardless of designation or not of the respective frequency band/carrier frequency for coexistence with the first RAT, 810. The UE operates in a frequency band/carrier frequency that is not designated for coexistence with the first RAT, 820. The UE receives, on the frequency band/carrier frequency, the SS/PBCH block that is provided in first resources corresponding to PSS/SSS and in second resources corresponding to a first PBCH/MIB associated with the first RAT, 830. The UE assumes that, on the frequency band/carrier frequency, the second resources (possibly except for a subset thereof associated with DM-RS of the first PBCH) are reserved (e.g., set to predetermined values) and are not used for any DL signal or channel, 840. The UE receives, on the frequency band/carrier frequency, a second PBCH/MIB associated with the second RAT in third resources that are predetermined for SS/PBCH block extension, 850.

Herein, an SS/PBCH block on a non-MRSS frequency band/carrier frequency relates, for example, to a resource structure of the NR SSB, not the NR SSB signal itself, which is not necessarily applicable to a band/carrier that is dedicated to 6G (e.g., FR3 band). For example, the 6G UE discards the NR PBCH as captured in 740, or other methods are applied for NR PBCH, as subsequently described.

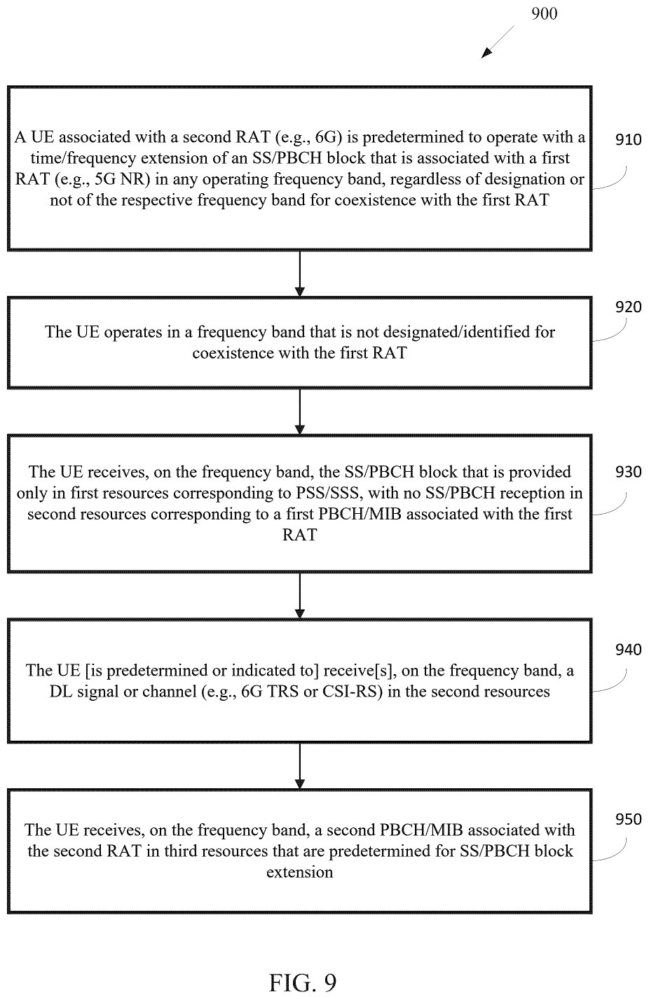

FIG. 9 illustrates a flowchart of UE method 900 in a non-MRSS band using a 5G NR SSB structure that is extended for providing a 6G PBCH/MIB according to embodiments of the present disclosure. The UE method 900 may be performed by a UE (e.g., 111-116 as illustrated in FIG. 1). An embodiment of the UE method 900 shown in FIG. 9 is for illustration only. One or more of the components illustrated in FIG. 9 can be implemented in specialized circuitry configured to perform the noted functions or one or more of the components can be implemented by one or more processors executing instructions to perform the noted functions.

FIG. 9 shows another example method for an operation of a 6G UE in a non-MRSS band (i.e., a dedicated 6G band) using a 5G NR SSB structure that is extended for providing a 6G PBCH/MIB: resources corresponding to NR PBCH are used for other 6G DL signals or channels.

A UE associated with a second RAT (e.g., 6G) is predetermined to operate with a time/frequency extension of an SS/PBCH block that is associated with a first RAT (e.g., 5G NR) in any operating frequency band/carrier frequency, regardless of designation/identification or not of the respective frequency band/carrier frequency for coexistence with the first RAT, 910. The UE operates in a frequency band/carrier frequency that is not designated/identified for coexistence with the first RAT, 920. The UE receives, on the frequency band/carrier frequency, the SS/PBCH block that is provided only in first resources corresponding to PSS/SSS, with no SS/PBCH reception in second resources corresponding to a first PBCH/MIB associated with the first RAT, 930. The UE receives, on the frequency band/carrier frequency, a DL signal or channel (e.g., 6G TRS or CSI-RS or PDCCH) in the second resources, 940. For example, a procedure for the reception in 940 can be predetermined in the specifications of 6G system operation or can be indicated to the UE by PSS/SSS. The UE receives, on the frequency band/carrier frequency, a second PBCH/MIB associated with the second RAT in third resources that are predetermined for SS/PBCH block extension, 950.

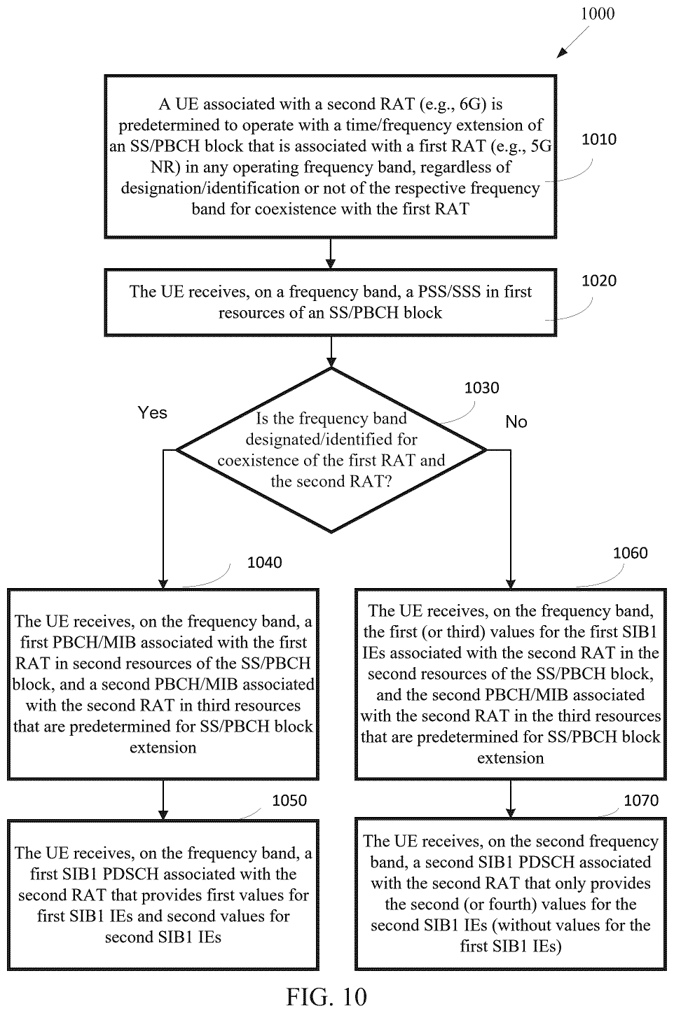

FIG. 10 illustrates a flowchart of UE method 1000 in a non-MRSS band using a 5G NR SSB structure that is extended for providing a 6G PBCH/MIB according to embodiments of the present disclosure. The UE method 1000 may be performed by a UE (e.g., 111-116 as illustrated in FIG. 1). An embodiment of the UE method 1000 shown in FIG. 10 is for illustration only. One or more of the components illustrated in FIG. 10 can be implemented in a specialized circuitry configured to perform the noted functions or one or more of the components can be implemented by one or more processors executing instructions to perform the noted functions.

FIG. 10 shows yet another example method for operation of a 6G UE in a non-MRSS band (i.e., a dedicated 6G band) using a 5G NR SSB structure that is extended for providing a 6G PBCH/MIB: resources corresponding to NR PBCH are used for some 6G SIB1 IEs.

A UE associated with a second RAT (e.g., 6G) is predetermined to operate with a time/frequency extension of an SS/PBCH block that is associated with a first RAT (e.g., 5G NR) in any operating frequency band/carrier frequency, regardless of designation or not of the respective frequency band/carrier frequency for coexistence with the first RAT, 1010. The UE receives, on a frequency band/carrier frequency, a PSS/SSS in first resources of an SS/PBCH block, 1020. The UE determines whether or not the frequency band/carrier frequency is designated/identified for coexistence of the first RAT and the second RAT, 1030. When the UE determines that the frequency band/carrier frequency is designated/identified for coexistence of the first RAT and the second RAT, the UE receives, on the frequency band/carrier frequency, a first PBCH/MIB associated with the first RAT in second resources of the SS/PBCH block, and a second PBCH/MIB associated with the second RAT in third resources that are predetermined for SS/PBCH block extension, in 1040, and the UE receives, on the frequency band/carrier frequency, a first SIB1 PDSCH associated with the second RAT that provides first values for first SIB1 IEs and second values for second SIB1 IEs, 1050. When the UE determines that the frequency band/carrier frequency is not designated/identified for coexistence of the first RAT and the second RAT, the UE receives, on the frequency band/carrier frequency, the first values (or different third values) for the first SIB1 IEs associated with the second RAT in the second resources of the SS/PBCH block, and the second PBCH/MIB associated with the second RAT in the third resources that are predetermined for SS/PBCH block extension, 1060, and the UE receives, on the second frequency band/carrier frequency, a second SIB1 PDSCH associated with the second RAT that only provides the second values (or different fourth values) for the second SIB1 IEs (without any values for the first SIB1 IEs), 1070.

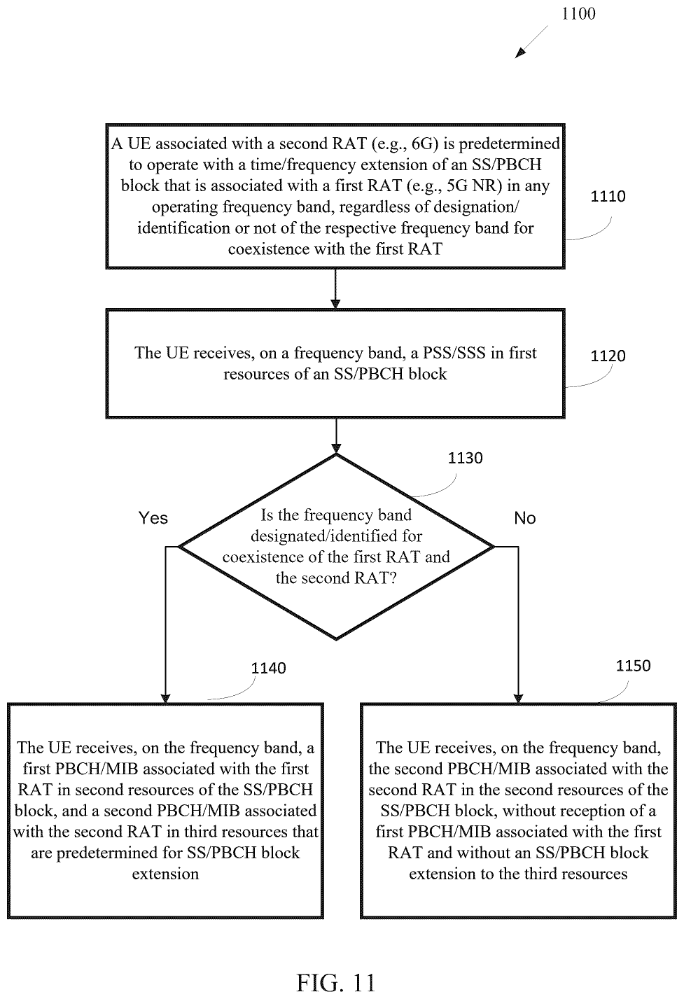

FIG. 11 illustrates a flowchart of UE method 1100 with different assumptions on SSB structure for MRSS-bands and non-MRSS band according to embodiments of the present disclosure. The UE method 1100 may be performed by a UE (e.g., 111-116 as illustrated in FIG. 1). An embodiment of the UE method 1100 shown in FIG. 11 is for illustration only. One or more of the components illustrated in FIG. 11 can be implemented in specialized circuitry configured to perform the noted functions or one or more of the components can be implemented by one or more processors executing instructions to perform the noted functions.

FIG. 11 shows an example method for operation of a 6G UE with different assumptions on SSB structure for MRSS-bands and non-MRSS band, e.g., in terms of time-frequency extension of 5G NR SSB for providing a 6G PBCH/MIB.

A UE associated with a second RAT (e.g., 6G) is predetermined to operate with a time/frequency extension of an SS/PBCH block that is associated with a first RAT (e.g., 5G NR) in any operating frequency band/carrier frequency, regardless of designation or not of the respective frequency band/carrier frequency for coexistence with the first RAT, 1110. The UE receives, on a frequency band/carrier frequency, a PSS/SSS in first resources of an SS/PBCH block, 1120. The UE determines whether or not the frequency band/carrier frequency is designated/identified for coexistence of the first RAT and the second RAT, 1130. When the UE determines that the frequency band/carrier frequency is designated/identified for coexistence of the first RAT and the second RAT, the UE receives, on the frequency band/carrier frequency, a first PBCH/MIB associated with the first RAT in second resources of the SS/PBCH block, and a second PBCH/MIB associated with the second RAT in third resources that are predetermined for SS/PBCH block extension, 1140. When the UE determines that the frequency band/carrier frequency is not designated/identified for coexistence of the first RAT and the second RAT, the UE receives, on the frequency band/carrier frequency, the second PBCH/MIB associated with the second RAT in the second resources of the SS/PBCH block, without reception of a first PBCH/MIB associated with the first RAT and without an SS/PBCH block extension to the third resources, 1150.

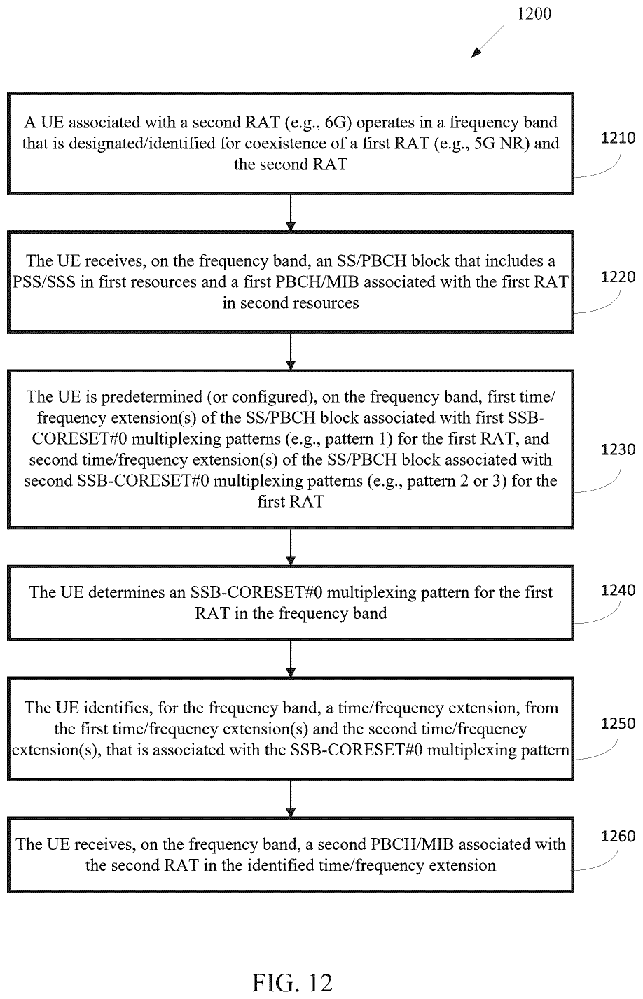

FIG. 12 illustrates a flowchart of UE method 1200 with time-frequency extension of 5G NR SSB (for providing a 6G PBCH/MIB) that depends on the SSB-CORESET #0 multiplexing pattern according to embodiments of the present disclosure. The UE method 1200 may be performed by a UE (e.g., 111-116 as illustrated in FIG. 1). An embodiment of the UE method 1200 shown in FIG. 12 is for illustration only. One or more of the components illustrated in FIG. 12 can be implemented in specialized circuitry configured to perform the noted functions or one or more of the components can be implemented by one or more processors executing instructions to perform the noted functions.

FIG. 12 shows an example method for operation of a 6G UE with time-frequency extension of 5G NR SSB (for providing a 6G PBCH/MIB) that depends on the SSB-CORESET #0 multiplexing pattern.

A UE associated with a second RAT (e.g., 6G) operates in a frequency band/carrier frequency that is designated/identified for coexistence of a first RAT (e.g., 5G NR) and the second RAT, 1210. The UE receives, on the frequency band/carrier frequency, an SS/PBCH block that includes a PSS/SSS in first resources and a first PBCH/MIB associated with the first RAT in second resources, 1220. The UE is predetermined (or configured), on the frequency band/carrier frequency, first time/frequency extension(s) of the SS/PBCH block associated with first SSB-CORESET #0 multiplexing patterns (e.g., pattern 1) for the first RAT, and second time/frequency extension(s) of the SS/PBCH block associated with second SSB-CORESET #0 multiplexing patterns (e.g., pattern 2 or 3) for the first RAT, 1230. The UE determines an SSB-CORESET #0 multiplexing pattern for the first RAT in the frequency band/carrier frequency, 1240. The UE identifies, for the frequency band/carrier frequency, a time/frequency extension, from the first time/frequency extension(s) and the second time/frequency extension(s), that is associated with the SSB-CORESET #0 multiplexing pattern, 1250.

The UE receives, on the frequency band/carrier frequency, a second PBCH/MIB associated with the second RAT in the identified time/frequency extension, 1260.

In one example, a 5G UE such as a 5G UE may not be aware of additional time/frequency resources for the second/6G PBCH that are appended to the NR SSB or LP-SS. In one example, the 5G UE is not configured or scheduled by a 5G gNB for DL reception or UL transmission in such T/F resources. In another example, the 5G UE may be configured or scheduled for DL reception or UL transmission in such T/F resources, and configured or indicated semi-static or dynamic rate matching (RM) patterns that include such T/F resources, so that the 5G UE avoids, for example, via rate matching around (or puncturing), those T/F resources. In another example, no avoidance or rate-matching may be performed for such T/F resources, for example, since the 5G UE can be configured or scheduled DL receptions or UL transmissions using different TCI states or beams or spatial filters that are different from that of the corresponding SSB index or LP-SS index. In another example, such separation can be achieved by other means, such as different sequence domain parameters, or advanced antenna architectures, such as multiple panels or joint phase-time arrays (JPTA), and so on.

In another example, a 5G UE, such as an MRSS-aware 5G UE (for example, a Rel-21 NR UE) may be aware of the 6G SSB design, such as predetermined or higher layer information of the additional T/F resources for 6G PBCH that is appended to the 5G NR SSB or LP-SS. For example, the MRSS-aware 5G UE can avoid the NR SSB extension based on predetermined or dedicated higher layer configuration or, when a corresponding 5G UE capability is declared by the UE, can cancel an interference from the 6G PBCH and receive a DL signal or channel in such T/F resources.

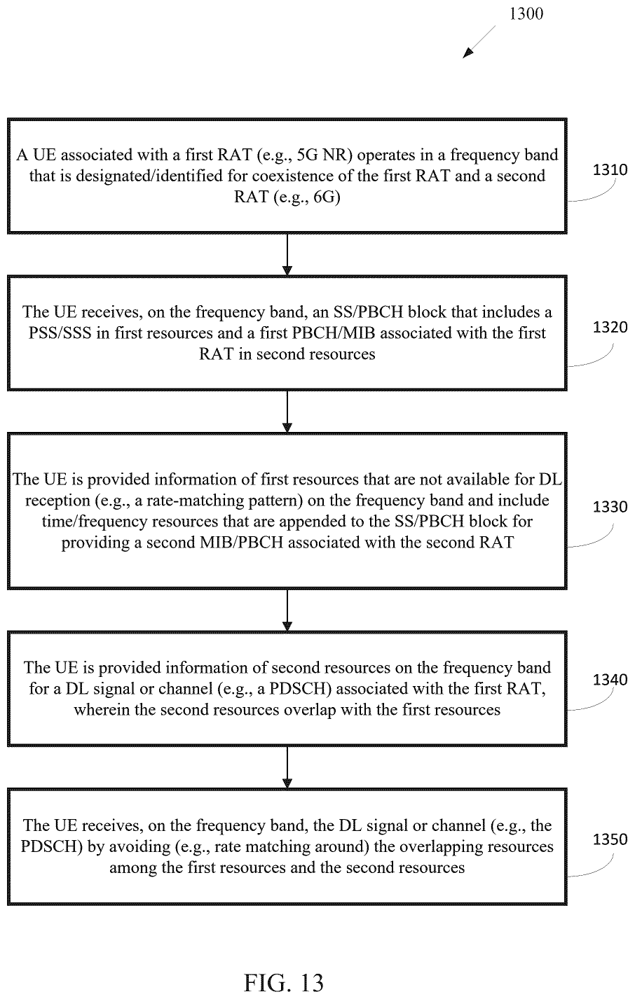

FIG. 13 illustrates a flowchart of UE method 1300 for rate-matching around the time-frequency resources appended to the 5G NR SSB for providing a 6G PBCH/MIB according to embodiments of the present disclosure. The UE method 1300 may be performed by a UE (e.g., 111-116 as illustrated in FIG. 1). An embodiment of the UE method 1300 shown in FIG. 13 is for illustration only. One or more of the components illustrated in FIG. 13 can be implemented in specialized circuitry configured to perform the noted functions or one or more of the components can be implemented by one or more processors executing instructions to perform the noted functions.

FIG. 13 shows an example method for operation of a 5G UE for rate-matching around the time-frequency resources appended to the 5G NR SSB (for providing a 6G PBCH/MIB).

A UE associated with a first RAT (e.g., 5G NR) operates in a frequency band/carrier frequency that is designated/identified for coexistence of the first RAT and a second RAT (e.g., 6G), 1310. The UE receives, on the frequency band/carrier frequency, an SS/PBCH block that includes a PSS/SSS in first resources and a first PBCH/MIB associated with the first RAT in second resources, 1320. The UE is provided information of first resources that are not available for DL reception or UL transmission (e.g., a rate-matching pattern) on the frequency band/carrier frequency and include time/frequency resources that are appended to the SS/PBCH block for providing a second MIB/PBCH associated with the second RAT, 1330. The UE is provided information of second resources on the frequency band/carrier frequency for a DL signal or channel (e.g., a PDSCH) associated with the first RAT, wherein the second resources overlap with the first resources, 1340. The UE receives, on the frequency band/carrier frequency, the DL signal or channel (e.g., the PDSCH) by avoiding (e.g., rate matching around) the overlapping resources among the first resources and the second resources, 1350.

In one example, the DL anchor signal/SSB/LP-SS includes single system information, such as a single PBCH or a single MIB, that applies to multiple RATs, such as both 5G NR and 6G.

In one example, an NR UE parses the PBCH or MIB into first fields/IEs and interprets per NR specifications, and a 6G UE parses the PBCH or MIB into second fields/IEs and interprets per 6G specifications. For example, at least some of the first and second fields/IEs, or corresponding number of bits, can be different between 5G NR and 6G. For example, interpretation of fields can be different among RATs, for example, different values or tables for the 6G MIB parameters compared to 5G NR.

For example, a number of bits for MIB IE(s) for SIB1 PDCCH configuration, such as CORESET #0 information or SS #0 information, can be different for 5G and 6G. In another example, predetermined tables for mapping between the values of MIB IEs for SIB1 PDCCH and parameters for CORESET #0 configuration or SS #0 configuration for 6G can be different from those for 5G NR, as captured in TS 38.213. Similar examples are provided for other MIB/PBCH IEs, such as SCS values, cell barring, frequency offset values relative to CRB grid, SSB index, and so on.

In another variation, the DL anchor signal/SSB/LP-SS includes single system information, such as a single PBCH or a single MIB, and whether or not the system information/PBCH/MIB is shared with 5G NR and 6G can be indicated by the DL anchor signal, such as a sequence parameter or a scrambling of the PSS/SSS or LP-SS, or can be indicated by the PBCH/MIB.

For example, a spare bit of the NR MIB can indicate whether or not the MIB corresponds to 6G. For example, a value 0 indicates that MIB corresponds to NR only, and a value 1 indicates that the MIB corresponds to both 5G NR and 6G. For example, when the spare bit has value 0 (NR only), the 6G UE discards the rest of the MIB (only 5G NR UE uses such MIB/PBCH). For example, when the spare bit has value 1 (both NR and 6G), the 6G UE interprets the rest of the MIB and PBCH based on the 6G specifications.

For example, a structure of SSB or LP-SS (such as sequence generation, number of OFDM symbols, number of REs/RBs, and so on) for 6G is same as that for 5G NR, while an actual placement of the SSB or LP-SS in the resource grid can be different. For example, an SSB or LP-SS for 6G can be placed on sync rasters that are different from 5G NR sync rasters, such as a subset or a superset of those for 5G NR, or a shifted version of 5G NR sync rasters (such as a shift by a predetermined value, or by a value dependent on a channel bandwidth or based on a frequency band or frequency range). For example, a 6G SSB can be placed in different subframes or frames than a 5G SSB, such as a subset or superset of those for 5G NR. For example, the sync raster value/index or the subframe/frame index, possibly along with a value of the MIB spare bit, can be used to determine whether an SSB or LP-SS corresponds to 5G NR or 6G.

In one example, in case of MRSS, such as when a carrier or frequency band is shared between 5G NR and 6G, and when a first instance of the DL anchor signal/SSB/LP-SS includes a first system information/PBCH/MIB for 5G NR, and a second instance of the DL anchor signal/SSB/LP-SS includes a second system information/PBCH/MIB for 6G, the first and second instances of the DL anchor signal/SSB/LP-SS or the first and second system information/PBCH/MIB can provide assistance information for each other, such as time-frequency (relative) location or periodicity of the other DL anchor signal/SSB/LP-SS.

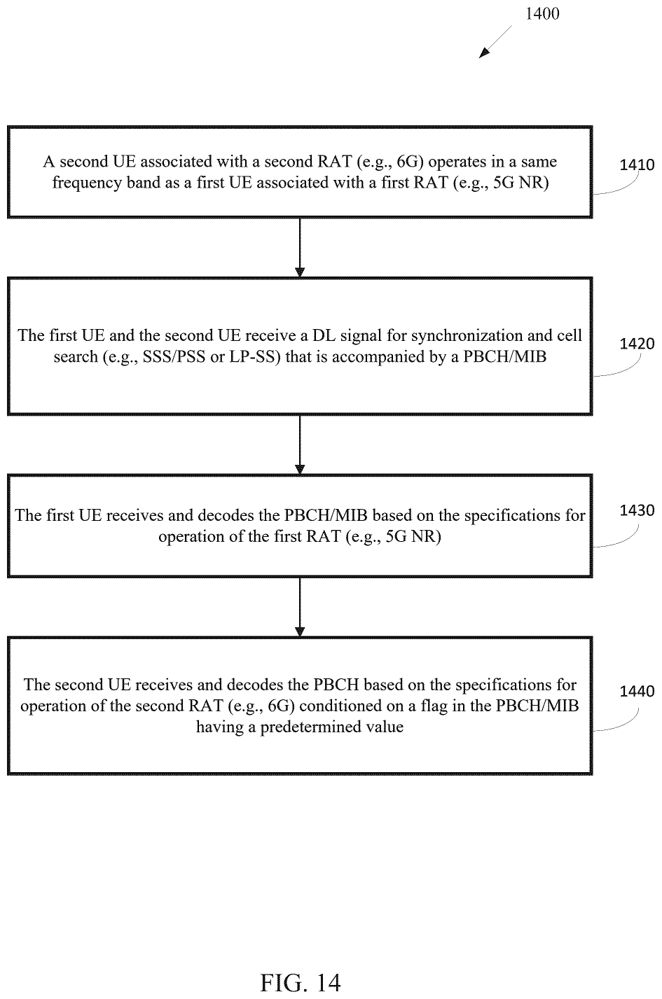

FIG. 14 illustrates a flowchart of UE method 1400 for sharing PBCH/MIB between 5G NR and 6G according to embodiments of the present disclosure. The UE method 1400 may be performed by a UE (e.g., 111-116 as illustrated in FIG. 1). The first UE or the second UE may be one of UEs (e.g., 111-116 as illustrated in FIG. 1). An embodiment of the UE method 1400 shown in FIG. 14 is for illustration only. One or more of the components illustrated in FIG. 14 can be implemented in specialized circuitry configured to perform the noted functions or one or more of the components can be implemented by one or more processors executing instructions to perform the noted functions.

FIG. 14 shows an example method for sharing PBCH/MIB between 5G NR and 6G.

A second UE associated with a second RAT (e.g., 6G) operates in the same frequency band/carrier frequency as a first UE associated with a first RAT (e.g., 5G NR), 1410. The first UE and the second UE receive, on the frequency band/carrier frequency a DL signal for synchronization and cell search (e.g., SSS/PSS or LP-SS) that is accompanied by a PBCH/MIB, 1420. The first UE receives, on the frequency band/carrier frequency, and decodes the PBCH/MIB based on the specifications for operation of the first RAT (e.g., 5G NR), 1430. The second UE receives, on the frequency band/carrier frequency, and decodes the PBCH based on the specifications for operation of the second RAT (e.g., 6G) when a flag in the PBCH/MIB (e.g., a spare bit of the 5G NR MIB) has a predetermined value (e.g., 1), 1440.

For example, the procedure of the second UE can be without/regardless of the condition. For example, the procedure of the second UE can be based on the condition. For example, when the flag in the PBCH/MIB takes a different value (e.g., 0), the second UE does not acquire the system information based on the PBCH/MIB. For example, the second UE assumes that system information for the second RAT is provided by a separate PBCH/MIB associated with a separate DL anchor signals (e.g., SSS/PSS or LP-SS), such as one in a different frame or subframe, or a different sync raster, and so on. In another example, the procedure of the second UE can be without any condition, such as a condition for a flag value as described in 1440. For example, the second UE receives, on the frequency band/carrier frequency, and decodes the PBCH always based on the specifications for operation of the second RAT (e.g., 6G).

In one realization, a same DL sync signal/anchor signal is used for both a first RAT and a second RAT, such as a same SSB for both NR and 6G, while the bits of a corresponding MIB can be reinterpreted (e.g. based on the 1-2 spare bits of the MIB in 5G NR).

In one example, cell barring can be separate for 5G and 6G. For example, a first interpretation of the MIB identifies a first barring/non-barring indication for NR, and a second interpretation of the MIB identifies a second barring/non-barring indication for 6G.

In another example, an indication of CORESET #0 and/or SS #0 can be separate for 5G and 6G. For example, a first interpretation of the MIB identifies a first CORESET #0 and/or SS #0 indication for 5G NR, and a second interpretation of the MIB identifies a second CORESET #0 and/or SS #0 indication for 6G. In another example, the MIB can include a flag to indicate whether the first CORESET #0 and/or SS #0 indicated for 5G NR can be also reused for 6G, or whether a different/second CORESET #0 and/or SS #0 applies to 6G, such as a CORESET #0_6G adjacent to (e.g., TDM or FDM with) the first CORESET #0 associated 5G NR.

In another realization, the DL sync signal/anchor signal/SSB can include separate PBCHs/MIBs for each of the first RAT and the second RAT, such as a first MIB for the 5G NR and a second MIB for 6G.

For example, there can be an indication, whether certain IEs from 5G are reused for 6G, such as reusing the cell-barring indication or reusing the CORESET #0 and/or SS #0.

In one example, when such flag is not supported or not present, or when the flag indicates that the 5G IEs cannot be reused, the second PBCH/MIB provides respective separate indications for 6G, such as separate cell barring or separate CORESET #0 or SS #0 indication for 6G.

In one embodiment, acquisition of RAT-specific remaining minimum information block (RMSI, a.k.a., SIB1) or other SIBx when sharing RAT-common signal or channel for initial cell search (e.g., sharing SSB) is provided.

In one embodiment, a UE associated with a first RAT, such as a 6G UE, can determine a first RMSI or SIB1 corresponding to the first RAT based on a DL anchor signal for initial synchronization or cell search, such as an SSB or an LP-SS, that is shared with a second RAT, such as 5G NR. The first RMSI/SIB1 can be different from a second RMSI/SIB1 that is associated with the second RAT. The scheduling information, such as PDCCH configuration, for the first SIB1 and the second SIB1 are provided by the DL anchor signal (e.g., NR SSB or NR LP-SS), such as by corresponding MIB message(s) that is/are embedded or accompanied by the DL anchor signal.

In one example, both the MIB message and the SIB1 PDSCH for 6G are shared with 5G NR, and the shared SIB1 PDSCH provides a SIB1 message that includes IEs for 5G NR operation (possibly re-used by 6G as well), and additional 6G-specific IEs for 6G operation, or the 6G UE interprets the shared SIB1 PDSCH payload differently than 5G NR.

In one example, both the MIB message and the SIB1 PDCCH for 6G are shared with 5G NR, and a DCI format 1_0 with SI-RNTI for 6G provided by the SIB1 PDCCH has same DCI size and same SI-RNTI as for 5G NR while with different DCI fields or with same fields while interpreted differently for 6G than 5G NR, or the 6G UE applies different parameters for SIB1 PDCCH reception (such as different DCI size or different RNTI) to determine a DCI format 1_0 with SI-RNTI for 6G that is different from that for 5G NR.

In one example, the MIB message for 6G is shared with 5G NR, and the 6G UE interprets the SIB1 scheduling information (such as CORESET #0 or search space set #0 configuration) provided by the shared MIB message same or differently from 5G NR, or applies additional randomization in the 6G PDCCH search space formula to receive a SIB1 PDCCH that is different (e.g., in different T/F/S resources) from the SIB1 PDCCH for 5G NR.

In one example, the DL anchor signal such as NR SSB or NR LP-SS provides a first PBCH/MIB for 6G and a second PBCH/MIB the 5G NR that is separate from the first PBCH/MIB (while some information may be shared between 5G and 6G), as previously described in embodiments in the present disclosure. The 6G UE acquires the first/6G SIB1 based on the first/6G MIB, that is separate from the second/5G SIB1 which is based on the first/5G MIB.

In one example, a single identical SIB1 message that applies to both RATs, such as both 5G NR and 6G is provided. For example, the 6G UE receives identical system information same as for a 5G NR UE, and any differentiation among 5G NR UEs and 6G UEs is indicated during or after the initial/random access procedure. For example, the 6G UE is provided with information of 6G-specific system information using UE-common (cell-specific) or dedicated (UE-specific) higher layer signaling, such as common or dedicated RRC signaling.

In one example, similar considerations as disclosed in embodiments of the present disclosure can apply to acquisition of first SIBx (x>1) associated with 6G that are different from second SIBx associated with 5G NR, when scheduling information for the first and second SIBx are identified based on a SIB1 that is shared between 5G and 6G, or based on first SIB1 and second SIB1, associated with 6G and 5G, respectively, that are different.

In one example, the 6G UE receives the same SIB1 PDSCH as for 5G NR. In one example, the SIB1 PDSCH provides a SIB1 message for 5G that include first IEs for 5G operation and second IEs for 6G operation. For example, the 5G UE is unaware/discards the second IEs corresponding to 6G, and the 6G UE discards the first IEs corresponding to 5G. For example, at least some of the IEs from the first IEs and the second IEs can refer to the same parameters, while taking different values for 5G and 6G. For example, certain PRACH resource or configuration parameters in 6G can be different from corresponding parameters in 5G NR.

In another example, the second IEs include only 6G-specific parameters that are not supported in 5G NR, or parameters that are shared with 5G NR while taking different values for 6G compared to 5G NR. For example, 6G-specific parameters can include parameters for advanced antenna architecture such as joint phase-time array (JPTA) or parameters for new 6G verticals such as integrated sensing and communication (ISAC) or new 6G duplex operation modes such as full duplex variations, and so on. For example, for other parameters, the 6G UE applies a value provided by the first IEs for 5G NR, or the 6G UE is predetermined in the 6G specifications (or indicated by the SIB1 message) to apply a default value, or to discard the parameter. For example, both 5G NR and 6G UEs may apply the same TDD configuration, or some of the PRACH configuration parameters, or some of the power control parameters, and so on.

For example, SIB1 IEs that are 6G-specific or SIB1 IEs that are shared with 5G NR and that take values different from corresponding 5G parameters can be referred to as differential SIB1 for 6G, as they provide only additional/extension IEs for SIB1 relative to SIB1 IEs in 5G NR.

In another example, the 6G UE receives and interprets the SIB1 PDSCH same as in 5G NR. For example, the shared SIB1 message includes scheduling information of a new SIBx, such as SIB26, that applies only to 6G UEs and provides the RMSI for 6G. For example, the new SIB26 can override certain values provided by SIB1 for 5G NR. For example, the new SIB26 includes only the 6G-specific parameters, while a predetermined subset of NR SIB1 IEs are shared with 6G.

In another example, the 6G UE interprets the SIB1 PDSCH payload differently from 5G NR. For example, the 6G UE interprets the SIB1 PDSCH payload based on a first list of IEs predetermined in the 6G specifications that can be different from a second list of IEs predetermined in the 5G NR specifications.

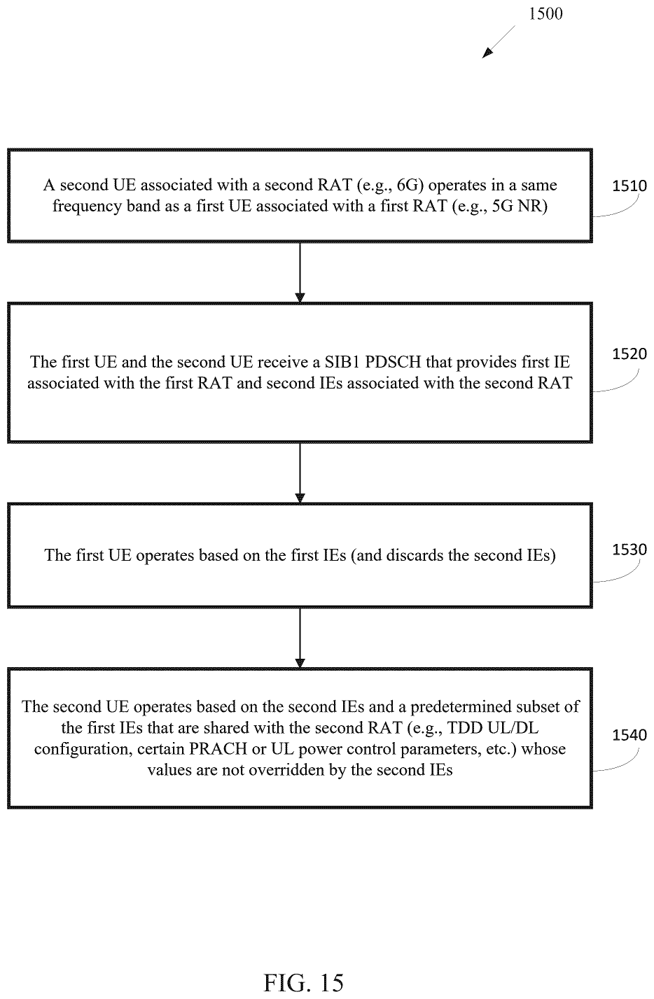

FIG. 15 illustrates a flowchart of UE method 1500 for sharing SIB1 PDSCH between 5G NR and 6G according to embodiments of the present disclosure. The UE method 1500 may be performed by a UE (e.g., 111-116 as illustrated in FIG. 1). The first UE or the second UE may be one of UEs (e.g., 111-116 as illustrated in FIG. 1). An embodiment of the UE method 1500 shown in FIG. 15 is for illustration only. One or more of the components illustrated in FIG. 15 can be implemented in specialized circuitry configured to perform the noted functions or one or more of the components can be implemented by one or more processors executing instructions to perform the noted functions.

FIG. 15 shows an example method for sharing SIB1 PDSCH between 5G NR and 6G.

A second UE associated with a second RAT (e.g., 6G) operates in the same frequency band as the first UE associated with a first RAT (e.g., 5G NR), 1510. The first UE and the second UE receive a SIB1 PDSCH that provides first IE associated with the first RAT and second IEs associated with the second RAT, 1520. The first UE operates based on the first IEs (and discards the second IEs), 1530. The second UE operates based on the second IEs and a predetermined subset of the first IEs that are shared with the second RAT (e.g., TDD UL/DL configuration, certain PRACH or UL power control parameters, etc.) whose values are not overridden by the second IEs, 1540.

In one embodiment, the 6G UE receives the same SIB1 PDCCH as in 5G NR, and the PDCCH provides a DCI format 1_0 with SI-RNTI that has the same DCI size and same SI-RNTI as in 5G NR. For example, the 6G UE is predetermined in the 6G specifications a list of DCI fields for the DCI format 1_0 with SI-RNTI that are different from those in the 5G NR. In another example, the DCI fields for DCI format 1_0 with SI_RNTI in 6G are same as those in 5G NR, and some of the DCI fields are interpreted differently. For example, an FDRA field or TDRA field are interpreted differently or based on different tables or mappings and so on. For example, a first value such as value “00” corresponds to SIB1 scheduling with all NR SIB1 IEs (or a predetermined subset thereof) applicable only to 5G and not applicable/shared with 6G, and a second value such as value “10” corresponds to SIB1 scheduling with all NR SIB1 IEs (or the predetermined subset thereof) applicable to both 5G NR and 6G. For example, a third value such as value “01” corresponds to SIBx>1 scheduling with all IEs of the corresponding NR SIBx>1 IEs (or a predetermined subset thereof) applicable only to 5G NR and not applicable/shared with 6G, and a fourth value such as value “11” corresponds to SIBx>1 scheduling with all IEs of the corresponding NR SIBx>1 (or the predetermined subset thereof) applicable to both 5G NR and 6G.

In another example, different values of the system information indicator field (or a new field in DCI format 1_0 with SI-RNTI) corresponds to different interpretations of the SIB1 PDCCH or SIB1 PDSCH, such as different TDRA tables, different FDRA interpretation, different UE types, different initial/random access procedures, or different initial DL/UL BWPs, and so on.

For example, a DCI format 1_0 with SI-RNTI for 6G can include an additional field that is not present in 5G NR, such as an early trigger for (cell-specific or TRP-specific or beam-specific) TRS availability or for CSI-RS or for SRS or for a configured-grant PUSCH transmission or for CSI reporting trigger or for beam reporting trigger, and so on.

For example, a DCI format 1_0 with SI-RNTI for 6G can reuse a DCI format with SI-RNTI for 5G that includes the first TDRA field and the first FDRA field for reception of the 5G SIB1 PDSCH, while using some of the reserved bits of the DCI format to indicate a new/second TDRA field and/or a new/second FDRA field for 6G SIB1 PDSCH. For example, the 5G UE discards the bits corresponding to the second TDRA field and the second FDRA field, as they are considered as reserved in 5G NR. For example, the 6G UE discards the first TDRA field and/or the first FDRA field, and instead uses the second TDRA field and/or the second FDRA field for reception of the 6G SIB1 PDSCH. In one example, only a second TDRA field is provided for 6G, and the FDRA for 6G SIB1 PDSCH is same as the first FDRA field for the 5G SIB1 PDSCH. In one example, only a second FDRA field is provided for 6G, and the TDRA for 6G SIB1 PDSCH is same as the first FDRA field for the 5G SIB1 PDSCH. For example, the 6G UE reads the only FDRA field (or the only TDRA field) that is shared with 5G NR.

For example, a DCI format 1_0 with SI-RNTI is same for 5G NR and for 6G. For example, the 5G UE acquires a first/5G SIB1 PDSCH based the field values, such as TDRA and FDRA, indicated by the DCI format 1_0 with SI-RNTI. For example, the 6G UE applies certain rules or formulas to receive the 6G SIB1 PDSCH. For example, the 6G UE applies a predetermined relationship to determine a second TDRA value and/or a second FDRA value for reception of 6G SIB1 PDSCH based on values of TDRA field and/or FDRA field that are provided by the DCI format 1_0 with SI-RNTI. For example, the UE applies a predetermined offset to the TDRA value or TDRA row index or a predetermined value to the FDRA value, such as predetermined RB/RE level offset. For example, the 6G UE interprets the TDRA value from on a new TDRA table.

For example, a value of SI-RNTI in 6G can be different from a value of SI-RNTI in 5G NR (that is, value FFFF), at least when a size of DCI format 1_0 in 6G is same as a size of DCI format 1_0 in 5G NR.

In another example, a value of SI-RNTI in 6G can be different from a value of SI-RNTI in 5G NR, regardless of whether a size of DCI format 1_0 with SI-RNTI in 6G is same as or different from a size of DCI format 1_0 with SI-RNTI in 5G NR. For example, a value of SI-RNTI in 6G is not a value FFFF (as used in LTE and NR). For example, a value of SI-RNTI in 6G can be different from any RNTI value that is used in association with DCI format 1_0 in 5G NR (or any DCI format in 5G NR with same DCI size), such as P-RNTI and so on. For example, a value 0000 or a value FFF0 or FFE0 or FF0F (or other RNTI values not used for CSS PDCCH) is defined for SI-RNTI for a DCI format scheduling 6G SIB. For example, an explicit or implicit partitioning of RNTI values is predetermined in the 5G/6G specifications of system operation, such that an SI-RNTI value used in 6G is not used as an RNTI value in 5G NR or 6G, at least for DCI formats that have a same size as a DCI format 1_0 with SI_RNTI in 6G.

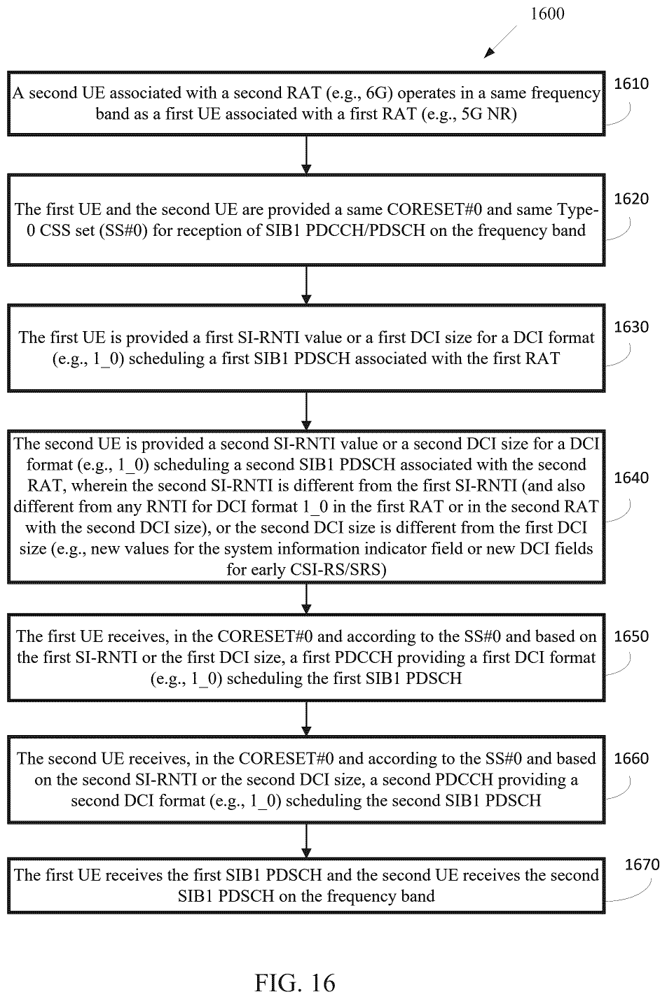

FIG. 16 illustrates a flowchart of UE method 1600 for using different SI-RNTI value or different DCI size for a DCI format scheduling SIB1 to distinguish a second SIB1 for 6G from a first SIB1 for 5G NR according to embodiments of the present disclosure. The UE method 1600 may be performed by a UE (e.g., 111-116 as illustrated in FIG. 1). The first UE or the second UE may be one of UEs (e.g., 111-116 as illustrated in FIG. 1). An embodiment of the UE method 1600 shown in FIG. 16 is for illustration only. One or more of the components illustrated in FIG. 16 can be implemented in a specialized circuitry configured to perform the noted functions or one or more of the components can be implemented by one or more processors executing instructions to perform the noted functions.

FIG. 16 shows an example method for using different SI-RNTI value or different DCI size for a DCI format scheduling SIB1 to distinguish a second SIB1 for 6G from a first SIB1 for 5G NR.

A second UE associated with a second RAT (e.g., 6G) operates in the same frequency band/carrier frequency as a first UE associated with a first RAT (e.g., 5G NR), 1610. The first UE and the second UE are provided a same CORESET #0 and same Type-0 CSS set (SS #0) for reception of SIB1 PDCCH/PDSCH on the frequency band/carrier frequency, 1620. The first UE is provided with a first SI-RNTI value or a first DCI size for a DCI format (e.g., 1_0) scheduling a first SIB1 PDSCH associated with the first RAT, 1630. The second UE is provided a second SI-RNTI value or a second DCI size for a DCI format (e.g., 1_0) scheduling a second SIB1 PDSCH associated with the second RAT, wherein the second SI-RNTI is different from the first SI-RNTI (and also different from any RNTI for DCI format 1_0 in the first RAT or in the second RAT with the second DCI size), or the second DCI size is different from the first DCI size (e.g., new values for the system information indicator field or new DCI fields for early CSI-RS/SRS), 1640. The first UE receives, in the CORESET #0 and according to the SS #0 and based on the first SI-RNTI or the first DCI size, a first PDCCH providing a first DCI format (e.g., 1_0) scheduling the first SIB1 PDSCH, 1650. The second UE receives, in the CORESET #0 and according to the SS #0 and based on the second SI-RNTI or the second DCI size, a second PDCCH providing a second DCI format (e.g., 1_0) scheduling the second SIB1 PDSCH, 1660. The first UE receives the first SIB1 PDSCH and the second UE receives the second SIB1 PDSCH on the frequency band/carrier frequency, 1670.

In one example, the 6G UE is provided a single MIB message by the NR SSB or LP-SS that applies to both NR and 6G. For example, the 6G UE interprets the MIB differently than in 5G NR. For example, the 6G UE determines different MIB fields/IEs or different number of bits than in 5G NR, possibly including different configuration information for SIB1 PDCCH. For example, the 6G UE determines different CORESET #0 or SS #0 or different Type-0 PDCCH configuration for SIB1 reception based on new predetermined tables, that are different from those in TS 38.213 for 5G NR.

For example, the 6G UE receives the SIB1 PDCCH/PDSCH (also known as Type-0 PDCCH/PDSCH) in a second CORESET #0 or SS #0 that is different from a first CORESET #0 or SS #0 associated with 5G NR. For example, the second CORESET #0 can be the first CORESET #0 after shifting the location of RBs by a number of RBs such as 1 RB or 2 RBs or shifting the location of symbols/slots by a number of symbols/slots such as 1 or 2 symbols/slots. For example, the first CORESET #0 and the second CORESET #0 can overlap in the time domain or in the frequency domain. In another example, the second CORESET #0 can be FDM or TDM with the first CORESET #0. For example, time-domain or frequency domain offsets relative to SSB can be different, such as values that result in non-overlapping resource allocation for the first CORESET #0 and the second CORESET #0.

For example, the second CORESET #0 for 6G can occupy different resources than first CORESET #0 for 5G NR, such as different number of OFDM symbols or different number of RBs or different placement of CORESET #0 such as different frame number, slot number, starting symbol number, or different offset value in time-domain or frequency-domain, such as symbol/slot offset or RB/RE offset, relative to NR SSB or LP-SS. For example, an SSB multiplexing pattern for CORESET #0 of 6G can be different from an SSB multiplexing pattern for CORESET #0 associated with 5G NR. For example, when CORESET #0 for 5G NR is TDM with NR SSB (multiplexing pattern 1), CORESET #0 for 6G can be FDM with NR SSB (multiplexing pattern 2 or 3). For example, when CORESET #0 for 5G NR is FDM with NR SSB (multiplexing pattern 2 or 3), CORESET #0 for 6G can be TDM with NR SSB (multiplexing pattern 1). In another example, CORESET #0 for 5G and CORESET #0 for 6G are both TDM with NR SSB (multiplexing pattern 1), and are FDM with each other (e.g., they are in the same slot or in same symbols). In another example, CORESET #0 for 5G and CORESET #0 for 6G are both TDM with NR SSB (multiplexing pattern 1), and are TDM with each other (e.g., all three are in different slots or in different symbols). In another example, CORESET #0 for 5G and CORESET #0 for 6G are both FDM with NR SSB (multiplexing pattern 2 or 3), and are FDM with each other (e.g., all three are in the same slot or in same or overlapping symbols).

For example, a configuration of a search space set #0 (SS #0) for SIB1 PDCCH reception in 6G can be different from a configuration of SS #0 in 5G NR. For example, such different configuration can be further conditioned on reusing/sharing a same CORESET #0 as in 5G NR.

For example, the 6G specifications can include different tables than those in NR TS 38.213, for configuration of SS #0 that provide frame index, slot index, or starting symbol index of PDCCH monitoring occasions for SS #0. For example, the 6G UE interprets the MIB information for SIB1 PDCCH configuration based on the 6G tables for SS #0 configuration, and receives the SIB1 PDCCH in PDCCH monitoring occasions that are different than those in 5G NR.

For example, an additional randomization can be applied to the search space formula in 6G to distinguish the 6G PDCCH candidates from those in 5G NR. For example, the search space formula from NR TS 38.213 can be modified to include a parameter g, from a set {0, 1, . . . , G−1} or {1, 2, . . . , G} or {G_max, G_max−1, G_max−2, . . . , G_max−(G−1)} with a predetermined value of G_max≥G such as G_max=FFFF (base-10 representation of the hex value FFFF), and so on.

For example, the parameter g can be associated with a search space set type or search space set index or a DCI format index or an RNTI used for a scrambling CRC of a DCI monitored in the corresponding search space set. For example, G can be (based on) a number of different CSS sets (or USS sets) that are associated with a same CORESET, such as CORESET #0. For example, a value g=0 (or g=1) can apply to SS #0 for SIB1 PDCCH, a value g=1 (or g=2) can apply to a CSS for paging PDCCH, a value g=2 (or g=3) can apply to a CSS for RAR PDCCH, and so on. For example, such mapping can be predetermined in the 6G specifications. In another example, the 6G specifications can include a mapping among values of parameter g and one of: CSS set indexes in CORESET #0, RNTI values for DCI formats 1_0 associated with CORESET #0 (such as SI-RNTI, P-RNTI, RA-RNTI, and so on). In another example, the 6G specifications can include first values for parameter g associated with DCI format 1_0, second values associated with DCI format 0_0, and so on. For example, a value g can be equal to or based on an RNTI value, such as an RNTI value when converted to a certain numerical base, such as base 10.

For example, the randomization parameter g can be applied to the search space using one of the following formulas:

$$L \cdot \{ ( {Y}_{p , {n}_{s , f}^{μ}} + ⌊ \frac{g \cdot {m}_{s , {n}_{CI}}^{( L )} \cdot {N}_{CCE , p}}{L \cdot {M}_{s , max}^{( L )}} ⌋ + {n}_{CI} ) mod ⌊ {N}_{CCE , p} / L ⌋ \} + i ,$$

$$L \cdot \{ ( {Y}_{p , {n}_{s , f}^{μ}} + ⌊ \frac{g \cdot {m}_{s , {n}_{CI}}^{( L )} \cdot {N}_{CCE , p}}{L \cdot {M}_{s , max}^{( L )}} ⌋ + {n}_{CI} ) mod ⌊ G \cdot {N}_{CCE , p} / L ⌋ \} + i ,$$

$$L \cdot \{ ( {Y}_{p , {n}_{s , f}^{μ}} + ⌊ \frac{g \cdot {m}_{s , {n}_{CI}}^{( L )} \cdot {N}_{CCE , p}}{L \cdot {M}_{s , max}^{( L )}} ⌋ + {n}_{CI} ) mod ⌊ {N}_{CCE , p} / L ⌋ \} + i ,$$

$$L \cdot \{ ( {Y}_{p , {n}_{s , f}^{μ}} + ⌊ \frac{{m}_{s , {n}_{CI}}^{( L )} \cdot {N}_{CCE , p}}{L \cdot {M}_{s , max}^{( L )}} ⌋ + {n}_{CI} + g ) mod ⌊ {N}_{CCE , p} / L ⌋ \} + i ,$$

$$L \cdot \{ ( g \cdot {Y}_{p , {n}_{s , f}^{μ}} + ⌊ \frac{{m}_{s , {n}_{CI}}^{( L )} \cdot {N}_{CCE , p}}{L \cdot {M}_{s , max}^{( L )}} ⌋ + {n}_{CI} ) mod ⌊ {N}_{CCE , p} / L ⌋ \} + i ,$$

or variations or combinations thereof.

For example, the randomization parameter g can be applied to the search space parameter using one of the following formulas:

$${Y}_{p , {n}_{s , f}^{μ}} = ( g \cdot {A}_{p} \cdot {Y}_{p , {n}_{s , f}^{μ} - 1} ) mod D ,$$

$${Y}_{p , {n}_{s , f}^{μ}} = ( g + {A}_{p} \cdot {Y}_{p , {n}_{s , f}^{μ} - 1} ) mod D ,$$

or variations or combinations thereof.

In another example, an initialization value Y_{p,-1}=g (instead of value

$${Y}_{p , {n}_{s , f}^{μ}} = 0 )$$

is applied, and following values are determined using the 5G NR formula:

$${Y}_{p , {n}_{s , f}^{μ}} = ( {A}_{p} \cdot {Y}_{p , {n}_{s , f}^{μ} - 1} ) mod D .$$

For example, for a CSS set, Y_{p,-1}=n_{RNTI}≠0, wherein the RNTI value used for n_{RNTI} is the RNTI for the DCI format associated with the CSS set, such as SI-RNTI for a Type-0 CSS set, or RA-RNTI for a Type-1 CSS set, or MsgB-RNTI for a Type-1A CSS set, or P-RNTI for a Type-2 CSS set, or PEI-RNTI for a Type-2A CSS set, and so on. When a UE is configured a CSS set (or a USS set) for monitoring multiple DCI formats associated with multiple common RNTI values, the UE determines the value used for n_{RNTI} based on a predetermined rule, such as a minimum or a maximum among the multiple RNTI values, or a default or reference value, such as an RNTI value that is predetermined in the specifications, or based on a priority among RNTI values, or a value of RNTI/n_{RNTI} is configured by higher layers for the CSS set (or USS set). For example, such a method can apply to Type-3 CSS set.

For example, introducing such randomization parameter for 6G PDCCH can be further conditioned on reusing/sharing a same CORESET, such as CORESET #0, or a same search space set, such as SS #0, as in 5G NR. In another example, introducing such randomization parameter for 6G PDCCH can be applied regardless of whether or not a CORESET or a search space set in 6G is re-used/shared as one corresponding to 5G NR. In another example, a flag in the MIB (or provided by higher layer signalling, when such randomization is used in general beyond SIB1 PDCCH/CORESET #0/SS #0) can indicate whether the parameter g is applied to the search space formula. When the parameter is not applied, a default value such as g=0 or g=1 is applied. In another example, such additional randomization is applied only for CORESET #0 and SS #0 and does not apply to other CORESETs or search space sets; for example, for other CORESETs/CSS sets/USS sets, a default value for parameter g is applied.

For example, for scheduling the 6G SIB1, a 6G UE receives a second PDCCH providing a second DCI format associated with 6G SI-RNTI that is separate from a first PDCCH that provides a first DCI format (e.g., DCI format 1_0) associated with 5G SI-RNTI (e.g., FFFF). For example, both the first PDCCH and the second PDCCH are provided in a same CORESET, such as CORESET #0.

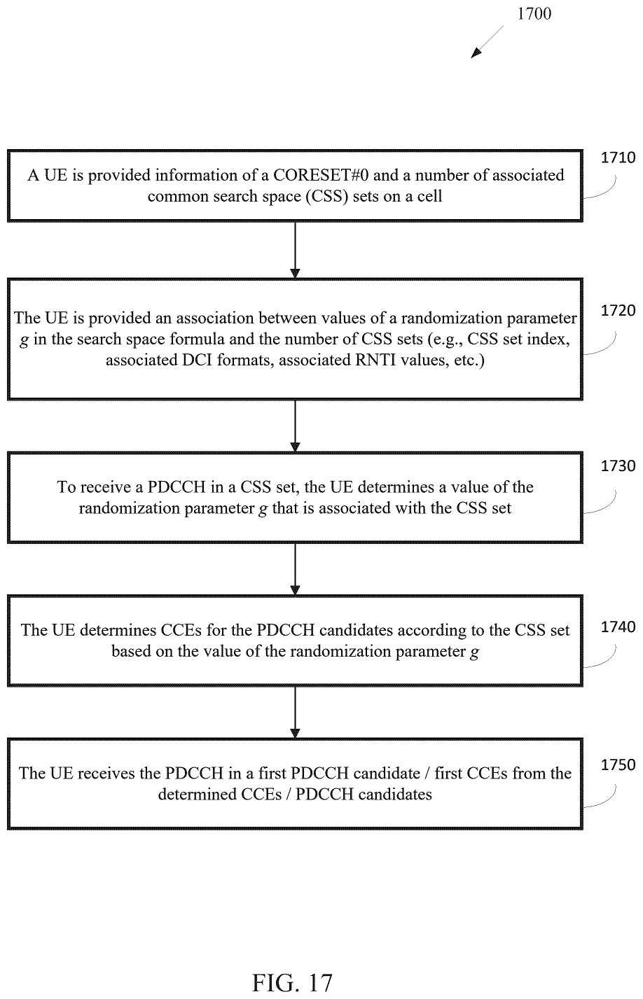

FIG. 17 illustrates a flowchart of UE method 1700 for randomization of CCEs/PDCCH candidates in the search space formula for CSS sets according to embodiments of the present disclosure. The UE method 1700 may be performed by a UE (e.g., 111-116 as illustrated in FIG. 1). An embodiment of the UE method 1700 shown in FIG. 17 is for illustration only. One or more of the components illustrated in FIG. 17 can be implemented in a specialized circuitry configured to perform the noted functions or one or more of the components can be implemented by one or more processors executing instructions to perform the noted functions.

FIG. 17 shows an example method for randomization of CCEs/PDCCH candidates in the search space formula for CSS sets.

A UE is provided information of a CORESET #0 and a number of associated CSS sets on a cell, 1710. The UE is provided an association between values of a randomization parameter g in the search space formula and the number of CSS sets (e.g., CSS set index, associated DCI formats, associated RNTI values, etc.), 1720. To receive a PDCCH in a CSS set, the UE determines a value of the randomization parameter g that is associated with the CSS set, 1730. The UE determines CCEs for the PDCCH candidates according to the CSS set based on the value of the randomization parameter g, 1740. The UE receives the PDCCH in a first PDCCH candidate/first CCEs from the determined CCEs/PDCCH candidates, 1750.

In one embodiment, a reception of RAT-specific paging/RAR/group-common PDCCH/LP-WUS is provided in resources shared across RATs.

In one embodiment, a first UE associated with a first RAT, such as a 6G UE, can receive a first PDCCH that schedules first paging information or a first random access response (RAR) or a first group-common PDCCH (such as DCI format 2_x in a CSS set) in time/frequency/spatial (T/F/S) resources, such as resources in a same CORESET #0 or resources in a same CORESET with non-zero index, that are also used (shared) for reception of a second PDCCH that schedules second paging information or a second RAR or a second group-common PDCCH to a second UE associated with a second RAT, such as 5G NR. The first paging/RAR/control information for the first UE can be included in a first paging message/RAR message (or RAR MAC)/group-common DCI format 2_x that includes paging/RAR/control information for a number of UEs, such as only 6G UEs, or a combination of 6G UEs and 5G NR UEs. Similar examples can be provided for LP-WUS as well. For the case of paging, the following embodiments/examples can be provided.

In one example, a paging PDSCH/message includes paging information for both 5G NR UEs and 6G UEs. If UE IDs are different each UE can distinguish corresponding paging information.

In one example, the paging PDCCH for 6G is shared with 5G NR, and the 6G UE applies different parameters for paging PDCCH reception (such as different DCI size or different RNTI) to determine a DCI format 1_0 with P-RNTI or a LP-WUS for 6G that is different from that for 5G NR.

In one example, a CORESET for reception of paging PDCCH for 6G is shared with 5G NR, while a search space set for paging PDCCH (such as a Type-2 CSS set) for 6G is different from a Type-2 CSS set for paging PDCCH for 5G NR, such as by the 6G UE applying an additional randomization in the 6G PDCCH search space formula, as previously described in embodiments of the present disclosure, or based on indication (by SIB1 or RRC configuration) of paging occasions for 6G that are different from paging occasions for 5G NR. Therefore, the 6G UE receives a paging PDCCH that is different (e.g., in different T/F/S resources) from the paging PDCCH for 5G NR.

As disclosed in the present disclosure, similar considerations can apply to reception of first RAR/group-common PDCCH in a CSS set (e.g., DCI 2_x) associated with 6G that are different/separate from second RAR/group-common PDCCH associated with 5G NR, for example, when corresponding CORESET or Type-1 CSS set or Type-3 CSS set is shared among NR and 6G.

As disclosed in the present disclosure, similar considerations can apply to reception of first paging early indication (PEI) or first low-power wake-up signal (LP-WUS) associated with 6G that are different/separate from second PEI or LP-WUS associated with 5G NR, for example, when CORESET or Type-2A CSS set for PEI PDCCH reception is shared among NR and 6G, or when T/F/S resources for LP-WUS reception are shared between NR and 6G.

In one example, partitioning of UE IDs can be used to distinguish paging for NR and 6G UEs. For example, partitioning of UE IDs can be predetermined in the specifications, such as certain prefix or suffix for the UE IDs of 5G or 6G, or different ranges for NR UE IDs and 6G UE IDs. In another example, partitioning of UE IDs can be based on coordination of 5G NR gNBs and 6G base stations (BSs), or by corresponding CNs, so that a same UE ID is not assigned to both an NR UE and a 6G UE.

In another example, paging (or PEI or LP-WUS) are based on UE groups, and each paging message or paging PDCCH/PDSCH or each PEI PDCCH or LP-WUS corresponds to a certain group of UEs. For example, 5G UEs are in separate UE groups than 6G UEs. For example, NR gNBs and 6G BSs, or corresponding CNs, coordinate to assign different indexes of UE groups to 6G UE groups than NR UE groups. For example, UE IDs are such that NR UE groups are separate from 6G UE groups, for example, as previously described for different UE IDs. For example, 6G specifications includes certain predetermined structures (such as prefix or suffix) or values or ranges for 6G UE group IDs to distinguish from NR group IDs.

In another example, an indication in the paging message or in the DCI format scheduling the PDSCH with paging information, such as a bit from the reserved bits of the DCI format 1_0 with P-RNTI (or in the DCI format 2_7 with PEI-RNTI, or in LP-WUS) can be used to indicate whether the paging/PEI/LP-WUS is for a group of NR UEs or a group of 6G UEs. For example, a value “0” indicates 5G NR, and a value “1” indicates 6G. For example, such flag can be combined or jointly encoded with other parameters, such as with the short message indicator, or the TRS availability indicator, and so on. For example, a 6G UE can determine a corresponding paging/PEI/LP-WUS even when a 5G NR UE with same UE ID or same UE group ID is present.

In another example, NR UEs and 6G UEs can be in a same UE group for paging/PEI/LP-WUS, and a distinction of UEs can be based on respective UE IDs, as previously described.

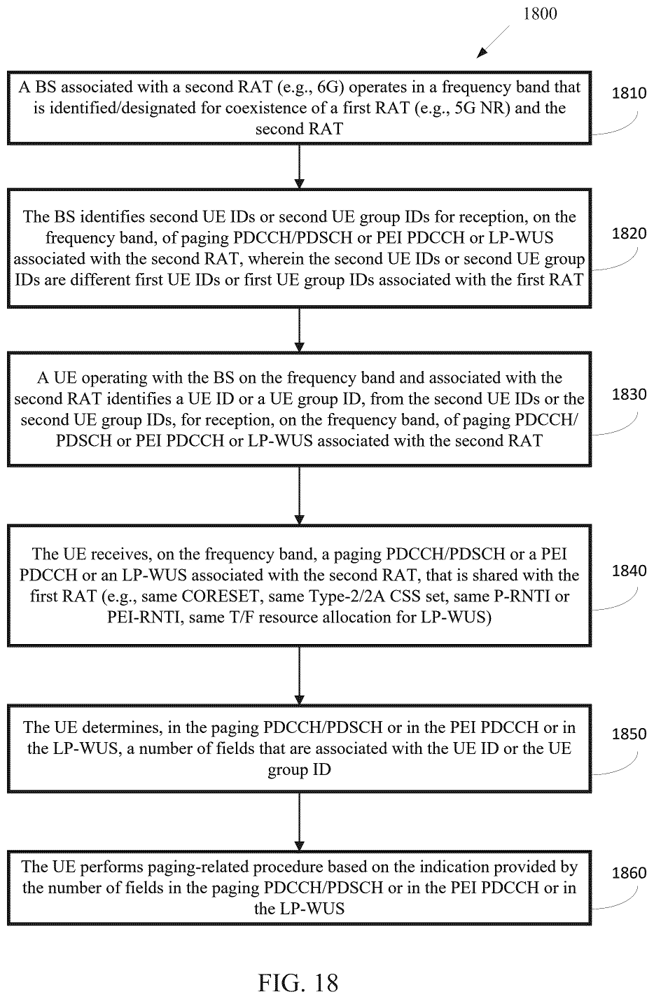

FIG. 18 illustrates a flowchart of a method 1800 for partitioning UE IDs or UE group IDs to distinguish a second paging (or PEI or LP-WUS) for 6G from a first paging (or PEI or LP-WUS) for 5G NR according to embodiments of the present disclosure. The method 1800 may be performed by a UE (e.g., 111-116 as illustrated in FIG. 1) and a BS (e.g., 101-103 as illustrated I FIG. 1). An embodiment of the method 1800 shown in FIG. 18 is for illustration only. One or more of the components illustrated in FIG. 18 can be implemented in specialized circuitry configured to perform the noted functions or one or more of the components can be implemented by one or more processors executing instructions to perform the noted functions.

FIG. 18 shows an example method for partitioning UE IDs or UE group IDs to distinguish a second paging (or PEI or LP-WUS) for 6G from a first paging (or PEI or LP-WUS) for 5G NR.

A BS associated with a second RAT (e.g., 6G) operates in a frequency band that is identified/designated for coexistence of a first RAT (e.g., 5G NR) and the second RAT, 1810. The BS identifies second UE IDs or second UE group IDs for reception, on the frequency band, of paging PDCCH/PDSCH or PEI PDCCH or LP-WUS associated with the second RAT, wherein the second UE IDs or second UE group IDs are different first UE IDs or first UE group IDs associated with the first RAT, 1820. A UE operating with the BS on the frequency band and associated with the second RAT identifies a UE ID or a UE group ID, from the second UE IDs or the second UE group IDs, for reception, on the frequency band, of paging PDCCH/PDSCH or PEI PDCCH or LP-WUS associated with the second RAT, 1830. The UE receives, on the frequency band, a paging PDCCH/PDSCH or a PEI PDCCH or an LP-WUS associated with the second RAT, that is shared with the first RAT (e.g., same CORESET, same Type-2/2A CSS set, same P-RNTI or PEI-RNTI, same T/F resource allocation for LP-WUS), 1840. The UE determines, in the paging PDCCH/PDSCH or in the PEI PDCCH or in the LP-WUS, a number of fields that are associated with the UE ID or the UE group ID, 1850. The UE performs paging-related procedure based on the indication provided by the number of fields in the paging PDCCH/PDSCH or in the PEI PDCCH or in the LP-WUS, 1860.

In one example for paging, a 6G UE is provided same CORESET and Type-2 CSS set for paging PDCCH and same time-domain paging occasions (POs) as a 5G NR UE. The 6G UE and the 5G NR UE can both receive a same paging PDCCH. The 6G specification for system operation defines a DCI format for paging PDCCH reception, such as a DCI format 1_0 with CRC scrambled by P-RNTI (for brevity: a DCI format 1_0 with P-RNTI). For example, a size of a DCI format 1_0 with P-RNTI in 6G is different from a size of a DCI format with P-RNTI in 5G NR, or a value of P-RNTI for 6G is different from that in 5G.

For example, a total number of bits for fields, except for FDRA field and for padding bits, if any, of a DCI format 1_0 for 5G is 28 bits, while a total number of bits for fields except for FDRA field and for padding bits, if any, of a DCI format 1_0 for 6G can be N bits, with N different from 28, such as 29 or 30 bits. For example, a DCI format 1_0 in 6G can have a number of (N−28), such as 1 or 2, additional reserved bits compared to 5G NR.

For example, a DCI format 1_0 with P-RNTI for 6G can include an additional field that is not present in 5G NR, as previously described for SI-RNTI.

For example, a short message indicator field or a short message field in DCI format 1_0 with P-RNTI for 6G can include more bits or different values than in 5G NR. For example, an additional most significant bit (MSB) can be added with a predetermined value such as one. For example, more combinations can be added, such as first 2 bits for indication of one or both of scheduling of first paging and first short message for first group of UEs, and second 2 bits for indication of one or both of scheduling of second paging and second short message for second group of UEs. For example, the first and second groups of UEs can refer to 6G UEs and 5G UEs, or can refer to certain UE groups or UEs served by a first/second TRP or UEs in a certain ranges or positions or zones or geographical areas or SSB areas or associated with a first/second beam or TCI state or SSB index, and so on. For example, for the short message field, some of values, from values 5 to 8 that are reserved in 5G NR, can be defined and used in the 6G specifications, such as for indication of modifications related/specific to 6G SIB1 or SIBx>1 or paging or ETWS, or CMAS, and so on for 6G, or for combination thereof with corresponding 5G NR messages.

For example, a value of P-RNTI in 6G can be same as, or different from, a P-RNTI value in 5G NR (that is, value FFFE), at least when a size of DCI format 1_0 in 6G is different from a size of DCI format 1_0 in 5G NR.

In another example, a value of P-RNTI in 6G can be different from a value of P-RNTI in 5G NR, regardless of whether a size of DCI format 1_0 with P-RNTI in 6G is same as or different from a size of DCI format 1_0 with P-RNTI in 5G NR. For example, a value of P-RNTI in 6G is not a value FFFE (as used in LTE and NR). For example, a value of P-RNTI in 6G can be different from any RNTI value that is used in association with DCI format 1_0 in 5G NR (or any DCI format in 5G NR with same DCI size), such as P-RNTI and so on. For example, a value 0001 is used for P-RNTI. For example, an explicit or implicit partitioning of RNTI values is predetermined in the 5G/6G specifications of system operation, such that a P-RNTI value used in 6G is not used as an RNTI value in 5G NR, at least for DCI formats that have a same size as a DCI format 1_0 with P-RNTI in 6G.

As disclosed in the present disclosure, similar methods apply for handling PEI-RNTI or DCI size of DCI format 2_7 with CRC scrambled with PEI-RNTI, for example, when a corresponding CORESET (or search space set) is shared between 5G NR and 6G.

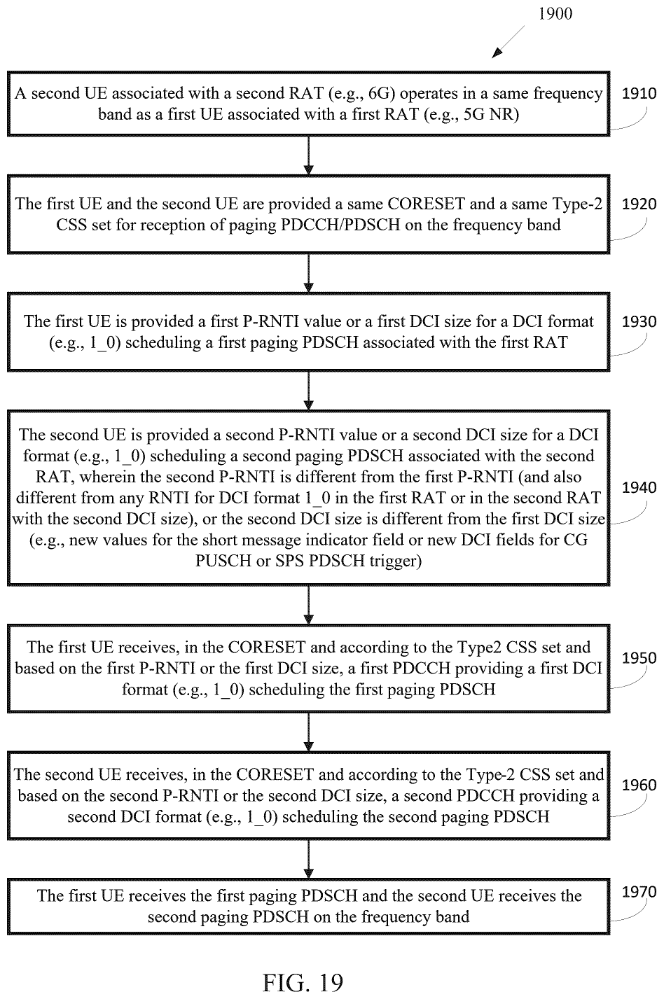

FIG. 19 illustrates a flowchart of UE method 1900 for using different P-RNTI value or different DCI size for a DCI format scheduling paging to distinguish a second paging for 6G from a first paging for 5G NR according to embodiments of the present disclosure. The UE method 1900 may be performed by a UE (e.g., 111-116 as illustrated in FIG. 1). The first UE or the second UE may be one of UEs (e.g., 111-116 as illustrated in FIG. 1). An embodiment of the UE method 1900 shown in FIG. 19 is for illustration only. One or more of the components illustrated in FIG. 19 can be implemented in a specialized circuitry configured to perform the noted functions or one or more of the components can be implemented by one or more processors executing instructions to perform the noted functions.

FIG. 19 shows an example method for using different P-RNTI value or different DCI size for a DCI format scheduling paging to distinguish a second paging for 6G from a first paging for 5G NR.

A second UE associated with a second RAT (e.g., 6G) operates in the same frequency band/carrier frequency as a first UE associated with a first RAT (e.g., 5G NR), 1910. The first UE and the second UE are provided with the same CORESET and same Type-2 CSS set for reception of SIB1 PDCCH/PDSCH on the frequency band/carrier frequency, 1920. The first UE is provided with a first P-RNTI value or a first DCI size for a DCI format (e.g., 1_0) scheduling a first paging PDSCH associated with the first RAT, 1930. The second UE is provided a second P-RNTI value or a second DCI size for a DCI format (e.g., 1_0) scheduling a second paging PDSCH associated with the second RAT, wherein the second P-RNTI is different from the first P-RNTI (and also different from any RNTI for DCI format 1_0 in the first RAT or in the second RAT with the second DCI size), or the second DCI size is different from the first DCI size (e.g., new values for the short message indicator field or new DCI fields for CG-PUSCH or SPS PDSCH trigger), 1940. The first UE receives, in the CORESET and according to the Type-2 CSS set and based on the first P-RNTI or the first DCI size, a first PDCCH providing a first DCI format (e.g., 1_0) scheduling the first paging PDSCH, 1950. The second UE receives, in the CORESET and according to the Type-2 CSS set and based on the second P-RNTI or the second DCI size, a second PDCCH providing a second DCI format (e.g., 1_0) scheduling the second paging PDSCH, 1960. The first UE receives the first paging PDSCH and the second UE receives the second paging PDSCH on the frequency band/carrier frequency, 1970.

In one embodiment, a CORESET for paging PDCCH (or for PEI PDCCH), such as CORESET #0, is shared among 6G UEs and 5G NR UEs, and a search space set for paging/PEI is also shared among 6G UEs and 5G NR UEs. For example, a randomization can be applied to the search space, as previously described for SIB1 PDCCH. For example, separation for the search space can be in time-domain or frequency domain. For example, different CORESETs or different search space sets are used for 6G than 5G NR. For example, time-domain paging occasions (POs) or occasion for PEI or occasions for LP-WUS monitoring are separated among 5G NR and 6G, using different parameters indicated by higher layers, such as SIB or RRC for 5G or 6G. For example, different frames, or slots or symbols are used for 6G than 5G NR. For example, new terms can be included in the paging frame (PF) or paging occasion (PO) formulas to randomize or differentiate 5G UEs from 6G UEs.

For example, the formula for paging SFN, referred to as paging frame (PF), is given by (SFN+PF_offset) mod T=(T div N)*(UE_ID mod N), wherein a value of PF_offset can be different for 5G NR and 6G. In another example, the PF formula is modified in 6G, such as by applying a different N value, or by adding additional offset term (SFN+PF_offset+PF_offset2) mod T=(T div N)*(UE_ID mod N), and so on. For example, the PO formula can be modified as i_s=1−floor (UE_ID/N) mod Ns, so that POs for 6G UEs are separate from Pos for 5G NR UEs.

The embodiments and examples disclosed in the present disclosure can apply beyond paging, PEI, and LP-WUS to other PDCCH or PDSCH or messages that provide control information for multiple UEs such as group(s) of UEs. For example, such methods can apply to RAR or group-common PDCCH (DCI format 2_x) that apply to all UEs in a cell or groups of UEs in a cell.

For example, above methods for sharing CORESET #0 or other CORESET or an initial DL/UL BWP between 5G NR and 6G can be applied for monitoring or reception of RAR PDCCH (or RAR PDSCH) in a Type-1 CSS set or Type-1A CSS set. For example, UE IDs, such as contention resolution ID (CR-ID), can be different across different RATs.

For example, a modified DCI format 1_0 with CRC scrambled with RA-RNTI for 6G can be different from DCI format 1_0 with RA-RNTI for 5G NR, such as by using additional DCI fields, as previously described. For example, a DCI size or an RA-RNTI for DCI format 1_0 with RA-RNTI for 6G can be different from those for 5G NR. For example, new terms can be included in the RA-RNTI formula to randomize or differentiate 5G UEs from 6G UEs.

For example, the formulas for RA-RNTI and MSGB-RNTI can be modified as:

$$RA - RNTI = 1 + s\_id + 14 \times t\_id + 14 \times 80 \times f\_id + 14 \times 80 \times 8 \times ul\_carrier \_id + 14 \times 80 \times 8 \times 2 \times 0 + 14 \times 80 \times 8 \times 2 \times 2 * RAT\_id ,$$

$$MSGB - RNTI = 1 + s\_id + 14 \times t\_id + 14 \times 80 \times f\_id + 14 \times 80 \times 8 \times ul\_carrier \_id + 14 \times 80 \times 8 \times 2 \times 1 + 14 \times 80 \times 8 \times 2 \times 2 * RAT\_id wherein RAT\_id is 0 for 5 G NR and is 1 for 6 G .$$

For example, RAR parameters such as RAR monitoring window can be different, such as TDM or non-overlapping for 5G NR and 6G. For example, the PDCCH monitoring occasions or the PDCCH candidates for Type-1 CSS set or Type-1A CSS set for RAR PDCCH can be randomized using additional terms in the search space formula, as previously described, or otherwise differentiated such as by configuration or indication of different monitoring occasions, for example, using different starting symbol or slot or different frame number and so on.

For example, search space sets or monitoring occasions for different group-common DCI formats, for example, set DCI formats 2_x, in a CSS set such as Type-3 CSS can be separate, e.g., TDM or non-overlapping. For example, such separation can be conditioned on monitoring corresponding PDCCH in a CORESET that is shared among different DCI formats 2_x. For example, some DCI formats 2_x correspond to 5G NR UEs and other DCI formats 2_x refer to 6G UEs. For example, a same DCI format 2_x may provide control information for first 6G UEs and second 5G NR UEs.

For example, procedures can be shared among NR UEs and 6G UEs. For example, a 6G UE can determine PDCCH monitoring procedures, such as PDCCH skipping or search space set switching or UE DRX procedure and so on based on 5G NR signaling, such as DCI format 2_0 that is shared between 6G UEs and NR UEs.

The present disclosure can be applicable to LTE/NR/6G specifications Rel-21 or beyond to support coexistence of UEs from different RATs, such as a 6G UE/NB with 5G/4G UEs/NB, based on MRSS with sharing or cooperation methods, such as cooperation or sharing of time/frequency/spatial resources (or other domain resources) or of procedures or signaling and so on.

The embodiments are generic and can also apply to various frequency bands in different frequency ranges (FR) such as FR1, FR2, FR3, and FR2-2, e.g., low frequency bands such as below 1 GHz, mid frequency bands, such as 1-7 GHZ, or 7-24 GHZ, and high/millimeter frequency bands, such as 24-100 GHz and beyond. In addition, the embodiments are generic and can apply to various use cases and settings as well, such as single-panel UEs and multi-panel UEs, eMBB, URLLC and IIOT, mMTC and IoT including BS-IoT, NR IoT, and A-IoT, sidelink/V2X, operation with multi-TRP/beam/panel, operation in NR-U, NTN, aerial systems such as drones, operation with RedCap UEs, NPN, and so on.

The present disclosure may also relate to a pre-5G or 5G or beyond 5G communication system to be provided for supporting one or more of: higher data rates, lower latency, higher reliability, improved coverage, and massive connectivity, and so on. Various embodiments apply to UEs operating with other RATs and/or standards, such as different releases/generations of 3GPP standards (including beyond 5G, 5G Advanced, 6G, and so on), IEEE standards (such as 802.16 WiMAX and 802.11 Wi-Fi and so on), and so forth.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method for a user equipment (UE), the method comprising:
receiving a master information block (MIB) that indicates a control resource set (CORESET) for receptions of physical downlink control channels (PDCCHs);
receiving a first PDCCH in the CORESET, wherein:
the first PDCCH provides a first downlink control information (DCI) format, and
the first DCI format schedules reception of a first physical downlink shared channel (PDSCH) that provides a first system information block (SIB);
receiving a second PDCCH in the CORESET, wherein:
the second PDCCH provides a second DCI format, and
the second DCI format schedules reception of a second PDSCH that provides a second SIB;
determining:
to receive the first PDSCH when the UE operates according to a first radio access technology (RAT), or
to receive the second PDSCH when the UE operates according to a second RAT; and
receiving:
the first PDSCH when the UE operates according to the first RAT, or
the second PDSCH when the UE operates according to the second RAT.

2. The method of claim 1, wherein:
the first DCI format includes a first cyclic redundancy check (CRC) scrambled by a first system information radio network temporary identifier (SI-RNTI), and
the second DCI format includes a second CRC scrambled by a second SI-RNTI.

3. The method of claim 1, wherein:
the first DCI format has a first size, and
the second DCI format has a second size.

4. The method of claim 1, wherein:
the first PDCCH reception is according to a first search space set, and
the second PDCCH reception is according to a second search space set.

5. The method of claim 1, wherein the receptions of the first PDCCH and of the second PDCCH are according to a same search space set.

6. The method of claim 1, further comprising:
receiving the first PDSCH when the UE operates according to the second RAT.

7. The method of claim 6, further comprising
determining a second value for a parameter, wherein:
the first PDSCH provides a first value for the parameter, and
the second PDSCH provides the second value for the parameter.

8. A user equipment (UE), comprising:
a transceiver configured to:
receive a master information block (MIB) that indicates a control resource set (CORESET) for receptions of physical downlink control channels (PDCCHs);
receive a first PDCCH in the CORESET, wherein:
the first PDCCH provides a first downlink control information (DCI) format, and
the first DCI format schedules reception of a first physical downlink shared channel (PDSCH) that provides a first system information block (SIB); and
receive a second PDCCH in the CORESET, wherein:
the second PDCCH provides a second DCI format, and
the second DCI format schedules reception of a second PDSCH that provides a second SIB; and
a processor operably coupled with the transceiver, the processor configured to determine:
to receive the first PDSCH when the UE operates according to a first radio access technology (RAT), or
to receive the second PDSCH when the UE operates according to a second RAT; and
wherein the transceiver is further configured to receive:
the first PDSCH when the UE operates according to the first RAT, or
the second PDSCH when the UE operates according to the second RAT.

9. The UE of claim 8, wherein:
the first DCI format includes a first cyclic redundancy check (CRC) scrambled by a first system information radio network temporary identifier (SI-RNTI), and
the second DCI format includes a second CRC scrambled by a second SI-RNTI.

10. The UE of claim 8, wherein:
the first DCI format has a first size, and
the second DCI format has a second size.

11. The UE of claim 8, wherein:
the first PDCCH reception is according to a first search space set, and
the second PDCCH reception is according to a second search space set.

12. The UE of claim 8, wherein the receptions of the first PDCCH and of the second PDCCH are according to a same search space set.

13. The UE of claim 8, wherein the transceiver is further configured to receive the first PDSCH when the UE operates according to the second RAT.

14. The UE of claim 13, wherein:
the processor is further configured to determine a second value for a parameter,
the first PDSCH provides a first value for the parameter, and
the second PDSCH provides the second value for the parameter.

15. A base station (BS), comprising:
a transceiver configured to:
transmit, to a user equipment (UE), a master information block (MIB) that indicates a control resource set (CORESET) for transmissions of physical downlink control channels (PDCCHs);
transmit a first PDCCH in the CORESET, wherein:
the first PDCCH provides a first downlink control information (DCI) format, and
the first DCI format schedules transmission of a first physical downlink shared channel (PDSCH) that provides a first system information block (SIB); and
transmit a second PDCCH in the CORESET, wherein:
the second PDCCH provides a second DCI format, and
the second DCI format schedules transmission of a second PDSCH that provides a second SIB; and
a processor operably coupled with the transceiver, the processor configured to determine:
to transmit the first PDSCH when the UE operates according to a first radio access technology (RAT), or
to transmit the second PDSCH when the UE operates according to a second RAT; and
wherein the transceiver is further configured to transmit:
the first PDSCH when the UE operates according to the first RAT, or
the second PDSCH when the UE operates according to the second RAT.

16. The BS of claim 15, wherein:
the first DCI format includes a first cyclic redundancy check (CRC) scrambled by a first system information radio network temporary identifier (SI-RNTI), and
the second DCI format includes a second CRC scrambled by a second SI-RNTI.

17. The BS of claim 15, wherein:
the first DCI format has a first size, and
the second DCI format has a second size.

18. The BS of claim 15, wherein:
the first PDCCH transmission is according to a first search space set, and
the second PDCCH transmission is according to a second search space set.

19. The BS of claim 15, wherein the transmissions of the first PDCCH and of the second PDCCH are according to a same search space set.

20. The BS of claim 19, wherein:
the first PDSCH provides a first value for a parameter, and
the second PDSCH provides a second value for the parameter.
